(19) United States
(12) Patent Application Publication
(10) Pub. No.: US 2026/0330558 A1
(43) Pub. Date: Oct. 22, 2026

(54) SYSTEM FOR AUTOMATED MANAGEMENT OF A PORTFOLIO OF ASSETS

(71) Applicants: Jatin V Mehta, Voorhees, NJ (US); Kunal Narendra Jagda, Voorhees, NJ (US)

(72) Inventors: Jatin V Mehta, Voorhees, NJ (US); Kunal Narendra Jagda, Voorhees, NJ (US)

(21) Appl. No.: 19/185,181

(22) Filed: Apr. 21, 2025

(51) Int. Cl. G06Q 40/06

(52) U.S. Cl. CPC G06Q 40/0631; G06Q 40/062

(57) ABSTRACT

A system for an automated portfolio management model for optimizing an optimizable portfolio of assets comprises a memory and a processor communicatively coupled to the memory. The processor is configured to execute instructions stored in the memory to implement multiple modules comprising a data acquisition module, a profile evaluation module, an investment style evaluation module, an instrument selection module, a portfolio construction module, and a portfolio optimization module.

### BACKGROUND

Markowitz's theory of portfolio selection implies that an investor should diversify and maximize the expected return (see Mean-Variance Model for Portfolio Selection by Frank J. Fabozzi—2012). The rule states that the investor should diversify his funds among all those securities, giving the maximum expected return. The law of large numbers will ensure that the actual yield of the portfolio will be almost the same as the expected yield. Further, it also states that suppose an investor diversifies between two portfolios, and if the two original portfolios have equal variance, then typically the variance of the resulting portfolio will be less than the variance of either original portfolio.

The selection of a financial instrument has long been identified as an important but challenging process in financial market analysis. A proper asset selection process is also an attempt to facilitate investment decision-making. Accordingly, asset selection could serve as a preliminary step for the portfolio recommendations to provide target instruments deserving of study. The process of portfolio selection should be approached by:
(1) making probabilistic estimates of the future performance of the asset;
(2) analysing those estimates to determine an efficient set of portfolios; and
(3) selecting from that set of portfolios the best suited to the investor's preference.

One possible objective of investment in a group of financial instruments is to derive the optimal expected rate of return consistent with the optimal risk to which the investor is not adverse. In other words, it is beneficial to seek an indifference trade-off condition between acceptable risk and desired return. The interpretation of expected return for security is that it should be the mean of the probability distribution of the net price change plus cash dividends in a period as a percentage of the beginning price.

$$\begin{matrix}Return = \frac{( {P}_{2} - {P}_{1} + d )}{{P}_{1}} \\ Expected Return = ER = {μ}_{R} ,\end{matrix}$$

where P is the price of the financial instrument on a particular day, d is the dividend, μ is the mean return, and R has some probability distribution f(R). However, it may not be possible to specify the probability distribution and a subjective estimate of the expected value of the return must be based on both fundamental and technical considerations.

The degree of risk associated with a financial instrument is a function of the variation of the returns. A representative value for this risk can be obtained by computing the variance of the return from the geometric mean return over the past years. The geometric mean is used since it reflects growth by reinvestment of dividends. In addition, the geometric mean generally yields a more conservative value than the arithmetic mean. For the selection of a single financial instrument, the two measures of risk and expected return would provide an adequate decision basis for the investors. However, when assets are taken as a group, the risk character associated with each asset takes a new significance. The variation of the price of an asset may be due, as ‘Sharpe’ analyzed (see The Journal of Finance—William F. Sharpe—CAPM—1964), to either or both of two causes: (1) variations in the general market level, and (2) variations that are unique to that particular asset.

Different portfolios have different levels of expected return and risk. Typically, the higher the level of expected return, the greater the risk. Entities are faced with the decision of choosing a portfolio from the set of all possible risk-return combinations, where when they like returns, they dislike risk. Therefore, entities obtain different levels of utility from different risk-return combinations. The utility obtained from any possible risk-return combination is expressed by a utility function. The concept of the utility function in investments and decision-making under uncertainty was primarily formalized by John von Neumann and Oskar Morgenstern in their 1944 book, Theory of Games and Economic Behavior. They developed the Expected Utility Theory (EUT), which provides a mathematical basis for modeling decision-making under risk by using a utility function to represent preferences. The utility function expresses the preferences of entities over perceived risk and expected return combination. The portfolio that provides the largest possible expected return for given levels of risk is called an efficient portfolio. To construct an efficient portfolio, it is necessary to make some assumptions is that how investors behave when making investment decisions. One reasonable assumption is that investors are risk-averse. A risk-averse investor is an investor who, when faced with choosing between two investments with the same expected return but two different risks, prefers the one with the lower risk. In selecting portfolios, an investor seeks to optimize the expected portfolio return given his risk tolerance, alternatively, an investor seeks to minimize the risk that he is exposed to given some target expected return. Given a choice from the set of efficient portfolios, an optimal portfolio is the one that is the most preferred by the investor (see Mean-Variance Model for Portfolio Selection by Frank J. Fabozzi—2012).

There are six notable Nobel Prize winners, namely James Tobin, Harry Markowitz, Merton Miller, William Sharpe, Robert Merton, and Myron Scholes, in the field of financial economics, who have contributed to setting a framework for calculating the expected return of the portfolio. The most prominent and foundational framework is the ‘Modern Portfolio Theory’ by ‘Harry Markowitz’, which was published in the year 1952 and received the Nobel Prize in 1990 it has revolutionized the investment industry and also the approach for making investment decisions. American economist James Tobin was awarded the Nobel Prize in Economic Sciences in 1981. He received the prize for analyzing financial markets and their relations to expenditure decisions, employment, production, and prices (see James Tobin—https://www.nobelprize.org/prizes/economic-sciences/1981/summary/). Tobin extended Harry Markowitz's work on Modern Portfolio Theory. He introduced the concept of the “efficient frontier” and the idea that investors should diversify their portfolios by holding a mix of short-term risk-free assets (such as government bonds with maturity within one year) and risky assets (such as stocks). His key insight was that investors could achieve any desired risk-return combination by adjusting the proportion of risk-free and risky assets in their portfolio. This led to the development of the Capital Asset Pricing Model (CAPM).

### Mathematical Formulation:

The expected return of the portfolio E(Rₚ) is:

E(Rₚ)=w_{f}R_{f}+wₘR(Rₘ)

The standard deviation of the portfolio σₚ is:

σₚ=wₘσₘ

where: E(Rₚ) is the expected return of the portfolio, R_{f} is the risk-free asset, Rₘ is the risky asset, and w_{f} and wₘ are the weights of the risk-free and risky assets, respectively, with w_{f}+wₘ=1. The efficient frontier is derived by finding the optimal mix of w_{f} and wₘ that maximizes E(Rₚ) for a given σₚ.

The 1990 Nobel Memorial Prize in Economic Sciences was awarded jointly to Harry Markowitz, Merton Miller, and William Sharpe for their pioneering work in the field of financial economics. Their contributions fundamentally transformed the understanding of portfolio theory, corporate finance, and asset pricing (see Harry Markowitz, Merton Miller, and William Sharpe—https://www.nobelprize.org/prizes/economic-sciences/1990/summary/).

Theory: Harry Markowitz developed the Modern Portfolio Theory (MPT), which addresses the optimization of investment portfolios. The core idea is to maximize the expected return for a given level of risk through diversification.

### Model:

Expected Return: The return expected from a portfolio is the weighted average of the expected returns of the individual assets.

$$E ( {R}_{p} ) = {\sum }_{i = 1}^{n} {w}_{i} E ( {R}_{i} )$$

where E(Rₚ) is the expected return of the portfolio, wᵢ is the weight of the asset i in the portfolio, and E(Rᵢ) is the expected return of the asset i.

Portfolio Variance: The risk (variance) of a portfolio is determined by the weights of the assets, their variances, and their covariances.

$${σ}_{p}^{2} = {\sum }_{i = 1}^{n} {\sum }_{j = 1}^{n} {w}_{i} {w}_{j} {σ}_{ij}$$

where

$${σ}_{p}^{2}$$

is the portfolio variance, and σᵢⱼ is the covariance between asset i and asset j.

Efficient Frontier: The set of optimal portfolios that offer the highest expected return for a given level of risk or the lowest risk for a given level of expected return.

Theory: William Sharpe developed the Capital Asset Pricing Model (CAPM), which describes the relationship between systematic risk and expected return for assets, particularly stocks.

### Model:

### CAPM Equation:

E(Rᵢ)=R_{f}+βᵢ(E(Rₘ)−R_{f})
Where E(Rᵢ) is the expected return on asset i, R_{f} is the risk-free rate, βᵢ is the beta of the asset i, and E(Rₘ) is the expected return on the market portfolio.
Beta (β): A measure of an asset's volatility relative to the market.

$${β}_{i} = \frac{C o v ( {R}_{i} , {R}_{m} )}{Var ( {R}_{m} )}$$

where Cov is the covariance between the asset return and the market return, and Var is the variance of the market return.

With this above background, the entire investment portfolio industry revolves around the fundamental principles of ‘Modern Portfolio Theory’. There are several Mutual Funds (MFs), Exchange Traded Funds (ETFs), Hedge funds, Private Equity Funds, etc. which are professionally managing funds in the investment industry with the sole motto to maximize returns and minimize risk associated with the investment. However, there are seldom any funds providing returns beyond a certain level, which we believe is not fully optimized. The table shown in FIG. 1 illustrates average returns for 3 y, 5 y, 10 y, and 15 y of the top MFs/ETFs in the USA (Source: Google Finance, data as on Nov. 1, 2024).

Hence there is a long felt yet unresolved need for a system for automated portfolio management for optimizing an optimizable portfolio of assets. There is also a long felt yet unresolved need to derive an optimized expected return from a set of optimizable investment portfolios.

### SUMMARY OF THE INVENTION

This summary is provided to introduce a selection of concepts in a simplified form that are further disclosed in the detailed description of the invention. This summary is not intended to determine the scope of the claimed subject matter.

The system disclosed herein provides an automated portfolio management model for optimizing an optimizable portfolio of assets, for example, a financial portfolio of assets. The automated portfolio management model optimizes the expected returns of the optimizable portfolio of assets. The system comprises a memory and a processor communicatively coupled to the memory. The processor is configured to execute a plurality of instructions stored in the memory to implement multiple modules. The multiple modules comprise a data acquisition module configured to receive data, pre-process the received data, normalize and integrate the pre-processed data to create a comprehensive dataset for analysis. The received data is pre-processed using one or more of actuarial data models and credit worthiness to estimate an investor's risk. The modules further comprise a profile evaluation module 305 configured to receive data on an investor's goals, risk tolerance, return determination, investment horizon, tax implications, personal preferences etc., of the individual and (or) institutional investor. The profile evaluation module 305 is further configured to apply one or more machine learning algorithms to analyze and classify profiles of a plurality of investors dynamically and generate a detailed investor profile report, including a risk aversion index, specific investment objectives, etc. The modules further comprise an investment style evaluation module configured to analyze investor's historical investment behavior, trading patterns, market preferences, etc.; utilize clustering techniques, sentiment analysis, etc. to determine investor's preferred investment style; and output a categorized investment style tailored to investor's profile and preferences.

The modules further comprise an instrument selection module, also herein referred to as a financial instrument selection module, configured to use predictive models, including machine learning algorithms, to filter and select appropriate financial instruments; ensure diversification across sectors, industries, and asset classes based on an optimization criterion, generate a list of selected financial instruments for inclusion in the portfolio. The modules further comprise a portfolio construction module configured to apply multi-objective optimization (MOO) algorithms to construct the optimized portfolio as per the recommendations generated through Artificial Intelligence (AI)/Machine Learning (ML) model and approved by the investors; by utilizing the Modern Portfolio Theory (MPT), Black-Letterman model, mean-variance optimization, an unique return optimization model (‘TBD’ model), etc. The modules further comprise a portfolio optimization module configured to continuously and dynamically refine and optimize the portfolio using advanced MOO algorithms to optimize risk-adjusted returns; integrate AI-driven optimization techniques that adapt dynamically to the changing market condition and changing investor profiles; and output an optimized portfolio with updated allocations to achieve a superior performance.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, in an embodiment, various structural elements can be employed depending on the design choices of the system designer.

### BRIEF DESCRIPTION OF THE DRAWINGS

The patent or application file contains at least one drawing executed in color. Copies of this patent or patent application publication with color drawings will be provided by the Office upon request and payment of the necessary fee. The foregoing summary, as well as the following detailed description of the invention, is better understood when read in conjunction with the appended drawings. For illustrating the invention, exemplary constructions of the invention are shown in the drawings. However, the invention is not limited to the specific methods and structures/components disclosed herein. The description of a method step or a structure/component referenced by a numeral in a drawing is applicable to the description of that method step or structure/component shown by that same numeral in any subsequent drawing herein.

FIG. 1 illustrates average returns for 3 y, 5, 10 y, and 15 y of the top MFs/ETFs in the USA.

FIG. 2A illustrates a framework for optimizing the portfolio returns.

FIG. 2B illustrates a staging data mart and validation process.

FIG. 3 illustrates a system for an automated investment portfolio model for optimizing a portfolio of financial assets.

FIG. 4A illustrates a flowchart showing investor onboarding, risk scoring, risk tolerance interpretation, portfolio creation, portfolio adjustment, risk monitoring and reporting, etc.

FIGS. 4B-4C illustrates screenshots showing steps associated with onboarding an individual investor.

FIGS. 4D-4E illustrates screenshots showing steps associated with onboarding an institutional investor.

FIG. 5A illustrates a flowchart illustrating the decision-making process for evaluating the investor's risk tolerance.

FIG. 5B illustrates the risk-scoring process performed by the system shown in FIG. 3.

FIG. 5C illustrates risk tolerance interpretation based on a risk score range.

FIG. 5D illustrates the portfolio creation process.

FIG. 5E illustrates the dynamic adjustment process.

FIG. 5F illustrates the process of applying considerations for institutional investors.

FIG. 5G illustrates the risk monitoring and reporting process.

FIGS. 6A-6C illustrates an architecture overview for a portfolio construction module, for example, an Artificial Intelligence (AI)-based portfolio construction module.

FIG. 6D illustrates training/fine-tuning with financial data.

FIG. 6E illustrates Real-Time Processing with Retrieval-Augmented Generation (RAG) (Chatbot and Dashboard interaction).

FIG. 6F illustrates an adaptive learning feedback loop

FIG. 7 illustrates a flowchart showing the overall process followed by the model for the optimization of the expected return.

FIG. 8 illustrates a flowchart showing how some of the modules shown in FIG. 5 work together.

FIG. 9 illustrates a flowchart showing the process followed by a data collection module.

FIG. 10 illustrates a flowchart showing the process followed by an Artificial Intelligence (AI) training module.

FIG. 11 illustrates a flowchart showing a validation and expert feedback loop.

FIG. 12 illustrates a flowchart showing the process followed by AI prediction module.

FIG. 13 illustrates a flowchart showing the process followed by AI evaluation and adjustment module.

FIG. 14A illustrates a flowchart showing investor onboarding and outputting an investor profile based on queries answered during onboarding.

FIG. 14B illustrates a flowchart showing working of an investment style evaluation module that analyzes investor's historical investment behavior, trading patterns, and market preferences categorized investment style tailored to investor's profile and preferences.

FIG. 14C illustrates a flowchart showing working of an instrument section module, also herein referred to as a financial instrument selection module that generates a list of selected financial instruments for inclusion in the investor's portfolio.

FIG. 14D illustrates a flowchart showing working of a portfolio construction module.

FIG. 14E illustrates a flowchart showing working of a forecasting module.

FIG. 14F illustrates a flowchart showing working of a risk management and evaluation module.

FIG. 14G illustrates a flowchart showing working of a rebalancing module.

FIG. 14H illustrates a flowchart showing working of an Environmental, Social, and Governance (ESG) evaluation module.

FIG. 14I illustrates a flowchart showing working of a performance evaluation and reporting module.

FIG. 15 illustrates the Buy-Sell Process Flow Chart.

FIG. 16 illustrates a graph showing real market vs AI prediction.

FIG. 17 illustrates a security diagram for user authentication, secure data flow and privacy.

FIG. 18 illustrates key components of personal AI LLM cloud architecture.

FIG. 19 illustrates a graph showing annualized returns and volatility.

FIG. 20 illustrates a data descriptions table.

FIG. 21 illustrates a graph showing Portfolio Risk vs Return.

FIG. 22 illustrates a graph showing annualized returns of a select stocks vs volatility.

FIG. 23 shows a table showing a Calculation of Expected Return (table) (end result).

FIG. 24 illustrates the roles and responsibilities assigned to each of the roles.

FIG. 25 illustrates an Artificial Intelligence (AI) based platform.

FIG. 26A illustrates results for portfolio no. 4 against S&P500 benchmark.

FIG. 26B illustrates results for portfolio no. 1 against the S&P500 benchmark.

FIG. 26C illustrates results for portfolio no. 2 against the S&P500 benchmark.

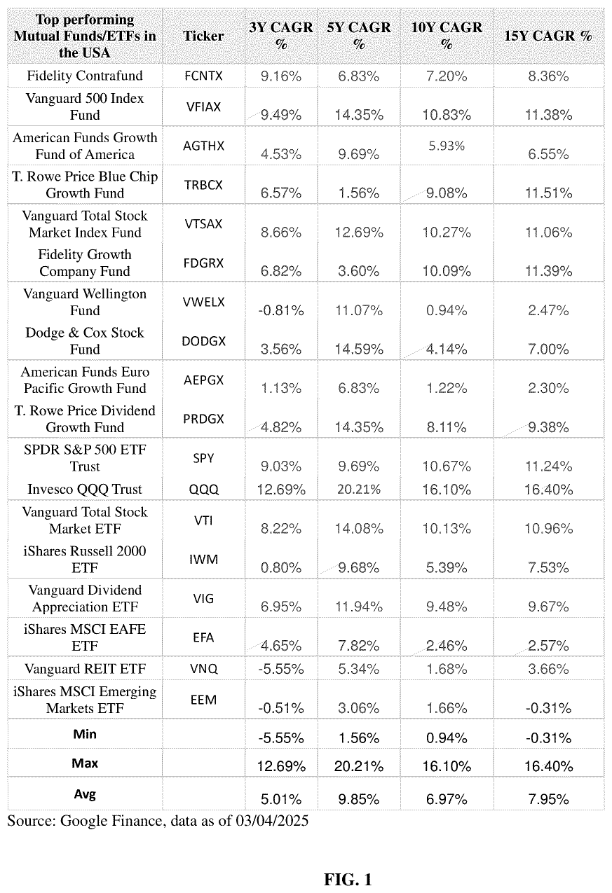

### DETAILED DESCRIPTION OF THE INVENTION

In today's dynamic financial environment, investors require advanced tools to optimize their portfolios, enhance returns, and manage risk efficiently. Modern markets demand more than traditional manual investment processes, which are not only inefficient and error-prone, but also fail to capitalize on available technological advances. This system presents a comprehensive solution that combines advanced data analytics, Generative Artificial Intelligence (GenAI), Machine Learning, Customized LLM training modules, and a unique return optimization model to automate investment portfolio management, to optimize returns while effectively managing risk.

Traditional investment management often relies on manual analysis and subjective decision-making, leading to suboptimal portfolio performance and increased risk exposure. In contrast, the automated investment model disclosed herein offers a data-driven approach to the optimization of a portfolio's return (total Investment return over a period), utilizing GenAI data for past performances and quantitative techniques to enhance investment decisions and optimize risk-adjusted expected returns.

Incorporating an Investment Policy Statement (IPS) into the automated investment model adds a layer of customization and risk management, aligning the selection process with the portfolio universe's volatility and the investor's inherent financial tolerance including actuarial data for risk tolerance. Currently, such an approach is not incorporated directly into a software process, method and system technology in the market which provides such a comprehensive and objective predictive data-based strategy and system for multi-asset investment decision-making.

To address the gaps and innovate within the field, an advanced dynamic investment model is disclosed that will help to optimize the expected returns of the optimizable financial portfolio, the Expected Return Model is designed to overcome the limitations of traditional economic models and provide a more robust framework for optimizing the portfolio returns. This model follows an intuitive structured approach, encompassing three key steps:
a) Model Innovation;
b) Framework Development, and
c) Design of an Automated Investment Software Product.

The present invention discloses an innovative automated investment model designed to enhance the performance of the optimizable portfolio, for example, the optimizable financial portfolio, by integrating advanced Data Analytics, Generative AI, Machine Learning algorithms, customized LLMs, and several other optimization techniques. Leveraging historical market data and real-time information, the model constructs and manages investment portfolios tailored to individuals, entities, family offices, and institutional investor preferences and market conditions.

The model constructs the investment portfolios as follows: The uniqueness of the model lies in its ability to dynamically leverage optimizable information about investors from multiple external sources, such as APIs from Dun & Bradstreet (DNB) or from similar database APIs for institutional credit ratings, actuarial data for assessing long-term liabilities, and various other financial data providers. These data inputs are seamlessly integrated and processed by the model to build a comprehensive profile of the investor's risk appetite. The model evaluates critical factors such as financial health, investment history, and market behavior to determine the optimal risk exposure. This real-time information enables the model to continually refine its recommendations, adjusting investment strategies based on both individual characteristics and changing market conditions. By dynamically adapting to both internal (investor-specific) and external (market) data, the model ensures precision in portfolio construction, making it highly innovative and adaptive. Additionally, the use of APIs allows for continuous updates and ensures that the investor's portfolio is aligned with the latest financial information, making the process more automated, data-driven, and efficient. This integration of multiple data streams gives the model a distinct advantage in accurately assessing risk and optimizing investment strategies, setting it apart from traditional methods of portfolio management.

The model employs techniques to select financial instruments comprising equities, bonds, commodities, real estate, and alternative assets based on a predetermined criterion. The model leverages a combination of rule-based algorithms and pattern recognition powered by generative AI to identify the optimal instruments, for example, optimal financial instruments, across a diverse range of asset classes. By analysing vast datasets and market trends, the model selects instruments based on predefined criteria and emerging patterns, ensuring a well-rounded and dynamic portfolio.

For each asset class, the model uses relevant benchmarks to evaluate and choose financial instruments:

Stocks: The model analyzes data from different indices actively operating in the capital market to identify suitable equity investments. It considers both individual stocks and sector performance based on fundamental and technical indicators.

Bonds: For fixed-income securities, the model uses benchmarks like the Bloomberg Barclays U.S. Aggregate Bond Index, the ICE B of A U.S. Treasury Index, or the Bloomberg Global Aggregate Index to select government, corporate, and municipal bonds. The selection focuses on factors such as yield, credit quality, and duration.

Commodities: The model evaluates commodity-based instruments using benchmarks like the S&P GSCI Commodity Index or Bloomberg Commodity Index, covering energy, metals, agriculture, and more. It includes physical commodities as well as commodity ETFs and futures contracts.

Real Estate: For real estate exposure, the model relies on the MSCI U.S. REIT Index or FTSE EPRA/NAREIT Global Real Estate Index to assess REITs and other real estate-related instruments, focusing on market capitalization, property sectors, and geographic regions.

Currencies: In the currency market, the model references the U.S. Dollar Index (DXY) or the J.P. Morgan Global FX Volatility Index to identify forex opportunities, focusing on currency pairs with significant volatility or trends.

Hedge Funds and Alternatives: For alternative investments, the model uses indices such as the HFRX Global Hedge Fund Index or the Credit Suisse Hedge Fund Index to identify opportunities in hedge funds, private equity, and venture capital.

ETFs and Mutual Funds: The model references benchmarks like the Morningstar U.S. Mutual Fund Indexes or the S&P Target Date Indices to evaluate passive and actively managed funds, aiming for diversified exposure across multiple asset classes.

Derivatives (Options & Futures): In derivatives markets, the model looks at instruments tied to indices such as the CBOE Volatility Index (VIX) or the S&P 500 Futures, selecting options and futures that align with the overall portfolio strategy.

By combining generative AI-driven pattern recognition with rule-based selection criteria and benchmarks, the model ensures an optimal mix of financial instruments. This approach maximizes portfolio diversification while adapting to market conditions and investor-specific goals. The invention includes various inventive strategies such as growth, value, and income strategies, among others, to select the most suitable financial instruments.

At the core is a unique combination of active and passive financial instruments within the portfolio, combined with a variable dynamic constant and dynamic auto-correction factor. The system and method disclosed herein allows for a better optimized and accurate representation of the expected return by considering various influencing and contributing parameters including conservative growth rate, potential market risk, corrections, etc. The system and method disclosed herein aims to deliver superior dynamically risk-adjusted returns by continuously adapting to volatile market conditions, dynamic investor preferences, etc.

The dynamic constant in this model is a fixed value derived from the analysis of historical data spanning the past several decades. It is not subject to ongoing change but is instead based on long-term market patterns. This constant reflects established market behaviour, trends, and average growth rates observed over a century. It acts as a foundational anchor, providing a reliable baseline to guide the portfolio's strategic decisions.

Dynamic Constant (Historical Anchor): The dynamic constant encapsulates long-term trends by analysing historical data to identify recurring growth rates, volatility patterns, and market shifts. This constant helps the portfolio remain grounded in what has been proven to work over a substantial period of time. It provides an informed basis for managing expectations about returns and risk, given historical precedents.

Purpose: Dynamic Constant is a metric that represents stable, long-term market performance, allowing the portfolio to set benchmarks, growth expectations, and risk assessments based on past behaviour. Although it remains fixed, it reflects dynamic historical inputs, such as economic cycles, market corrections, and sustained bull markets.

Example: If, over the past several decades, the S&P 500 has demonstrated an average annual growth of around 7%, this constant might guide the portfolio in setting expected returns, or it might act as a benchmark for evaluating current market conditions. When the market grows at a rate significantly higher or lower than this historical average, it could trigger adjustments within the portfolio.

Dynamic Auto-Correction Factor (Agile Risk Management): While the dynamic constant provides a historical benchmark, the dynamic auto-correction factor ensures that the portfolio responds flexibly to short-term market fluctuations. It automatically adjusts the portfolio's asset allocation when the portfolio deviates from its optimal risk-return profile. This feedback mechanism helps the portfolio react to real-time market movements, mitigating risks, or taking advantage of opportunities as they arise.

Purpose: The dynamic auto-correction factor continuously monitors the portfolio's performance relative to its risk and return objectives. When the portfolio's risk profile exceeds or falls below the target due to market volatility or asset-specific performance, the auto-correction factor rebalances the portfolio to bring it back into alignment with its goals.

Example: If the equity portion of the portfolio surges due to a sudden market rally, leading to an imbalance in risk exposure, the auto-correction factor would adjust the portfolio by reducing equity holdings and increasing safer asset classes like bonds to restore the intended risk level.

Interaction Between Dynamic Constant and Auto-Correction Factor: The model combines the stability of the dynamic constant, derived from a century of market data, with the flexibility of the dynamic auto-correction factor. The constant provides a long-term view, anchoring the portfolio in historical trends and setting expectations for market performance. In contrast, the auto-correction factor manages short-term risks, ensuring the portfolio remains agile and responsive to market shifts.

Together, these elements create a portfolio management strategy that is both stable and adaptive. The dynamic constant ensures that decisions are informed by historical precedence, while the dynamic auto-correction factor maintains ongoing alignment with the investor's risk and return objectives, even in fluctuating markets.

With the unique combination of active and passive financial instruments within the portfolio, combined with the variable dynamic constant and the dynamic auto-correction factor, the goal with this approach is to optimize return by utilizing various potential combinations of financial instruments. Furthermore, by incorporating a dynamic constant into the model that has been taken from the past several decades of S&P 500 index data. The S&P 500 was chosen since it is one of the only indices with nearly 100 years of historical data. Next, since the S&P 500 was first established in 1927, the data has been sorted into groups of 3, 5, 8, 10, 13, . . . , n years. For the same group years, corrective variable in the market has also been calculated. The corrective variable varies for each group year. However, this approach still has the following limitations:
1) Predicting the Correction Variable: Future market corrections are unpredictable when relying solely on past data.
2) Financial instrument combinations: The US capital market comprises about 15,000+ financial instruments, comprising approximately 6,000+ publicly traded equities, approximately 8,000+ mutual funds, approximately 2000+ exchange-traded funds (ETFs), bonds, commodities, real estate, currencies, and several other assets. The number of combinations that can be created will be measured in trillions rather than millions or billions. Therefore, finding the best combinations with the best subgroups to optimize portfolio returns is not achievable for humans.

To overcome the above limitations, Artificial Intelligence (AI)/Machine Learning (ML) approach is used.

The Artificial Intelligence (AI)/Machine Learning (ML) approach uses a Machine Learning Model. In an embodiment, the system 300 comprises a portfolio manager/Artificial Intelligence (AI) Agent 311a which is a part of the portfolio optimization module 311. The portfolio manager/AI Agent 311a employs reinforcement learning (RL) model to find the optimal combination of financial instruments. In the reinforcement learning (RL) model, an AI agent 311a iteratively tries different portfolio combinations and learns from the market's response (reward in the form of returns or risk minimization).

Feature Selection and Data Preparation while using the Artificial Intelligence (AI)/Machine Learning (ML) approach: The system uses historical stock prices, volatility, correlations, and other financial indicators as inputs (features). It also considers constraints like diversification, risk tolerance, and expected return.

Optimization while using the Artificial Intelligence (AI)/Machine Learning (ML) approach: The RL model simulates millions of portfolio allocations. The RL model uses a reward function to maximize returns while minimizing risk. Over time, the AI agent 311a learns which combinations of instruments, for example, financial instruments such as stocks and weightings in the portfolio produce the best risk-adjusted returns (e.g., using metrics like Sharpe ratio, etc.).

Given below is a description of how reward function is used by the RL model to maximize returns while minimizing risk. To best understand this, let us understand the overview of the Machine Learning Model with Reinforcement Learning (RL). The AI agent 311a uses Reinforcement Learning (RL) to iteratively improve portfolio allocation. Here's how it works in detail:
1) Investor Preference/Risk Appetite:
   a. The AI agent 311a uses constraints like the investor's risk tolerance, expected returns, and diversification requirements.
   b. Example: A moderate-risk investor might prefer a balance of high-growth stocks and stable, dividend-paying stocks.
2) Example Combinations of Stocks: Suppose the AI agent 311a evaluates the following three combinations of stocks:
   Combination 1:
      Stocks: AAPL (Weight: 40%), MSFT (Weight: 30%), AMZN (Weight: 30%)
      Risk Level: Moderate
      Historical Return: 12%
   Combination 2:
      Stocks: TSLA (Weight: 50%), NVDA (Weight: 30%), META (Weight: 20%)
      Risk Level: High
      Historical Return: 18%
   Combination 3:
      Stocks: JNJ (Weight: 30%), KO (Weight: 40%), PEP (Weight: 30%)
      Risk Level: High
      Historical Return: 8%
3) How the AI Agent 311a selects the best combination:
   a. Reward Function: The AI agent 311a uses a reward function to evaluate each combination of financial instruments. A common reward function might optimize the combination of instruments for risk-adjusted returns, such as the Sharpe Ratio:

$$Reward = \frac{Expected Return - Risk - Free Rate}{Portfolio Volatility}$$

For example:
Combination 1: Reward=(12%−2%)/10%=1.0
Combination 2: Reward=(18%−2%)/15%=1.07
Combination 3: Reward=(8%−2%)/5%=1.2
Based on this, combination 3 is preferred due to the highest reward, despite low raw returns, because it balances risk and returns better.

The AI agent 311a then ranks the combinations of financial instruments based on the calculated reward function. For example, combination 3 is ranked 1^{st}, combination 2 is ranked 2^{nd} and combination 1 is ranked 3^{rd}. The ranked combinations of financial instruments are used to select the combinations of financial instruments for inclusion in an optimized portfolio of assets.
4) Scaling to Thousands of combinations:
   a. Techniques to reduce search space:
      i. Monte Carlo Simulations: Randomly simulate millions of portfolio allocations and narrow them down based on preliminary rewards.
      ii. Deep Q-learning: Uses neural networks to predict the optimal portfolio based on historical patterns and current market conditions.
   b. Parallel processing:
      i. Use GPUs and distributed computing to evaluate multiple combinations simultaneously.
   c. Smart sampling:
      i. Prioritize combinations with higher likelihood of meeting the reward criteria (e.g. stocks with high Sharpe ratios).
5) Learning from market response:
   a. The AI agent 311a continuously updates its strategy using new data.
   b. Example: If a previously selected portfolio underperforms due to unexpected market volatility, the agent adjusts its model to give less weight to highly volatile stocks in the future.
   c. The learned behavior is reused to further refine the optimization process.

### Feature Selection and Data Preparation

The AI system uses a rich dataset to evaluate stock combinations using multiple APIs like Yahoo Finance, Alpha Vantage, Bloomberg, MorningStar, SEC filings, etc. Examples of some parameters include:

Historical Features: Prices, returns, volatility, beta, stock correlations, volumes, etc.

Macroeconomic Indicators: Interest rates, inflation, GDP growth, etc.

Investor Constraints: Risk tolerance, sectoral diversification, ESG preferences, etc.

The data is cleaned normalized and structured into inputs (features) for the model.

Optimization with AI

The AI uses the RL model to optimize the portfolio:
1) Simulating millions of portfolios:
   a. The RL agent creates millions of portfolios with different stock weightings.
   b. It evaluates the rewards for each portfolio.
2) A. Reward Function Example:
   a. Goal: Maximize risk-adjusted returns (e.g. Sharpe Ratio)
   b. Reward Function:
      i. R=w₁·Sharpe Ratio (SR)−w₂·Tracking Error (TE)+w₃·Diversification Index (DI)
   c. Weights (w₁, w₂, w₃) determine the importance of each factor.
   d. Tracking Error: It measures the deviation of a portfolio's performance from its benchmark. It is often used to assess how closely a portfolio replicates or tracks the returns of its benchmark index.

$$Tracking Error = \sqrt{\frac{1}{N - 1} {\sum }_{i = 1}^{N} {( {R}_{P , i} - {R}_{B , i} )}^{2}}$$

e. Diversification Index: It measures how well-diversified a portfolio is across various assets, sectors, or asset classes. It quantifies the extent to which the portfolio avoids concentration in a few investments and spreads risk.

$$i . Diversification Ratio = \frac{{\sum }_{i = 1}^{N} {w}_{i} . {σ}_{i}}{{σ}_{p}}$$

f. Example:
   i. Portfolio A: SR=1.2, TE=0.05, DI=0.9
   ii. Portfolio B: SR=1.0, TE=0.03, DI=0.95
g. Rewards:
   i. R_{A}=1.2−0.05+0.9=2.05
   ii. R_{B}=1.0−0.03+0.95=1.92
h. Portfolio A is chosen.
B. Real-life example: Portfolio construction using Reward Function (using computer codes)
   The reward function is the core evaluation engine of the portfolio selection system. It is designed to rank portfolios by quantifying balance between:
      Expected Returns
      Risk (Volatility/Variance)
      External Risk
This enables a dynamic and intelligent selection of high-potential portfolios that are optimized both quantitatively and contextually (market sentiment, volatility regimes, etc.)
C. Step-by-Step Reward Function Workflow:
   1. Generate Random Portfolios
      We use combinatorial logic to create random sets of stock portfolios (typically 5-10 stocks per portfolio)
   2. Calculate Portfolio Metrics
   For each portfolio, calculate:
      Expected Return (annualized)
      Variance (risk)
      Sharpe Ratio
      ML Risk Indicators (simulated or real ML inputs)
   3. Apply Reward Function
      Score each portfolio using the reward function formula.
      Higher scores indicate more desirable portfolios.
   4. Rank Portfolios.
      Sort portfolios based on their reward score.
      Display the top candidates for selection.
   5. Interactive Portfolio Selection
      User selects a portfolio from ranked list.
   6. Redefine Portfolio Weighting
   Within the selected portfolio:
      Calculate individual stock Sharpe Ratios.
      Assign higher weights to stocks with higher Sharpe Ratios.
      Exclude stocks with negative Sharpe Ratios by assigning zero weight.
   7. Portfolio Rebalancing and Benchmarking
      Simulate portfolio growth starting from $100.
      Compare it to S&P500 benchmark, also rebased to $100.
   8. Performance Reporting
      Display:
      Visual performance comparison (graph)
      Numerical metrics (CAGR, Total Return, Volatility, Sharpe Ratio, Max Drawdown)
   9. Technical Uniqueness
      Combines quantitative risk-return models with external ML-based risk signals
      Dynamic weight assignment based on stock-level Sharpe Ratios
      Interactive portfolio selection workflow
      Automate performance evaluation
      Flexible design for future integration (e.g., real-time sentiment feeds)
   10. Future Enhancements
      To integrate real ML-driven risk signals (volatility models, macroeconomic indicators).
      Automate hyperparameter optimization to fine-tune portfolio selection.
      Enable back-testing and forward-testing on different time horizons.
      Build into interactive dashboards.
[12]: #Convert to DataFrame and rank portfolios
   results_df=pd.DataFrame(portfolio_results).sort_values(by=Reward Score′, ascending=False).reset ir
print (“Top Portfolios Ranked by Reward Score:\\n”)
print(results_df[[‘Portfolio Number’, ‘Portfolio’, ‘Reward Score’, ‘Sharpe Ration’]]) Top Portfolios Ranked by Reward: \n

| Portfolio | | | Reward | Sharpe |
|---|---|---|---|---|
| Number | | Portfolio | Score | Ratio |
| 0 | 4 | (KKR, NVDA, TRGP, WAB, WMT) | 0.264977 | 1.680537 |
| 1 | 2 | (GDDY, GS, OKE, RCL, TPL) | 0.181312 | 1.304222 |
| 2 | 5 | (BSX, ISRG, NI, TPL, WAB) | 0.160799 | 1.315839 |
| 3 | 3 | (AXP, KMI, PLTR, SYF, TMUS) | 0.132828 | 1.124659 |
| 4 | 1 | (CINF, CTAS, GS, MSI, SYF) | 0.118990 | 1.103998 |

[*]: #Step 5: User selects portfolio
   selection=int (input (“\\nSelect a Portfolio Number (e.g., 1, 2, or 3):”))
selected_portfolio=results_df.loc[results_df[‘Portfolio Number’]==selection, ‘Portfolio’].values[0]
print (f“\\n You selected Portfolio {selection}: {selected_portfolio}”)
\nSelect a Portfolio Number (e.g., 1, 2, or 3): 4
Result for Portfolio #4
[15]: #Assign weights based on Sharpe ratio
   sharpe_ratios=sharpe_ratios.clip (lower=0) #Set negative Sharpe ratios to zero weights=sharpe_ratios/sharpe_ratios.sum( )
[16]: print(“\\nIndividual Stock Sharpe Ratios and Weights:”)
   stock_details=pd.DataFrame({‘Sharpe Ratio’: sharpe_ratios, ‘Weight’: weights}) print(stock_details)
   \nIndividual.Stock Sharpe Ratios and Weights:

| Ticker | Sharpe Ratio | Weight |
|---|---|---|
| KKR | 1.008558 | 0.175938 |
| NVDA | 1.062144 | 0.185286 |
| TRGP | 1.775412 | 0.309713 |
| WAB | 1.014817 | 0.177030 |
| WMT | 0.871519 | 0.152033 |

[20]: print (“\\nPerformance Comparison Table:”)
   print (comparison_df.to_string(index=False))
   \nPerformance Comparison Table:

| Metric | Selected Portfolio | S&P500 Benchmark |
|---|---|---|
| CAGR | 49.50% | 12.53% |
| Total Return | 445.79% | 65.76% |
| Volatility | 24.12% | 16.51% |
| Sharpe Ratio | 2.05 | 0.76 |
| Max Drawdown | −31.65% | −27.11% |

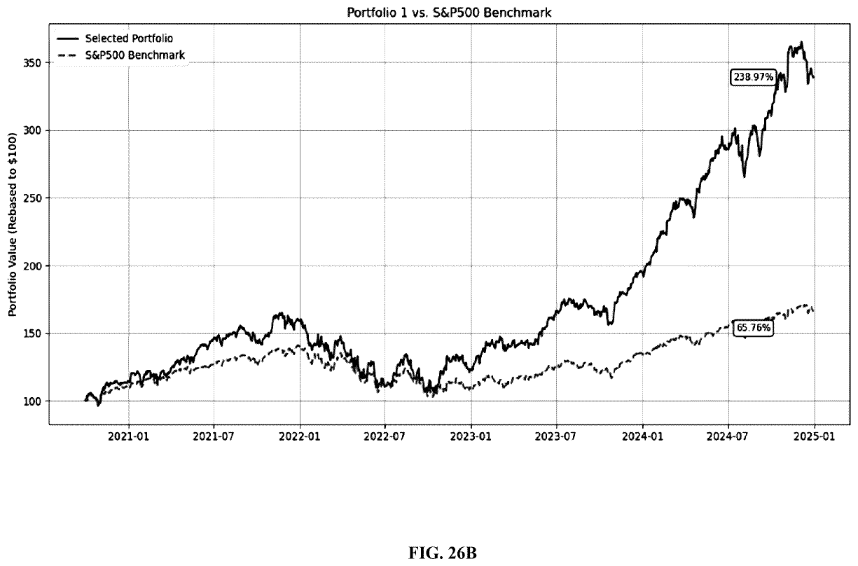

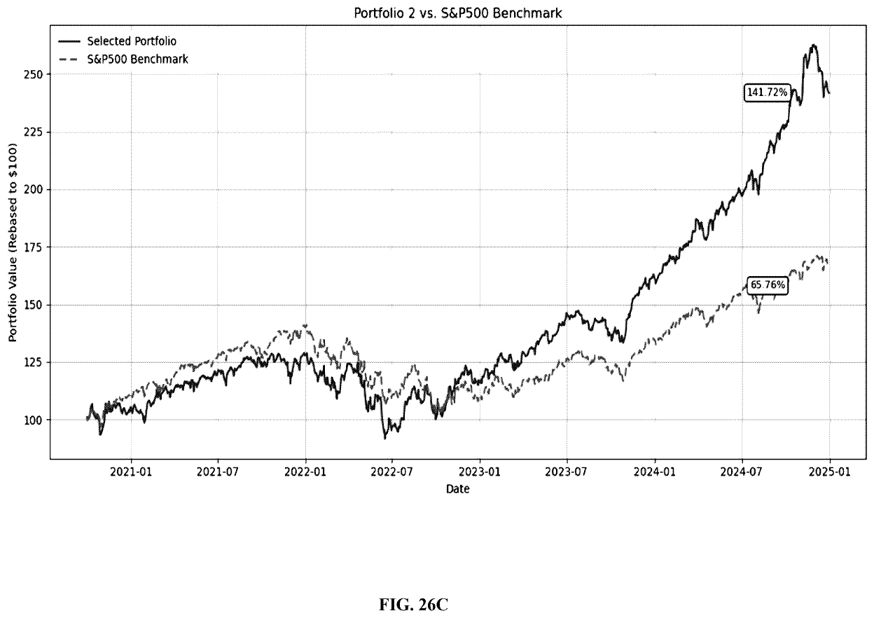

FIG. 26A illustrates results for portfolio no. 4 against S&P500 benchmark.
Result for Portfolio #1
[16]: print(“\\nIndividual Stock Sharpe Ratios and Weights:”)
   stock_details=pd.DataFrame({‘Sharpe Ratio’: sharpe_ratios, ‘Weight’: weights})
   print(stock_details)
   \nIndividual.Stock Sharpe Ratios and Weights:

| Ticker | Sharpe Ratio | Weight |
|---|---|---|
| NVDA | 1.062144 | 0.236919 |
| SYF | 0.649644 | 0.144908 |
| TMUS | 0.697063 | 0.155485 |
| TT | 1.059477 | 0.236325 |
| WAB | 1.014817 | 0.226363 |

[20]: print (“\\nPerformance Comparison Table:”)
   print (comparison_df.to_string(index=False))
   \nPerformance Comparison Table:

| Metric | Selected Portfolio | S&P500 Benchmark |
|---|---|---|
| CAGR | 33.28% | 12.53% |
| Total Return | 238.97% | 65.76% |
| Volatility | 23.77% | 16.51% |
| Sharpe Ratio | 1.40 | 0.76 |
| Max Drawdown | −30.90% | −27.11% |

FIG. 26B illustrates results for portfolio no. 1 against the S&P500 benchmark.
Result for Portfolio #2
[16]: print(“\\nIndividual Stock Sharpe Ratios and Weights:”)
   stock_details=pd.DataFrame({‘Sharpe Ratio’: sharpe_ratios, ‘Weight’: weights})
   print(stock_details)
   \nIndividual.Stock Sharpe Ratios and Weights:

| Ticker | Sharpe Ratio | Weight |
|---|---|---|
| BSX | 0.878400 | 0.210447 |
| CTAS | 0.825730 | 0.197828 |
| FI | 0.668667 | 0.160199 |
| MSI | 1.200075 | 0.287513 |
| RCL | 0.601110 | 0.144014 |

[20]: print(“\\nPerformance Comparison Table:”)
   print (comparison_df.to_string(index=False))
   \nPerformance Comparison Table:

| Metric | Selected Portfolio | S&P500 Benchmark |
|---|---|---|
| CAGR | 22.86% | 12.53% |
| Total Return | 141.72% | 65.76% |
| Volatility | 19.86% | 16.51% |
| Sharpe Ratio | 1.15 | 0.76 |
| Max Drawdown | −28.90% | −27.11% |

FIG. 26C illustrates results for portfolio no. 2 against the S&P500 benchmark.

### 3) Learning Through Iteration:

a. The agent records which portfolios performed well in previous simulations
b. It uses this knowledge to prioritize promising combinations in future iterations.

Real Examples using Python Codes with different strategy: Given Below are some real world examples which demonstrate how a computer code can deliver better results than a human. Based on these codes, we can further build the Machine Learning and AI models which can give more superior results as compared to manual computer coding. In the analysis shown below, 5 years historical data from 2019-2024 is used.

In this example, 65 Aristocrat Stocks are taken and bifurcated these stocks into three different portfolios.

### List of Aristocrats:

| Sr. | | | |
|---|---|---|---|
| No. | Company | Ticker | Sector |
| 1 | A. O. Smith | AOS | Industrials |
| 2 | Abbott Laboratories | ABT | Health Care |
| 3 | AbbVie | ABBV | Health Care |
| 4 | AFLAC | AFL | Financials |
| 5 | Air Products & Chemicals | APD | Materials |
| 6 | Albemarle Corporation | ALB | Materials |
| 7 | Amcor | AMCR | Materials |
| 8 | Archer-Daniels-Midland Co | ADM | Consumer Staples |
| 9 | Atmos Energy Corp | ATO | Utilities |
| 10 | Automatic Data Processing | ADP | Information Technology |
| 11 | Becton Dickinson & Co | BDX | Health Care |
| 12 | Brown & Brown Inc. | BRO | Financials |
| 13 | Cardinal Health Inc | CAH | Health Care |
| 14 | Caterpillar Inc | CAT | Industrials |
| 15 | C. H. Robinson | CHRW | Industrials |
| 16 | Chevron Corp | CVX | Energy |
| 17 | Chubb Limited | CB | Financials |
| 18 | Church & Dwight | CHD | Consumer Staples |
| 19 | Cincinnati Financial Corp | CINF | Financials |
| 20 | Cintas Corp | CTAS | Industrials |
| 21 | Clorox | CLX | Consumer Staples |
| 22 | Coca-Cola Co | KO | Consumer Staples |
| 23 | Colgate-Palmolive | CL | Consumer Staples |
| 24 | Consolidated Edison Inc | ED | Utilities |
| 25 | Dover Corp | DOV | Industrials |
| 26 | Ecolab Inc | ECL | Materials |
| 27 | Emerson Electric | EMR | Industrials |
| 28 | Essex Property Trust | ESS | Real Estate |
| 29 | Expeditors International of | EXPD | Industrials |
| | Washington | | |
| 30 | Exxon Mobil Corp | XOM | Energy |
| 31 | Fastenal | FAST | Industrials |
| 32 | Federal Realty Investment | FRT | Real Estate |
| | Trust | | |
| 33 | Franklin Resources Inc | BEN | Financials |
| 34 | General Dynamics | GD | Industrials |
| 35 | Genuine Parts Company | GPC | Consumer Discretionary |
| 36 | Hormel Foods Corp | HRL | Consumer Staples |
| 37 | Illinois Tool Works | ITW | Industrials |
| 38 | IBM | IBM | Information Technology |
| 39 | The J. M. Smucker Company | SJM | Consumer Staples |
| 40 | Johnson & Johnson | JNJ | Health Care |
| 41 | Kenvue, Inc. | KVUE | Consumer Staples |
| 42 | Kimberly-Clark | KMB | Consumer Staples |
| 43 | Linde plc | LIN | Materials |
| 44 | Lowe's | LOW | Consumer Discretionary |
| 45 | McCormick & Company | MKC | Consumer Staples |
| 46 | McDonald's Corp | MCD | Consumer Discretionary |
| 47 | Medtronic plc | MDT | Health Care |
| 48 | NextEra Energy | NEE | Utilities |
| 49 | Nordson Corp | NDSN | Industrials |
| 50 | Nucor Corp | NUE | Materials |
| 51 | Pentair | PNR | Industrials |
| 52 | PepsiCo | PEP | Consumer Staples |
| 53 | PPG Industries | PPG | Materials |
| 54 | Procter & Gamble | PG | Consumer Staples |
| 55 | Realty Income | O | Real Estate |
| 56 | Roper Technologies | ROP | Industrials |
| 57 | S&P Global Inc | SPGI | Financials |
| 58 | Sherwin-Williams | SHW | Materials |
| 59 | Stanley Black & Decker | SWK | Industrials |
| 60 | Sysco Corp | SYY | Consumer Staples |
| 61 | T Rowe Price Group Inc | TROW | Financials |
| 62 | Target Corp | TGT | Consumer Discretionary |
| 63 | W. W. Grainger | GWW | Industrials |
| 64 | Walmart Inc. | WMT | Consumer Staples |
| 65 | West Pharmaceutical | WST | Health Care |
| | Services | | |

1) Based on certain Fundamental Parameters, Scores are assigned to the stocks dynamically
2) Based on the Scores calculated, a threshold is set on the scale of 1 to group the stocks into different categories
   a. Stocks with Excellent fundamental score (>=0.75)
   b. Stocks with Above Average fundamental score (>=0.55)
   c. Stocks with Average fundamental score (>=0.35)
   d. Stocks with Below Average fundamental score (<0.35)
3) Then we calculate the total Combinations:

Total Combinations=Number of Stock Combinations^{Number of total Stocks}−1
4) Then we use different methods to assign weights dynamically to the stocks. The Python code will iterate according to the total combinations calculated (weighting methods like Monte Carlo Simulation, Mean-Variance Optimization, etc.).
5) Excellent Stock Combinations: 2⁹−1=511; Above Average Stocks Combinations: 2³²−1=4.3 Bn; Average Stocks Combinations: 2²³−1=8.4 Mn;
6) With a unique strategy we calculated Portfolio Returns using different weights
   a. Monte-Carlo Optimized Portfolio Results: Weighted Average Time-Adjusted Portfolio Return: 39.83%
   b. MVO Weights Portfolio Results: Weighted Average Time-Adjusted Portfolio Return: 32.53%
7) Then we use Technical Scoring to generate Buy/Sell signals.
8) Then we run the Python Codes to optimize the trades based on the signals generated above. We then combined all the trades for all the stocks and calculate the weighted average portfolio time-adjusted returns.

### Output: Grouped Stocks:

| Excellent Stocks | Above Average | Average |
|---|---|---|
| CAT: Final Score = 0.76 | AOS: Final Score = 0.60 | AMCR: Final Score = 0.52 |
| CVX: Final Score = 0.77 | ABT: Final Score = 0.71 | ADP: Final Score = 0.54 |
| CB: Final Score = 0.78 | ABBV: Final Score = 0.75 | BDX: Final Score = 0.49 |
| KO: Final Score = 0.82 | AFL: Final Score = 0.68 | CAH: Final Score = 0.37 |
| XOM: Final Score = 0.76 | APD: Final Score = 0.58 | CHRW: Final Score = 0.51 |
| JNJ: Final Score = 0.84 | ALB: Final Score = 0.71 | CHD: Final Score = 0.50 |
| MCD: Final Score = 0.83 | ADM: Final Score = 0.62 | CTAS: Final Score = 0.48 |
| NEE: Final Score = 0.83 | ATO: Final Score = 0.61 | CLX: Final Score = 0.42 |
| O: Final Score = 0.87 | BRO: Final Score = 0.62 | CL: Final Score = 0.54 |
| | CINF: Final Score = 0.59 | ECL: Final Score = 0.45 |
| | ED: Final Score = 0.63 | FAST: Final Score = 0.52 |
| | DOV: Final Score = 0.57 | BEN: Final Score = 0.53 |
| | EMR: Final Score = 0.74 | GD: Final Score = 0.51 |
| | ESS: Final Score = 0.61 | GPC: Final Score = 0.45 |
| | EXPD: Final Score = 0.58 | HRL: Final Score = 0.47 |
| | FRT: Final Score = 0.66 | SJM: Final Score = 0.37 |
| | ITW: Final Score = 0.56 | KVUE: Final Score = 0.36 |
| | IBM: Final Score = 0.69 | KMB: Final Score = 0.50 |
| | LIN: Final Score = 0.69 | MKC: Final Score = 0.46 |
| | LOW: Final Score = 0.69 | NDSN: Final Score = 0.50 |
| | MDT: Final Score = 0.60 | PPG: Final Score = 0.53 |
| | NUE: Final Score = 0.72 | SHW: Final Score = 0.48 |
| | PNR: Final Score = 0.57 | SWK: Final Score = 0.44 |
| | PEP: Final Score = 0.64 | |
| | PG: Final Score = 0.68 | |
| | ROP: Final Score = 0.71 | |
| | SPGI: Final Score = 0.69 | |
| | SYY: Final Score = 0.63 | |
| | TROW: Final Score = 0.71 | |
| | TGT: Final Score = 0.66 | |
| | GWW: Final Score = 0.56 | |
| | WMT: Final Score = 0.59 | |
| | WST: Final Score = 0.59 | |

Analysis of Stocks with Excellent Fundamental Scoring: Portfolio 1

| | Time- | MC | MC Net | MVO | MVO Net |
|---|---|---|---|---|---|
| | Adjusted | Weight | Return | Weights | Return |
| Stock | Return (%) | (%) | (%) | (%) | (%) |
| CAT | 41.8 | 22.0 | 9.2 | 39.0 | 16.3 |
| CVX | 61.9 | 15.2 | 9.4 | 0.0 | 0.0 |
| CB | 31.2 | 22.9 | 7.2 | 23.7 | 7.4 |
| KO | 19.6 | 1.6 | 0.3 | 3.3 | 0.6 |
| XOM | 42.3 | 24.7 | 10.4 | 5.1 | 2.2 |
| JNJ | 31.1 | 0.1 | 0.0 | 0.0 | 0.0 |
| MCD | 22.8 | 9.8 | 2.2 | 15.3 | 3.5 |
| NEE | 18.6 | 1.3 | 0.2 | 13.6 | 2.5 |
| O | 33.8 | 2.4 | 0.8 | 0.0 | 0.0 |
| Total | | 100.0 | 39.8 | 100.0 | 32.5 |

| | | | Close | Weighted | Final |
|---|---|---|---|---|---|
| Sr. No. | Date | Stock | Price | Signal | Signal |
| 1 | Mar. 23, 2020 | CAT | 82.9 | −0.90 | Buy |
| 2 | Mar. 24, 2020 | CAT | 83.2 | 0.21 | Hold |
| 3 | Mar. 25, 2020 | CAT | 83.4 | 0.43 | Hold |
| 4 | Mar. 26, 2020 | CAT | 83.7 | 0.00 | Hold |
| 5 | Mar. 27, 2020 | CAT | 84.0 | −0.35 | Buy |
| 6 | Mar. 30, 2020 | CAT | 84.3 | −0.12 | Buy |
| 7 | Mar. 31, 2020 | CAT | 84.5 | 0.00 | Hold |
| 8 | Apr. 1, 2020 | CAT | 84.8 | −0.12 | Buy |
| 9 | Apr. 2, 2020 | CAT | 85.1 | 0.00 | Hold |
| 10 | Apr. 3, 2020 | CAT | 85.4 | −0.35 | Buy |
| . . . | . . . | . . . | . . . | . . . | . . . |
| 8320 | Aug. 2, 2022 | O | 65.6 | 0.45 | Hold |
| 8321 | Aug. 3, 2022 | O | 65.6 | 0.12 | Hold |
| 8322 | Aug. 4, 2022 | O | 65.7 | 0.24 | Hold |
| 8323 | Aug. 5, 2022 | O | 65.7 | 0.60 | Hold |
| 8324 | Aug. 8, 2022 | O | 65.8 | 0.84 | Hold |
| 8325 | Aug. 9, 2022 | O | 65.8 | 0.84 | Hold |
| 8326 | Aug. 10, 2022 | O | 65.9 | 0.71 | Hold |
| 8327 | Aug. 11, 2022 | O | 65.9 | 0.58 | Hold |
| 8328 | Aug. 12, 2022 | O | 66.0 | −0.11 | Buy |
| 8329 | Aug. 15, 2022 | O | 66.0 | 0.11 | Hold |

### Active Management (Trades Using Above Signals):

| | | | | | | Weighted |
|---|---|---|---|---|---|---|
| | Dollar | Dollar | | | | Time- |
| | Avg | Avg | Net | Time | | Adjusted |
| | Buy | Sell | Return | Period | Weight | Return |
| Stock | Price | Price | (%) | (Years) | (%) | (%) |
| CAT | 167.8 | 245.6 | 31.40% | 1.08 | 38.97 | 12.24 |
| CVX | 45.5 | 112.2 | 79.01% | 1.45 | 0 | 0 |
| CB | 115.0 | 155.9 | 32.71% | 0.87 | 23.72 | 7.76 |
| KO | 36.6 | 43.3 | 16.97% | 0.75 | 3.31 | 0.56 |
| XOM | 51.1 | 78.5 | 23.20% | 1.24 | 5.16 | 1.20 |
| JNJ | 112.2 | 144.1 | 23.16% | 0.90 | 0 | 0 |
| MCD | 155.6 | 194.5 | 15.13% | 0.93 | 15.27 | 2.31 |
| NEE | 41.5 | 47.9 | 75.07% | 0.25 | 13.57 | 10.19 |
| O | 33.0 | 45.1 | 34.91% | 0.87 | 0 | 0 |
| Total | | | | | 100.00 | 34.25 |

Analysis of Stocks with Average Fundamental Scores: Portfolio 2

| | Time-Adjusted | MC Weight | MC Net | MVO | MVO Net |
|---|---|---|---|---|---|
| Stock | Return (%) | (%) | Return (%) | Weights (%) | Return (%) |
| ADP | 27.4 | 14.5 | 4.0 | 5.9 | 1.6 |
| BDX | 13.2 | 0.6 | 0.1 | 0.0 | 0.0 |
| CAH | 31.2 | 7.14 | 2.2 | 20.0 | 6.3 |
| CHD | 25.7 | 5.9 | 1.5 | 5.0 | 1.3 |
| CTAS | 49.4 | 14.5 | 7.1 | 36.0 | 17.7 |
| CLX | 13.4 | 0.9 | 0.1 | 0.0 | 0.0 |
| CL | 17.1 | 4.8 | 0.8 | 2.6 | 0.4 |
| ECL | 43.8 | 0.4 | 0.2 | 0.0 | 0.0 |
| FAST | 41.0 | 2.07 | 0.8 | 20.2 | 8.3 |
| BEN | 83.7 | 6.2 | 5.2 | 0.0 | 0.0 |
| GD | 29.3 | 2.1 | 0.6 | 0.0 | 0.0 |
| GPC | 67.5 | 12.4 | 8.3 | 0.0 | 0.0 |
| HRL | 12.7 | 0.8 | 0.1 | 0.0 | 0.0 |
| SJM | 14.3 | 3.5 | 0.5 | 0.0 | 0.0 |
| KMB | 21.0 | 1.9 | 0.4 | 0.0 | 0.0 |
| MKC | 13.6 | 2.2 | 0.3 | 0.0 | 0.0 |
| NDSN | 29.5 | 0.4 | 0.1 | 0.0 | 0.0 |
| PPG | 119.5 | 7.6 | 9.1 | 0.0 | 0.0 |
| SHW | 39.9 | 2.4 | 0.9 | 10.5 | 4.2 |
| SWK | 25.5 | 10.0 | 2.6 | 0.0 | 0.0 |
| | | 100.0 | 44.9 | 100.0 | 39.7 |

| | | | | Weighted | Final |
|---|---|---|---|---|---|
| Sr. No. | Date | Stock | Close | Signal | Signal |
| 1 | Mar. 23, 2020 | ADP | 98.7 | −0.80 | Buy |
| 2 | Mar. 24, 2020 | ADP | 98.9 | −0.21 | Buy |
| 3 | Mar. 25, 2020 | ADP | 99.1 | −0.22 | Buy |
| 4 | Mar. 26, 2020 | ADP | 99.2 | 0.00 | Hold |
| 5 | Mar. 27, 2020 | ADP | 99.4 | 0.23 | Hold |
| 6 | Mar. 30, 2020 | ADP | 99.6 | 0.12 | Hold |
| 7 | Mar. 31, 2020 | ADP | 99.7 | 0.00 | Hold |
| 8 | Apr. 1, 2020 | ADP | 99.9 | −0.12 | Buy |
| 9 | Apr. 2, 2020 | ADP | 100.1 | 0.12 | Hold |
| 10 | Apr. 3, 2020 | ADP | 100.2 | 0.12 | Hold |
| . . . | . . . | . . . | . . . | . . . | . . . |
| 13473 | Sep. 17, 2024 | SWK | 108.3 | 0.87 | Hold |
| 13474 | Sep. 18, 2024 | SWK | 108.4 | 0.52 | Hold |
| 13475 | Sep. 19, 2024 | SWK | 108.5 | 0.30 | Hold |
| 13476 | Sep. 20, 2024 | SWK | 108.6 | 0.48 | Hold |
| 13477 | Sep. 23, 2024 | SWK | 108.7 | 0.55 | Hold |
| 13478 | Sep. 24, 2024 | SWK | 108.8 | −0.18 | Buy |
| 13479 | Sep. 25, 2024 | SWK | 108.9 | 0.17 | Hold |
| 13480 | Sep. 26, 2024 | SWK | 109.0 | 0.49 | Hold |
| 13481 | Sep. 27, 2024 | SWK | 109.0 | 0.32 | Hold |
| 13482 | Sep. 30, 2024 | SWK | 109.1 | 0.24 | Hold |

### Active Management (Trades Using Above Signals):

| | | | | | | Weighted |
|---|---|---|---|---|---|---|
| | | | | Time | | Time- |
| | Dollar Avg | Dollar Avg | Net Return | Period | | Adjusted |
| Stock | Buy Price | Sell Price | (%) | (Years) | Weight (%) | Return |
| ADP | 156.1 | 198.0 | 11.62% | 0.9 | 5.87% | 0.68% |
| BDX | 183.3 | 228.9 | 2.68% | 1.6 | 0% | 0% |
| CAH | 49.6 | 66.3 | 28.89% | 0.9 | 20.09% | 5.81% |
| CHD | 69.5 | 84.3 | 22.41% | 0.7 | 4.96% | 1.11% |
| CTAS | 71.5 | 114.6 | 41.64% | 1.1 | 35.97% | 14.98% |
| CLX | 111.8 | 142.1 | 51.38% | 0.6 | 0% | 0% |
| CL | 64.4 | 78.1 | 4.88% | 1.1 | 2.55% | 0.12% |
| ECL | 128.9 | 190.8 | 47.52% | 0.9 | 0% | 0% |
| FAST | 45.6 | 59.8 | 38.53% | 0.7 | 20.15% | 7.76% |
| BEN | 12.6 | 18.6 | 122.35% | 0.5 | 0% | 0% |
| GD | 132.9 | 168.9 | 19.82% | 0.8 | 0% | 0% |
| GPC | 45.1 | 77.1 | 122.54% | 0.6 | 0% | 0% |
| KMB | 101.5 | 114.2 | 20.22% | 0.5 | 0% | 0% |
| NDSN | 132.7 | 183.5 | 18.44% | 1.2 | 0% | 0% |
| PPG | 68.2 | 94.2 | 189.50% | 0.3 | 0% | 0% |
| SHW | 223.0 | 293.4 | 38.58% | 0.7 | 10.41% | 4.02% |
| SWK | 71.0 | 84.0 | 25.03% | 0.6 | 0% | 0% |
| Total | | | | | 100.00% | 34.48% |

Outcome while using the Artificial Intelligence (AI)/Machine Learning (ML) approach: The AI model finds the optimal asset allocation in a fraction of the time it would take humans. The final portfolio consists of a select group of stocks, with a precise allocation that maximizes expected returns and minimizes risk. The system continually updates its decisions based on real-time market data.

Advantages of using the Artificial Intelligence (AI)/Machine Learning (ML) are as follows:
a) Scalability: AI can evaluate trillions of portfolio combinations far faster than humans.
b) Adaptability: The model learns and improves over time, adjusting to changing market conditions.
c) Complexity Handling: It can process massive amounts of data (e.g., historical price movements, volatility, correlations) that would be impossible to analyze manually.

Given below is an example of how a portfolio is created and optimized without using the Artificial Intelligence (AI)/Machine Learning (ML) approach.
1. Modern Portfolio Theory (MPT): In the first step, for example, the manager uses Markowitz's Efficient Frontier approach to allocate assets. MPT assumes that investors are rational and that asset returns follow a normal distribution.
2. Manual Screening: The portfolio manager 311a manually screens the 500 stocks based on a few key factors like historical returns, volatility, and sector diversification. They then calculate the expected return and risk (variance) for different combinations of these stocks. FIG. 19 illustrates a graph showing annualized returns and volatility.
3. Optimization Process:
   The manager creates a few portfolio combinations manually (for example, choosing 20 stocks at random or based on sector performance).
   For each combination, they calculate the portfolio's expected return and risk, and compare the results to identify portfolios that lie on the efficient frontier (those with the highest return for the lowest risk).
   To achieve diversification, the manager imposes constraints like minimum exposure to certain sectors or caps on specific stock allocations.
4. Outcome:
   After manually evaluating several portfolios, the manager selects one that seems optimal based on their analysis. However, due to human limitations, they can only test a limited number of combinations, typically in the thousands rather than trillions.
   The process is slow and may not yield the truly optimal portfolio, as only a small subset of possible combinations is considered.

Therefore, the limitation of traditional methods comprise:
Limited Search Space: The manager can only explore a limited number of stock combinations, leaving many potential opportunities untouched.
Assumption of Normality: MPT relies on assumptions (e.g., returns follow a normal distribution), which may not hold true in real market conditions.
Manual Errors and Bias: Human judgment is subject to biases and errors, making it challenging to achieve true optimization.

Accordingly, it is not possible for a human being to identify combinations of financial instruments that have specific characteristics. Additionally, it is not possible to combine financial instruments that have specific characteristics such as value and growth, cyclical and non-cyclical, volatile and stable, large and mid-cap, large and small cap, mid-cap and small-cap, and many others that maximize portfolio returns. To find the optimal combination with optimal subsets, we require a computer system and software.

Given below is yet another exemplary description of the advantage of using the Artificial Intelligence (AI)/Machine Learning (ML) approach.
1. Input Data: The portfolio manager 311a feeds the system with a large dataset of financial instruments, including stocks, bonds, and ETFs, along with their fundamental data, historical price trends, volatility, market cap size, and other characteristics.
2. AI/ML Algorithms: The AI/ML system uses algorithms such as Genetic Algorithms (GA), Reinforcement Learning (RL), or Deep Learning to explore the optimal combinations of assets with these diverse characteristics.
   Genetic Algorithm: The system evolves combinations of financial instruments by mimicking natural selection. It tests, mutates, and combines different subsets of assets to find the best portfolio configuration.
   Deep Reinforcement Learning: The AI agent 311a evaluates millions of portfolio allocations, learning over time which combinations yield the best returns for the desired characteristics (value, growth, cyclical, stable, etc.).
3. Multi-Objective Optimization: AI/ML can handle multi-objective optimization, meaning it can maximize returns while minimizing risk and ensuring that the financial instruments selected adhere to specific characteristics like volatility or market cap. The system can analyze combinations such as value-growth hybrid portfolios or cyclical-noncyclical blends.
4. Output: The system produces a portfolio with:
   A balance between value and growth stocks.
   A mix of cyclical and non-cyclical assets to hedge against economic downturns.
   Volatile and stable assets to maximize returns while controlling for risk.
   Large-cap and small-cap stocks for diversification and growth potential.
5. Real-Time Updates: The AI/ML system continuously monitors the portfolio and adjusts allocations dynamically based on changing market conditions, ensuring that the optimal balance is maintained.

Given below are the advantage of using AI/ML approach as described in the above paragraph:
High Complexity: AI can easily handle multi-dimensional problems, optimizing portfolios that balance characteristics such as value vs. growth, volatile vs. stable, and cyclical vs. non-cyclical.
Speed: AI/ML algorithms can analyze and test trillions of combinations in hours, a task that would take years for a human.
Multi-Objective Optimization: AI can optimize for several objectives (returns, risk, volatility, market cap) simultaneously, which is very difficult for traditional approaches.

Given below is an example of how a portfolio is not properly optimized without the AI/ML Approach i.e., while using a traditional approach:
1. Manual Screening: The portfolio manager 311a manually selects stocks and other financial instruments by screening for key characteristics:
   Value Stocks: Based on low P/E ratios, strong earnings, and dividends.
   Growth Stocks: Selected based on high earnings growth potential and momentum indicators.
   Cyclical Assets: Chosen based on their dependence on the economic cycle (e.g., industrial or consumer discretionary stocks).
   Non-Cyclical Assets: Selected from sectors like healthcare or utilities, which perform well in downturns.
2. Portfolio Construction: The manager uses a traditional Modern Portfolio Theory (MPT) approach. After selecting individual instruments based on their characteristics, the manager manually tests a limited number of portfolio combinations to find the best trade-off between risk and return. This involves calculating expected returns and volatility using historical data.
3. Optimization: The manager tries to balance the portfolio manually, aiming to combine instruments like large-cap growth stocks, small-cap value stocks, and non-cyclical bonds to manage risk. However, the process is limited to testing a few hundred or thousand combinations.

Given below is an example of limitations of the above described traditional approach:
Manual Limitations: Humans can only manually screen and test a limited number of combinations, far less than what AI can handle.
Suboptimal Allocation: Without exploring enough combinations, the final portfolio may not be fully optimized for returns or risk.
Lack of Multi-Objective Optimization: Balancing multiple characteristics (e.g., value, growth, cyclical, non-cyclical, etc.) becomes difficult manually, and the process is prone to human error and bias.

Therefore, with AI/ML, the AI/ML algorithms can evaluate trillions of combinations of financial instruments that vary by characteristics like market cap, growth, volatility, and cyclicality. These algorithms can find optimal subgroups and asset combinations that maximize returns while minimizing risk. This is computationally achievable in a short time frame, leveraging models such as Reinforcement Learning, Genetic Algorithms, or Deep Learning.

Without using AI/ML, the traditional methods rely on limited manual screening and optimization techniques. While a human can analyze a subset of stocks and create a moderately balanced portfolio, the sheer number of possible combinations (in the trillions) makes it impossible to achieve a truly optimized portfolio manually. Traditional methods are also limited by the number of variables a human can juggle and tend to underperform AI-driven approaches.

Given below are several exemplary examples/scenarios illustrating selection of stocks to create a portfolio of assets:

### Example 1: Selecting Stocks from the S&P 500

If a subset of stocks are selected from the S&P 500, the number of possible combinations can be calculated using the combinations formula:

$$C ( n , k ) = \frac{n !}{k ! ( n - k ) !}$$

Where;
   n is the total number of stocks (500 in S&P 500)
   k is the number of stocks selected.
      Scenario 1: Selecting 10 Stocks from 500

$$C ( 500 , 10 ) = \frac{500 !}{10 ! ( 500 - 10 ) !} = \frac{500 !}{10 ! \text{.490} !}$$

This evaluates to:
C(500,10)≈1.606×10¹⁸
Total combinations: ≈1.606 quintillion combinations
   Scenario 2: Selecting 50 Stocks from 500

$$C ( 500 , 50 ) = \frac{500 !}{50 ! ( 500 - 50 ) !} = \frac{500 !}{50 ! . 45 {0}^{1}}$$

This evaluates to:
C(500,50)≈1.254×10⁹⁸
Total combinations: ≈1.254×10⁹⁸ (an extremely large number of combinations)

### Example 2: Selecting from the Full US Market (15,000+ Financial Instruments)

Now, let's assume we have more than 15,000 financial instruments available in the US market, including stocks, mutual funds, ETFs, commodities, etc.
   Scenario 1: Selecting 100 Instruments from 15,000

$$C ( 15000 , 100 ) = \frac{15000 !}{100 ! ( 150 \; 00 - 1 \; 00 ) !} = \frac{15000 !}{100 ! \text{.14900} !}$$

This evaluates to:
C(15000,100)≈3.586×10²⁷⁶
Total combinations: ≈3.586×10²⁷⁶ (an extremely large number of combinations)
   Scenario 2: Selecting 1,000 Instruments from 15,000

$$C ( 15000 , 1000 ) = \frac{15000 !}{1000 ! ( 150 \; 00 - 10 \; 00 ) !} = \frac{15000 !}{100 ! \text{.14000} !}$$

This evaluates to:
C(15000, 1000)≈1.284×10²⁵⁵⁷
Total combinations: ≈1.284×10²⁵⁵⁷ (an extremely large number of combinations)

### Example 3: Including Other Asset Classes (Stocks, ETFs, Mutual Funds)

Let's assume a simplified universe with 4,000 stocks, 2,000 ETFs, 1,000 mutual funds, and 500 commodities. You want to create a portfolio consisting of 50 instruments selected from this set of 7,500 financial instruments.

$$C ( 75 \; 00 , 50 ) = \frac{7500 !}{50 ! ( 750 \; 0 - 50 ) !} = \frac{7500 !}{50 ! \text{.7450} !}$$

This evaluates to:
C(15000,1000)≈1.889×10¹²²
Total combinations: ≈1.889×10¹²² (an extremely large number of combinations)

As can be seen from the above examples/scenarios, the number of combinations grows exponentially with even small changes in the number of instruments or the size of the subset, making this an intractable problem for human computation, but ideal for AI/ML optimization techniques.

Optimal combination weights: A computer and/or software are required to provide the ideal weights to the subsets of combinations that can optimize portfolio returns.

Time Horizon: Various time horizons yield varying returns; it is not humanly feasible to determine which time horizon combined with the best conditions will yield the highest portfolio returns.

The model disclosed herein to calculate the expected return of the portfolio comprises multiple financial instruments. To enhance and optimize the expected return, these instruments, for example, the financial instruments are categorized into different groups such as optimized, unoptimized, and optimized hedge-able assets. The unoptimized assets are primarily those instruments that are bought and held until the end of a defined time horizon. On the other hand, optimized assets are those financial instruments that are actively managed during the defined time horizon. The optimized hedge-able assets are derivatives, future and options to hedge the risk of the optimized assets. To process the data and identify the best correlation between the multiple financial instruments available and categorize them into different groups is humanly not possible. To perform such a complex task a computer system and software are required.

The task of categorizing financial instruments into these groups based on their correlation, risk profiles, and performance characteristics is extremely complex. This complexity arises from the need to process large amounts of financial data and identify the best correlations and relationships between instruments. Human effort alone cannot achieve this level of precision or speed due to the vast number of combinations and correlations to consider. To solve this, we turn to AI/ML systems, which are ideal for such tasks.

Below are examples of how AI/ML can be applied to handle this complexity and an alternative approach where traditional methods are used without AI/ML. The aim is to process a large dataset of stocks, bonds, ETFs, and derivatives to maximize portfolio returns while managing risk. This requires correlating different instruments to determine their groupings and their optimal role in the portfolio.

### With Ai/ML Approach:

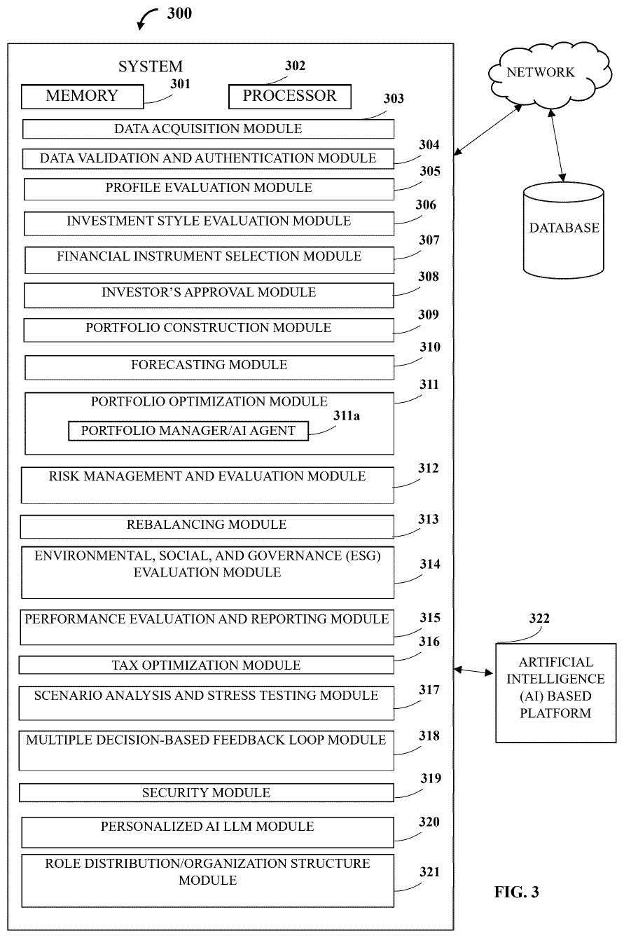

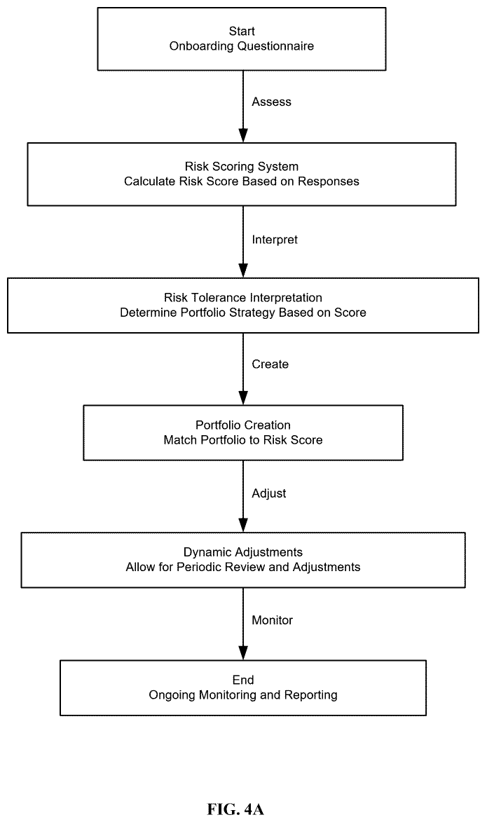

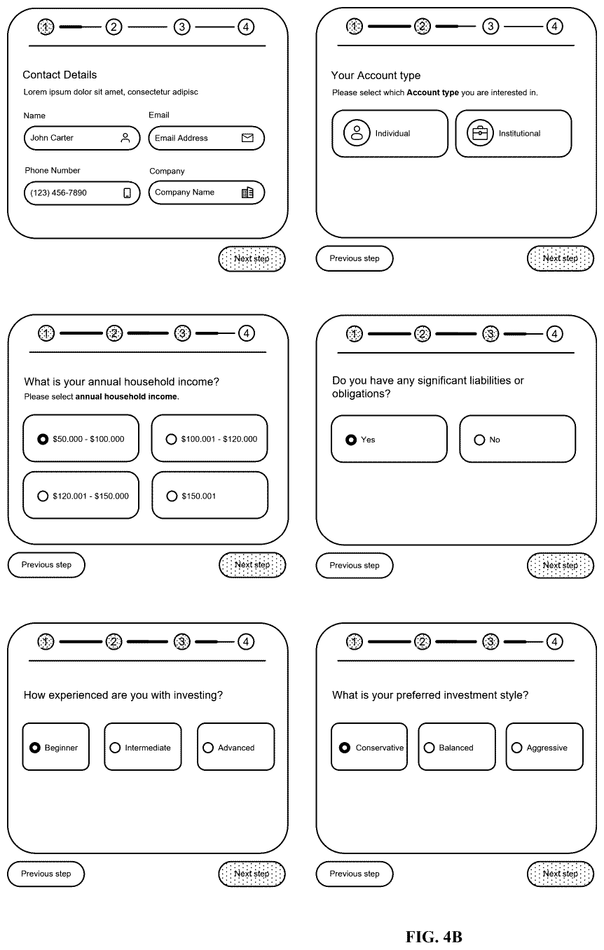

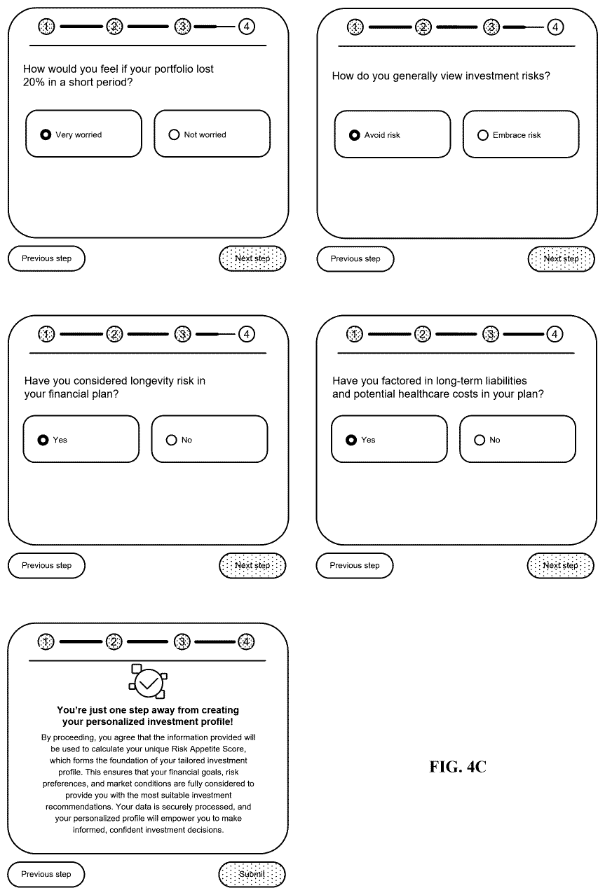

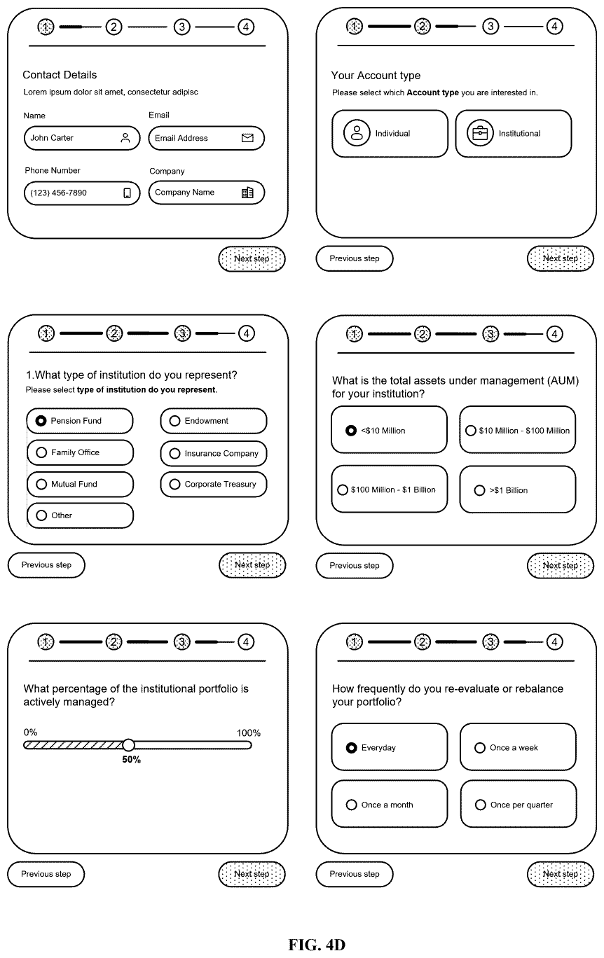

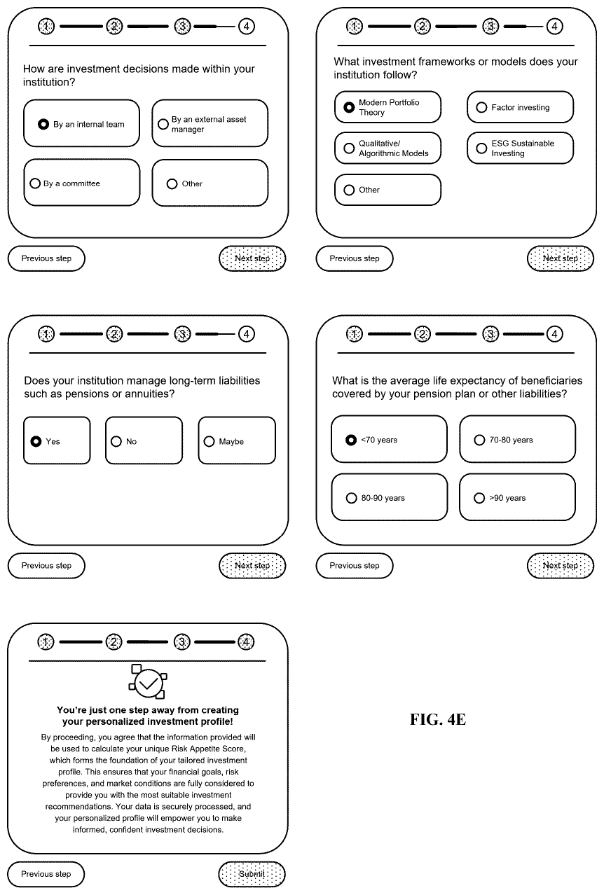

1. Data Collection: The portfolio manager 311a collects historical data on:
   Unoptimized Assets: Passive investment instruments (e.g., index funds, ETFs).
   Optimized Assets: Actively managed stocks, bonds, or mutual funds.
   Optimized Hedge-able Assets: Derivatives, futures, and options used for hedging.
2. AI/ML Algorithm: The portfolio manager 311a uses an instrument selection module, for example, a financial instrument selection module 307, shown in FIG. 3, which employs unsupervised machine learning techniques like clustering or principal component analysis (PCA) to categorize financial instruments based on correlations, volatility, performance metrics, and risk profiles.
   Clustering: A K-means or Hierarchical Clustering algorithm groups the instruments based on their features (e.g., price movement, correlation with other assets, volatility).
   Principal Component Analysis (PCA): This method reduces the dimensionality of the dataset, identifying the key factors that explain the most variance among the instruments. These factors are used to categorize the assets.
3. Categorization Process:
   The system categorizes Unoptimized Assets by identifying instruments with low volatility, passive management strategies, and low correlation with actively managed assets.
   Optimized Assets are dynamically identified based on factors like high Sharpe ratios, active management, and correlation with the rest of the portfolio.
   Optimized Hedge-able Assets (futures, options) are identified by analyzing which derivatives are most effective in hedging the risks of the optimized assets (e.g., options that hedge against volatility in active stock positions).
4. Optimization: AI/ML models like Reinforcement Learning (RL) or Genetic Algorithms are employed to optimize the allocation of these categorized assets, ensuring that:
   Optimized Assets are actively managed during the time horizon.
   Optimized Hedge-able Assets provide protection during market volatility or downturns.
   Unoptimized Assets provide stability with buy-and-hold strategies.
5. Outcome:
   The AI/ML system creates a portfolio where assets are perfectly categorized:
      Unoptimized assets are stable, low-risk, and provide steady returns over time.
      Optimized assets are actively managed for higher returns.
      Optimized Hedge-able Assets effectively reduce the risk exposure of the optimized assets.
   The system, via the portfolio optimization module, dynamically adjusts these allocations as market conditions change, based on real-time data.

### Advantage of AI/ML:

High-dimensional data processing: AI/ML can efficiently analyze large datasets with multiple features, making it possible to identify correlations and categorize assets in a way that would be impossible manually.
Dynamic optimization: The system can continuously optimize asset groupings and portfolio allocations, adjusting for market conditions.
Speed: AI/ML can test and process millions of combinations and strategies, finding the best solutions in minutes or hours, compared to what would take years for human analysts.

### Without AI/ML Approach:

1. Manual Data Analysis: The manager manually collects historical data for stocks, bonds, ETFs, and derivatives. Using Excel or similar tools, they calculate key metrics such as:
   Volatility (standard deviation of returns).
   Correlation with other assets.
   Sharpe ratio to measure risk-adjusted returns.
2. Human Categorization:
   Unoptimized Assets: The manager screens for assets with low volatility and consistent returns (e.g., index funds) and assigns them to the unoptimized category.
   Optimized Assets: The manager manually identifies actively managed stocks or funds that have historically outperformed benchmarks, and they assign these to the optimized group.
   Optimized Hedge-able Assets: The manager reviews the derivatives market and selects options and futures contracts that can hedge against volatility in the optimized assets.
3. Correlation Analysis: The portfolio manager 311a calculates pairwise correlations between the instruments manually, identifying which financial instruments can be grouped together or hedged against each other.
4. Manual Optimization: After manually categorizing the assets, the manager tries different allocation strategies based on intuition and historical performance. They manually test these allocations to balance risk and return.
5. Outcome:
   The portfolio manager 311a successfully categorizes some assets into the three groups but can only test a small number of combinations due to the complexity.
   The allocation is likely suboptimal since the manual correlation analysis and categorization process are slow and imprecise.
   Without AI, dynamic adjustments are difficult to implement, and the portfolio manager 311a may miss key hedging opportunities.

### Limitations of Traditional Approach:

Limited Capacity: A human can only analyze a limited number of financial instruments and correlations, leaving many potential combinations unexplored.
Time-Consuming: Manually calculating correlations and categorizing assets is slow and labor-intensive.
Static: Once categorized, it's difficult for a human to dynamically adjust allocations as market conditions change.

Accordingly, with AI/ML, the system can process vast amounts of data and dynamically categorize financial instruments based on their correlation, risk profile, and performance characteristics. It can handle the complexity of categorizing unoptimized, optimized, and hedge-able assets and continuously optimize the portfolio using advanced algorithms. This ensures that the portfolio is always balanced and dynamically adjusted to maximize returns and manage risk.

Without using AI/ML and instead using the traditional approach: While still possible, the traditional approach is extremely limited. A human can only process a small number of correlations and asset combinations, which makes the process inefficient and suboptimal. The categorization of assets is static and requires frequent manual intervention, making it hard to adjust the portfolio in real time as market conditions change.

Formula Example with AI/ML (Categorization and Correlation):
Using AI/ML, we can define an optimization function that categorizes assets based on correlation and volatility:

$$Category = \{ \begin{matrix}Optimized if Sharpe {Ratio}_{i} > Threshold , {ρ}_{i} > Correlation Threshold \\ Unoptimized if {σ}_{i} < Threshold , {ρ}_{i} < Correlation Threshold \\ Hedge - able if {Derivatives}_{i} hedges risk of Optimized asset\end{matrix}$$

Where;
   σᵢ is the volatility of the asset;
   ρᵢ is the correlation of asset i with the rest of the portfolio; and
   The thresholds are dynamically determined by the AI/ML system based on the historical and other various data.

Quantifying the risk tolerance level of the investors and aligning it to construct an optimal portfolio that can generate an optimized expected return with the defined risk tolerance level requires a computer system and software.

There are certain limitations of the Nobel Laureate models i.e., Tobin's and Markovitz's model of modern portfolio theory has limitations in that it ignores behavioral factors, does not account for the market inefficiency, and assumes a normal distribution of returns and may not hold during market anomalies or extreme events. William Sharpe's CAPM model assumes a single period investment horizon, and normally distributed returns. Whereas the Fama-French three-factor model does not account for momentum, liquidity, or other potential risk factors that might influence portfolio returns, and the Fama-French three-factor model also assumes linear relationships and may not fully capture non-linear effects. These limitations will be addressed through the model, computer system, and software disclosed herein. It should be noted that the terms risk tolerance and risk factor are used interchangeably throughout this application.

A unique multilayer buy-sale signaling process requires computer systems and software. The AI large language model (LLM) cloud architecture disclosed herein revolves around a decentralized, personalized AI LLM model pertaining to individual or institutional investors that are continuously trained and hosted in private cloud environments.

These customized AI systems protect users' privacy and security while adhering to their unique requirements, preferences, and data. Users are able to access their own private AI LLM pertaining to their own selection of financial instruments across devices with scalability and processing flexibility through integration with cloud architecture. With advancements in AI and foundation LLM, these systems have the potential to provide consumers with extremely intuitive and context-aware services that aid in decision-making, automation, and tailored experiences in a variety of disciplines.

Thus, a novel architecture, a computer system, and/or software is required to accomplish the work in order to solve the aforementioned limitations.

Users are increasingly interested in leveraging customized AI systems to help them manage and analyze their own portfolios of financial instruments. These systems are designed to protect user privacy and security while providing a high degree of personalization, allowing each user to have their own private AI large language model (LLM). This private AI system would provide scalable and flexible processing by integrating with cloud architecture, enabling users to analyze their selected financial instruments across multiple devices seamlessly.

### With AI/ML Approach:

1. Customized AI Model:
   The user has a set of selected financial instruments (e.g., stocks, bonds, ETFs, etc.) that they want to track. The system builds a private AI large language model (LLM) that processes this specific portfolio.
   The AI system is fine-tuned to focus on the user's individual portfolio preferences, using user-specific financial data (like performance metrics, risk tolerance, and investment goals) to tailor recommendations.
2. Privacy and Security:
   The AI is hosted in a secure, private cloud environment, ensuring the user's data is encrypted and accessible only to them. Federated learning can be employed, meaning the AI model improves its performance using aggregated data across users without compromising any individual's data privacy.
   The system adheres to strict data privacy laws (like GDPR or CCPA) and provides the user with full control over their data, including the ability to delete or export their information at any time.
3. Processing Flexibility and Scalability:
   The AI model is cloud-integrated, allowing the user to access it from any device (laptop, smartphone, or tablet) in real time.
   The system offers processing flexibility by scaling its computational resources dynamically through cloud architecture (e.g., AWS, Google Cloud, Microsoft Azure, etc.). This ensures that heavy computational tasks like portfolio optimization, data processing, and risk analysis are handled smoothly and efficiently, regardless of the user's device.
4. AI-Powered Insights:
   The AI system continuously monitors the performance of the user's financial instruments and generates personalized recommendations, such as:
      Buy/sell signals based on real-time market data.
      Risk-adjusted portfolio optimization based on user preferences.
      Sentiment analysis on financial news or reports affecting the user's holdings.
5. Real-Time Notifications:
   The system sends real-time alerts across all devices when important events occur, such as a significant change in stock price, earnings reports, or when a portfolio reaches a specific performance threshold.

### Outcome:

The AI system provides the user with real-time financial insights and personalized recommendations without compromising their privacy or security. The system is scalable and can process large amounts of financial data in real time, adjusting the portfolio automatically according to the user's preferences.
The user experiences seamless access to their private AI across devices, benefiting from cloud-based scalability and the ability to manage their portfolio from anywhere with secure, encrypted access.

### Advantages of AI/ML:

Personalization: AI fine-tunes its models based on the user's preferences, portfolio structure, and financial goals, offering tailored recommendations.
Scalability: Cloud integration ensures that the system can process and analyze large amounts of financial data in real time without performance limitations.
Privacy and Security: Through federated learning, encryption, and strict data protection measures, the user's sensitive financial data remains secure.

### Without AI/ML Approach:

1. Manual Data Tracking:
   The user inputs their selected financial instruments (stocks, bonds, ETFs, etc.) manually into a financial tracking tool (such as Excel or a portfolio tracking app).
   The system allows the user to view historical performance and basic metrics (e.g., stock price, dividend yield, total return), but there is no dynamic analysis or prediction.
2. Limited Privacy Controls:
   The system may store the user's data locally or on a third-party server, but there is no AI-driven encryption or federated learning, which means the user's privacy is more vulnerable to external threats (e.g., hacking or data breaches).
   There are fewer or less robust data privacy options, and the system may not be fully compliant with privacy laws like GDPR or CCPA.
3. Lack of Scalability and Flexibility:
   The system lacks cloud-based scalability, which means that complex financial calculations (e.g., portfolio optimization, risk management) might slow down the user's device or fail to process large datasets efficiently.
   The user may only be able to access their portfolio from a single device or may need to manually sync data across devices. In contrast to a cloud-based system, processing tasks are handled locally, limiting performance and flexibility.
4. No Real-Time Recommendations:
   The system does not generate real-time recommendations, buy/sell signals, or risk management alerts. The user must manually review their portfolio and make decisions based on static data.
   There is no sentiment analysis or market news integration, meaning the user must independently track relevant news and earnings reports that might affect their holdings.
5. Notifications:
   Notifications are limited to simple alerts (e.g., changes in stock price), but they do not include advanced, AI-powered insights. For example, the user would not receive notifications about portfolio rebalancing or new buying opportunities unless they check the system manually.

### Outcome:

The traditional system provides basic tracking functionality but lacks the personalization, privacy protections, and scalability offered by AI/ML-based solutions. The user must manually analyze their portfolio and market news, which is time-consuming and less efficient.
The system is less flexible in terms of accessing data across devices, and computationally heavy tasks like portfolio optimization are either not possible or are very slow.

### Limitation of the Traditional Approach:

No Personalization: The system provides generic data without offering personalized insights or tailored recommendations based on the user's portfolio or financial goals.
Limited Privacy and Security: Data privacy measures are weaker, and the system may not be fully compliant with modern privacy laws.
Lack of Scalability: Without cloud-based integration, large-scale data analysis is slow, and the system cannot efficiently handle multiple financial instruments or complex computations.

In the context of personalized financial analysis, a customized AI system integrated with cloud architecture offers distinct advantages over traditional systems without AI/ML. The AI-based system can provide:
Highly personalized insights tailored to the user's financial instruments and preferences.
Real-time recommendations and notifications across multiple devices.
Scalable processing power, ensuring smooth performance even with complex data.
Enhanced privacy and security, with encrypted data and compliance with privacy regulations.

On the other hand, traditional systems that lack AI/ML are less flexible, slower in processing, and provide only limited tracking capabilities. As financial markets become more complex and dynamic, the advantages of AI/ML in offering customized, secure, and scalable solutions become increasingly critical.

Building a robust, agile, innovative framework including cell-based architecture, LLM Model etc. and for mobile React Native, flutter, etc., and many such related and hybrid frameworks are required for the complex application of the automated investment portfolio model. This involves creating algorithms that can process vast amounts of financial instrument data, optimize the invention parameters, and generate actionable insights, etc. The framework also incorporates advanced statistical techniques, Generative AI, machine learning algorithms, and big data analytics to ensure precision and reliability. The integration of traditional and alternative financial data sources will enhance the automated investment portfolio model's predictive capabilities and performance.

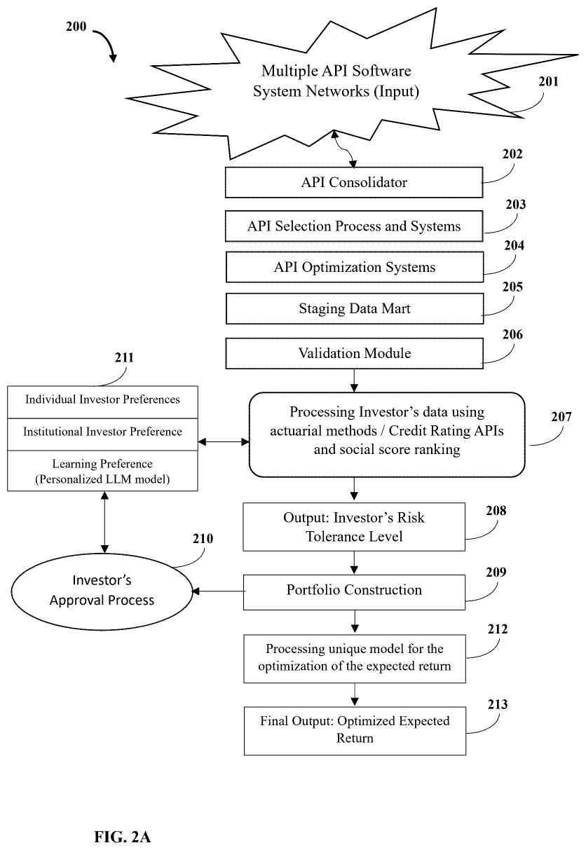

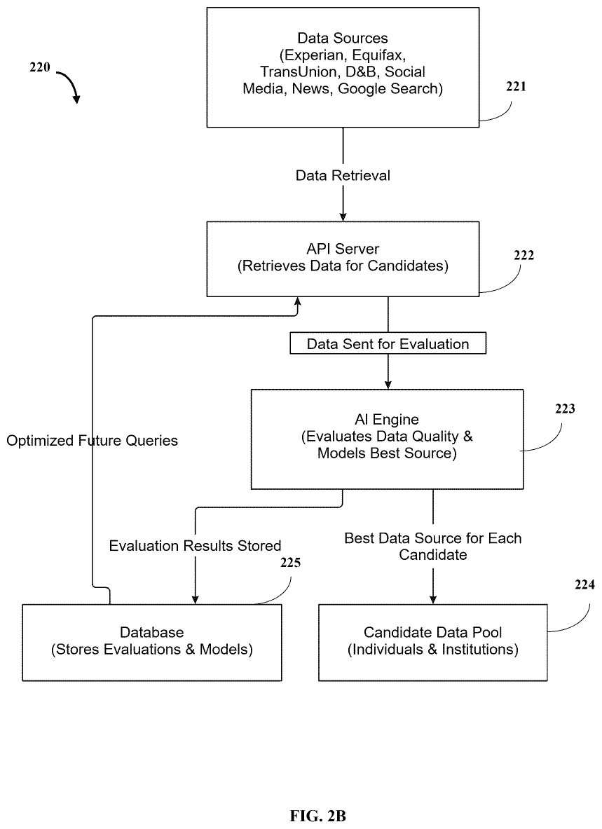

FIG. 2A illustrates a framework 200 for optimizing the portfolio returns. In the first step, 201 input is obtained from multiple Application Programming Interface (API) software systems. The API software systems bring data from various financial API platforms like Bloomberg, Koyfin, Ziggma, World Bank, Yahoo Finance, Seeking Alpha, Wall Street Zen, Alpha Vantage, SEC Fillings, and many others which extracts data for various financial instruments including but not limited to stocks, bonds, commodities, futures & options, etc. These various financial API platforms are data sources 221 as shown in FIG. 2B. Next, the API platforms are consolidated 202. Depending upon the financial instruments in use, the authenticity of the data extracted from the respective APIs are verified and scrutinized. The best of the authentic data is used for analysis.

The functions of the “API consolidator” 202, “API Selection Process and Systems” 203 and “API Optimization Systems” 204 are as follows:

API Consolidator 202: The API consolidator acts as the central hub for integrating and managing APIs from multiple sources including but not limited to various APIs like Yahoo Finance, Bloomberg, Alpha Vantage, SEC, MorningStar, etc. It gathers data, functionalities, or services provided by different APIs into a unified platform.

### General Functions of API Consolidator:

### Aggregation:

Collects data or services from multiple APIs.
Example: Combining data from multiple financial market APIs, news APIs, and analytics APIs into a single system.

### Standardization:

Normalizes data formats and protocols across APIs.
Ensure uniform structure (e.g. JSON, XML) for easier downstream processing.

### Authentication Management:

Handles API keys, OAuth tokens, or other authentication mechanisms.
Centralizes credential storage and updates to simplify integration.

### Error Handling:

Detects and resolves API failures or inconsistencies.
Implements retry mechanisms for unreliable connections.

### Caching and Rate Limiting:

Stores frequently accessed API responses temporarily.
Adheres to API provider rate limits to avoid disruptions.

In a financial portfolio management system, the API consolidator might fetch:
Stock Prices, Volume data from Yahoo Finance API.
Fundamental Data from SEC API.
News data from Bloomberg API.
Market sentiment data from alternative data providers.

API Selection Process and Systems 203: The API selection process determines which APIs to use for specific task based on predefined criteria such as accuracy, reliability, cost, and relevance.

### General Functions of API Selection Process and Systems 203:

### Dynamic Selection:

Selects the best API for a task in real time based on parameters like response time, data accuracy, or cost.
Example: Switching between APIs for stock prices based on availability and latency.

### API Scoring:

Evaluates APIs based on key performance indicators (KPIs) like:
   Latency,
   Data Freshness
   Historical accuracy
   Cost (e.g., per-call fees or subscription)

### Contextual Matching:

Matches APIs to the context of the task.
Example: For a high-frequency trading system, prioritize APIs with the lowest latency over those with comprehensive historical data.

### Redundancy and Backup:

Maintains a list of backup APIs in case of failure.
Automatically switches to an alternative API when the primary API is unavailable.

### Monitoring and Feedback:

Continuously monitors API performance and updates scores.
Incorporates user feedback for future selections.

API Optimization Systems 204: The API Optimization Systems enhance the efficiency, reliability, and scalability of API usage in the software. It ensures optimal performance under varying loads and conditions.

### General Functions of the API Optimization Systems 204:

### Load Balancing:

Distributes API calls across multiple endpoints to avoid overloading a single API.
Implements strategies to prevent rate limit breaches.

### Call Minimization:

Reduces the number of API calls by:
   Implementing data caching.
   Merging multiple calls into one (batching).
   Using conditional requests (e.g., “only fetch if data has changed”).

### Cost Optimization:

Minimizes API call costs by:
   Prioritizing free or low-cost APIs.
   Avoiding redundant or unnecessary calls.

### Latency Reduction:

Optimizes API usage for minimal response times.
Example: Preferring APIs hosted geographically closer to the end-user.

### Data Deduplication:

Filters out duplicate data fetched from multiple APIs.
Ensures consistency across data points.

### Fail-Safe Mechanisms:

Implements fallback APIs or local data caches in case of API failures.
Automatically retries failed calls with exponential backoff strategies.

### Scalability:

Adapts to increasing API call volumes during peak usage.
Dynamically provisions resources to handle large-scale API requests.

### Example Use Case:

Optimize API calls to fetch real-time prices only for actively traded stocks while using batch calls for less time-sensitive data.

The API Consolidator 202, API Selection Process 203, and API Optimization Systems 204, work together as follows:
API Consolidator collects and integrates multiple APIs into a unified system.
API Selection Process determines the most suitable API for specific tasks dynamically.
API Optimization Systems ensure that the selected APIs are used efficiently and cost-effectively.

FIG. 2B illustrates a staging data mart and validation process. The Staging Data Mart 205 and Validation Module 206 create a data storage and validation pipeline to ensure the quality, consistency, and reliability of data before it is used for downstream tasks, such as AI modelling and analysis, as described below:

### Staging Data Mart and Validation

a) Data Retrieval and Collection:
   Data is fetched 221, as shown in FIG. 2B, from multiple reliable external sources such as Yahoo Finance, SEC (Securities and Exchange Commission), Bloomberg, and other market data providers.
   This data typically includes stock prices, financial reports, corporate announcements, historical trading data, other financial asset information, and macroeconomic metrics.
   In an embodiment, an API server retrieves 222 the data for candidates i.e., the investors.
b) Data Mart Construction:
   A permanent data mart is created to serve as the central repository for all validated data.
   The staging data mart acts as an intermediary layer to ensure that all incoming data is properly validated, structured, and ready for downstream usage.
c) Data Validation Process:
   The AI Engine performs rigorous validation or evaluation 223 of the data to ensure its quality and consistency before integrating it into the final Stock or Financial Asset Data Pool.
   Key validation checks include:
      Completeness: Ensuring all necessary data points, such as stock prices, timestamps, and financial ratios, are available.
      Accuracy: Cross-checking data against multiple sources to identify and resolve discrepancies.
      Consistency: Verifying uniformity across various datasets (e.g., corporate filings vs. market data sources).
      Timeliness: Ensuring the data reflects up-to-date market conditions and events.
      Source Credibility: Ranking and prioritizing the reliability of each data provider.
d) Validated Data Storage:
   Post-validation, the data is stored in Data Mart for long-term access and analysis.
   This stored data is then used for:
      Portfolio Construction: Building and maintaining individual and institutional portfolios.
      Backtesting: Evaluating historical performance of portfolios or strategies.
      Risk Analysis: Assessing market, credit, and operational risks.
      AI Modeling: Feeding the validated data into machine learning models for real-time and predictive analysis.
e) Optimized Data Queries:
   The evaluation results from the AI engine are stored 225 as metadata in the database, which includes:
      Source rankings.
      Quality scores for each dataset.
      Anomaly detection logs.
   This metadata allows for optimized future data queries, ensuring faster and more accurate data retrieval from the best sources.
f) Data Pool Integration:
   Once validated, the data is added 224 to the Stock Data Pool, which becomes the primary source for portfolio construction and ongoing management.
   The pool includes a comprehensive collection of validated data for assets such as stocks (e.g., AAPL, MSFT), bonds, ETFs, or other financial instruments.
g) Portfolio Construction and Management:
   The data stored in the data mart and pooled into the Stock Data Pool directly feeds into the portfolio construction process.
   Dynamic Updates: As new data arrives and is validated, the portfolio adjusts dynamically based on market conditions, investor risk profiles, and performance metrics.
   Historical Comparisons: Enables historical analysis and comparison of individual stock or portfolio performance.

### Benefits of the Staging Data Mart and Validation Process

1. Permanent and Centralized Repository:
   Ensures that all validated data is permanently stored and can be accessed for future portfolio analysis, reporting, or rebalancing.
2. Foundation for Portfolio Construction:
   By maintaining a structured and validated data mart, portfolio construction becomes more efficient and accurate.
3. Enhanced Data Integrity:
   Reduces the risk of inaccuracies in portfolio decisions by rigorously validating data before storage and usage.
4. Scalability:
   Allows for easy integration of additional data sources or financial instruments in the future, making it robust for institutional and individual investors.
5. Seamless AI-Driven Updates:
   AI continuously validates and updates the data, ensuring the portfolio remains aligned with the latest market conditions and investor preferences.

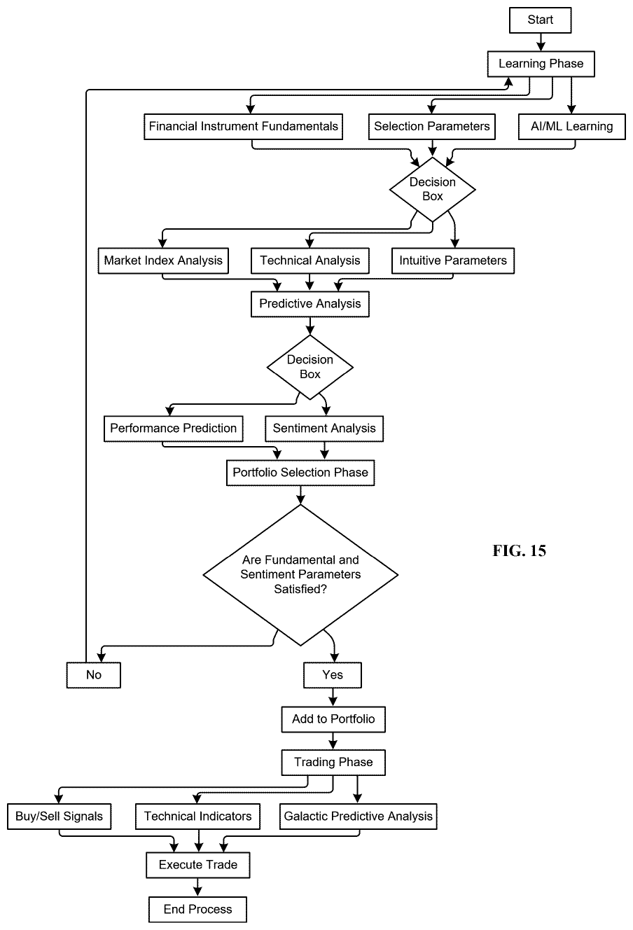

As shown in FIG. 2A, the individual investor's data is processed using actuarial methods, also referred to as actuarial data models 207. As used herein, investor's data comprises parameters comprising investor preferences, investor's goals, risk tolerance, return determination, investment horizon, tax implications, personal preferences, investor's historical investment behavior, trading patterns, market preferences, etc., of the individual and (or) institutional investor. In an embodiment, the parameters further comprise fundamental parameters, technical parameters and/or sentimental parameters as described in the description of FIG. 15. For institutional investors, the framework obtains the preferences of the institutional investors i.e., “institutional preferences”, as shown in FIG. 2A. As used herein, mainly there are two types of investors i.e., individual investors and institutional investors. Individual investors are personal investors with varying financial goals such as retirement, income generation, capital appreciation, etc. Institutional investors are entities like pension funds, hedge funds, family offices, etc. with different goals, time horizons, and asset management approaches.

The Investor's Data is processed using Actuarial Methods (actuarial data models)/Credit Rating APIs, and Social Score Ranking as follows:

Processing Investor's Data using Actuarial Methods/Actuarial Data models: Actuarial methods/Actuarial Data models are statistical and mathematical techniques used to assess and quantify risk. In the context of portfolio management, they process investor data to provide insights into financial planning, risk profiling, and investment strategy optimization.

### Key Features:

1. Risk Assessment:
   Uses actuarial data models to estimate an investor's financial risks based on:
      Age
      Income
      Asset base
      Liabilities
      Investment history
2. Lifetime Financial Modeling:
   Projects an investor's financial needs over their lifetime.
   Considers retirement planning, income stability, and potential liabilities (e.g., loans or medical expenses).
3. Risk Appetite Analysis:
   Quantifies the investor's tolerance for risk.
   Example: Conservative investors might be assigned a risk score favoring low-volatility assets like bonds.
4. Scenario Analysis:
   Simulates potential financial outcomes under different economic conditions (e.g., market crashes, inflation spikes).
5. Customization of Portfolios:
   Provides tailored investment strategies that align with the investor's risk tolerance 208, financial goals, and actuarial projections.

### Example Use Case:

An investor planning for retirement in 20 years may undergo actuarial analysis to determine:
Required annual contributions to achieve retirement goals.
Optimal portfolio allocation between equities, bonds, and real estate to balance growth and stability.

### Credit Rating APIs

Credit Rating APIs provide insights into an investor's creditworthiness by fetching and analyzing credit scores from established bureaus. This data can inform portfolio decisions and risk assessments.

### Key Features:

1. Credit Score Retrieval:
   Fetches scores from agencies like Experian, Equifax, or TransUnion.
   Provides details such as payment history, credit utilization, and outstanding debts.
2. Debt-to-Income Ratio:
   Calculates the ratio of the investor's debt to their income, helping assess their financial health.
3. Risk Adjustment:
   Uses credit data to adjust portfolio risk levels.
   Example: High-credit-risk individuals might favor low-risk, income-generating assets.
4. Loan Suitability Analysis:
   Evaluates whether the investor is eligible for loans or margin trading based on credit data.
5. Integration with Actuarial Data Models:
   Combines credit rating data with actuarial projections to provide a holistic financial risk profile.

### Example Use Case:

An investor with a high credit score and low debt might be recommended a more aggressive investment strategy, while someone with poor credit might focus on safer, income-generating investments.

Social Score Ranking: Social Score Ranking evaluates an investor's social and online behavior to gain insights into their financial habits, preferences, and overall reliability. It leverages non-traditional data sources like social media, online reviews, and behavioral patterns.

### Key Features:

1. Behavioral Analysis:
   Analyzes social media activity, professional networks, and online interactions.
   Identifies habits that indicate financial stability or risk-taking tendencies.
2. Reputation Scoring:
   Assigns scores based on online behavior and reputation.
   Example: Consistent professional behavior and responsible online interactions may result in a higher score.
3. Psychographic Profiling:
   Assesses personality traits, preferences, and attitudes toward risk and wealth accumulation.
   Example: An investor showing interest in sustainable initiatives may prefer ESG portfolios.
4. Alternative Risk Assessment:
   Complements traditional credit scores by providing an additional layer of risk analysis.
   Example: Investors with limited credit history but strong social scores may still be deemed reliable.
5. Real-Time Updates:
   Continuously updates scores based on ongoing social activity and interactions.

Example Use Case: An investor who actively follows and engages with financial news platforms on social media might be considered more informed and willing to take calculated risks. This insight can influence the portfolio's asset allocation strategy.

### Imagine an Investor Onboarding Process:

Actuarial Analysis: The system calculates their retirement needs, risk tolerance 208, and optimal savings rate.
Credit Score Check: Fetches their credit rating to ensure they can handle risks like margin trading or high-leverage investments.
Social Score Evaluation: Evaluates their behavioral tendencies, such as interest in ESG investing or preference for high-growth sectors.

These inputs are combined to create a highly personalized portfolio tailored to their financial profile, goals, and preferences.

Learning Preferences with a Personalized LLM Model 211:

A Personalized Large Language Model (LLM) tailors its interactions, outputs, and recommendations based on an individual's unique preferences, goals, and historical interactions. In the context of learning preferences, it adapts its content delivery, tone, and depth to suit the specific needs and styles of the user.

### Key Components of a Personalized LLM Model for Learning Preferences

1. Adaptive Learning Mechanisms
   The LLM evolves based on user interactions, identifying how each investor prefers to consume information or interact with the platform.
   Examples:
      Visual Learners: Provide portfolio charts, infographics, or trend visualizations.
      Verbal Learners: Focus on textual explanations and written recommendations.
      Action-Oriented Learners: Offer interactive tools, such as simulation models or real-time trade calculators.
2. Behavioral Analysis
   Tracks the user's habits, preferences, and engagement history to refine learning paths.
   Examples:
      If an investor often clicks on ESG-related news, the LLM prioritizes sustainable investment content.
      For users frequently seeking risk metrics, the LLM tailors responses to include Sharpe ratios or volatility indices.
3. Natural Language Understanding and Dialogue Personalization
   Uses advanced natural language processing to:
      Understand user queries, regardless of complexity or phrasing.
      Respond in a tone and complexity level suited to the investor's expertise (e.g., beginner-friendly or advanced).
   Examples:
      Novice Investor Query: “What's a good investment strategy?”
         Response: “For beginners, consider a diversified portfolio of index funds and bonds to balance growth and stability.”
      Advanced Investor Query: “How does the beta of this stock affect portfolio risk?”
         Response: “This stock has a beta of 1.2, indicating higher volatility than the market. It could increase portfolio risk depending on current weightings.”

### Personalization Process

1. Data Collection:
   User Input: Investor's goals, risk tolerance, investment horizon, and preferred interaction style.
   Behavioral Data: Tracking navigation patterns, interaction history, and frequent queries.
   External Data: Social score, credit ratings, and actuarial data models (from the components described earlier).
2. Preference Learning:
   The LLM identifies recurring themes and adjusts its outputs.
   Example: An investor who often queries about real estate trends will see more recommendations for REITs (Real Estate Investment Trusts).
3. Dynamic Content Generation:
   Creates personalized recommendations and educational content.
   Example: Generates a tutorial for portfolio diversification tailored to the investor's current holdings.

### Use Cases of a Personalized LLM in Investment Software

1. Tailored Investment Recommendations
   Generates investment strategies aligned with user preferences and risk appetite.
   Example: “Based on your risk tolerance and interest in high-growth sectors, consider adding ETFs like ARKK, which focus on innovation.”
2. Customized Market Insights
   Summarizes complex financial reports or market news.
   Example: “Tesla's recent earnings report highlights a 15% growth in revenue. This aligns with your interest in growth-oriented tech stocks.”
3. Interactive Portfolio Analysis
   Responds to queries with real-time portfolio insights.
   Example: “Your portfolio's current Sharpe ratio is 1.3, which is above the market average. Adding bonds could improve risk-adjusted returns.”
4. Goal-Based Learning Modules
   Educates users about investment topics relevant to their goals.
   Example: A user aiming for retirement planning receives tutorials on tax-advantaged accounts and compound interest.

### Key Features Enabled by Personalized LLM

1. Conversational Interaction:
   Provides a natural, chat-based interface for complex financial queries.
   Example: “Explain the impact of rising interest rates on my bond investments.”
2. Multi-Lingual Support:
   Tailors responses in the user's preferred language, improving accessibility.
3. Real-Time Updates:
   Dynamically adapts content based on market conditions.
   Example: “Today's Fed announcement may impact your holdings in financial sector stocks.”
4. Emotion-Aware Responses:
   Recognizes sentiment from user queries and adapts accordingly.
   Example:
      Query: “I'm nervous about the market crash.”
         Response: “Market corrections can be unsettling, but your portfolio is diversified to mitigate significant risks.”
            Integration with Other Components
1. Actuarial Data Models:
   Provides the LLM with a detailed risk profile and lifetime financial projections, enabling smarter recommendations.
2. Credit Rating APIs:
   Informs the LLM about the investor's creditworthiness to tailor suggestions on leveraging or debt management.
3. Social Score Ranking:
   Enhances the LLM's understanding of the investor's values and interests, aligning recommendations with personal preferences (e.g., ESG investing).

### How the LLM Optimizes the User Experience

### Example Workflow:

1. User Query:
   “I want to retire in 15 years. How should I invest?”
2. Data Integration:
   LLM accesses actuarial data models for retirement goals, credit scores for financial health, and social scores for preferences.
3. Response:
   The LLM generates a detailed plan:
      “To retire in 15 years with an annual income of $80,000, you need a portfolio worth $1.2 M. Consider investing in low-cost index funds (e.g., VOO, VTI) and allocating 20% to bonds for stability.”
      Adds a link to an interactive calculator for refining the plan.

Portfolio Construction 209: Portfolio construction is the process of selecting and allocating assets to create a portfolio that aligns with an investor's financial goals, risk tolerance, and preferences. In the context of the investment software enhanced by Personalized LLM Models, actuarial methods, and API-driven insights, portfolio construction becomes a dynamic, data-driven, and highly personalized process.

### Key Components of Portfolio Construction

### 1. Setting Objectives

Define the investor's goals:
   Capital appreciation
   Income generation
   Risk minimization
   Diversification
   Specific time horizons (e.g., retirement, buying a house)
Incorporate constraints:
   Risk tolerance (e.g., low, moderate, high)
   Ethical preferences (e.g., ESG investing)
   Liquidity needs

### 2. Asset Selection

Utilize data from APIs, actuarial methods/Actuarial data models, and LLM recommendations to identify assets such as:
   Equities: High-growth stocks, dividend-paying stocks.
   Fixed Income: Bonds, treasury securities.
   Alternatives: Commodities, REITs, hedge funds, cryptocurrencies.
   Cash Equivalents: Money market funds, savings.

### 3. Risk Assessment and Allocation

### Risk Profiling:

Use actuarial data models to analyze investor-specific risks.
Incorporate market risks (volatility, sectoral exposure) and personal financial risks (credit score, liabilities).

### Risk Mitigation Methods:

Value-at-Risk (VaR): Quantifies potential portfolio losses over a specific timeframe at a given confidence level.
Stress Scenario Analysis: Simulates portfolio performance under adverse events like market crashes or rising interest rates.
Hedging Strategies: Uses derivatives (options, futures) to offset potential losses. E.g. Hedging equity risk with index put options.
Dynamic Rebalancing: Adjust allocations periodically to maintain risk-return alignment.

### Diversification:

Minimize unsystematic risk by spreading investments across sectors, geographies, and asset classes.
Example: Avoid overexposure to technology stocks by balancing with consumer goods and healthcare.

### 4. Optimization

### Reinforcement Learning (RL):

The system iteratively tests asset combinations to identify optimal risk-adjusted returns.
Metrics like Sharpe Ratio, Sortino Ratio, and tracking error guide the optimization process.

### Dynamic Rebalancing:

Adjust portfolio allocations based on market conditions, investor preferences, or life events.

### Workflow of Portfolio Construction in the Software

### 1. Investor Profiling:

Data Sources:
   Actuarial methods provide lifetime financial projections.
   Credit Rating APIs assess financial discipline.
   Social Score Ranking identifies behavioral and ethical preferences.
Output: Risk tolerance, return expectations, and investment constraints.

### 2. Asset Universe Selection:

### Data Aggregation:

API consolidator collects data on 15,000+ financial instruments (stocks, ETFs, bonds, etc.).

### Selection:

LLM narrows down the universe based on investor preferences and goals.
Example: For a sustainability-focused investor, prioritize ESG-compliant stocks and funds.

### 3. Portfolio Optimization:

### Simulation:

Reinforcement Learning models test millions and trillions of asset combinations.
Example: Allocate 60% to equities, 30% to bonds, and 10% to alternatives to achieve the desired risk-return profile.

### Reward Function:

Optimize for metrics such as:
   Sharpe Ratio: Maximize risk-adjusted returns.
   Diversification Index: Ensure broad exposure.
   Beta: Manage market sensitivity.

### 4. Portfolio Construction:

Based on optimization results, create the initial portfolio with specific asset allocations.
Example Portfolio for a Moderate Risk Investor:
   40% Equities:
      20% AAPL (Apple)
      10% VOO (S&P 500 ETF)
      10% TSLA (Tesla)
   40% Bonds:
      20% TLT (Treasury Bonds ETF)
      20% AGG (Aggregate Bond ETF)
   20% Alternatives:
      10% GLD (Gold ETF)
      10% REITs (Real Estate Investment Trusts)

### 5. Investor Feedback:

Present the portfolio to the investor for approval.
Example: “Based on your preferences and risk profile, this portfolio has a projected annual return of 12.5% with a volatility of 15%. Would you like to proceed or adjust allocations?”

### 6. Continuous Monitoring and Updates:

Use APIs and real-time data to monitor portfolio performance.
LLM offers rebalancing suggestions or alternative allocations in response to market changes.

### Features of Portfolio Construction in the Software

1. Customization with LLM Models
Personalized Recommendations:
   Beginner investors receive simple portfolios with index funds.
   Advanced investors see sector-specific, high-growth strategies.
Natural Language Queries:
   Example: “What allocation will minimize risk for my portfolio?”
   LLM responds with actionable insights and suggested allocations.

### 2. Real-Time Data Integration

Fetch real-time stock prices, news, and analytics via APIs.
Ensure portfolios reflect the latest market conditions.

### 3. Scenario Analysis and Stress Testing

Simulate portfolio performance under adverse conditions (e.g., market crashes, rising interest rates).
Example: “If the market drops 10%, your portfolio value would decrease by 6.5%.”

### 4. Tax-Efficient Strategies

Incorporate tax-optimized investment plans:
   Tax-advantaged accounts (e.g., IRAs, 401(k)s).
   Harvesting losses to offset gains.

### 5. ESG and Ethical Investing

Tailor portfolios to align with investor values (e.g., renewable energy, diversity-focused funds).
Example: Allocate 30% to ESG-compliant ETFs and avoid fossil fuel companies.

### Benefits of LLM-Assisted Portfolio Construction

Personalized Guidance: Portfolios are uniquely tailored to each investor's preferences, goals, and risk profiles.
Enhanced Decision-Making: Simplifies complex investment decisions with clear, actionable insights.
Flexibility: Allows investors to adjust allocations dynamically based on evolving goals or market changes.
Transparency: Provides clear reasoning behind asset choices, fostering trust.
Efficiency: AI-driven optimization significantly reduces the time required to construct and test portfolios.

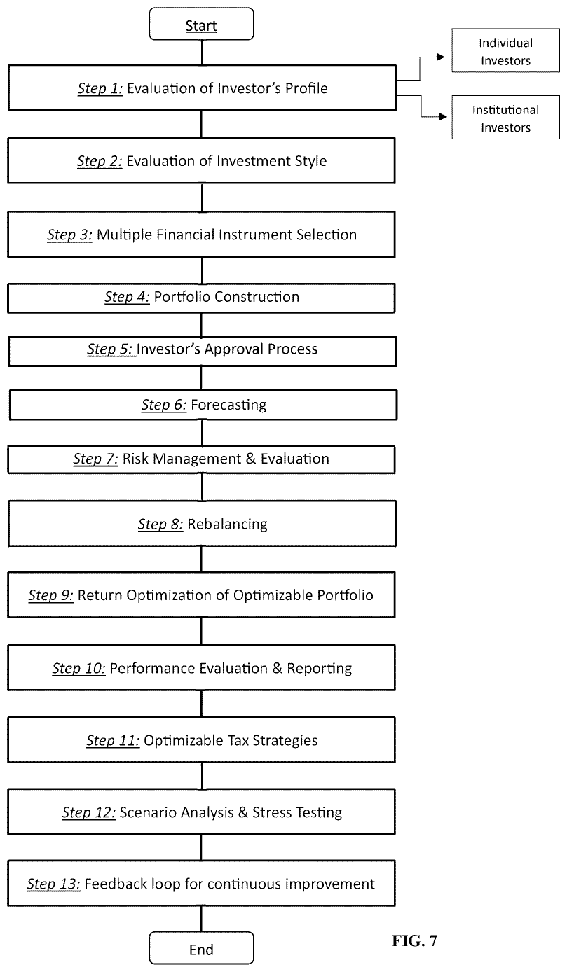

Processing the unique model for the optimization of the expected return. Processing unique model for the optimization of the expected return 212 corresponds to FIG. 7. FIG. 7 illustrates a flowchart showing the overall process followed by the model for the optimization of the expected return 212 to obtain an output comprising Optimized Expected Return 213.

As shown in FIG. 2A, after determining the investor's risk tolerance level, the investor's portfolio is constructed 209. FIG. 2A comprises an Investor's approval process 210 after the portfolio is constructed. The investor's approval process is used for portfolio allocation using AI-driven risk scoring. The investor's approval process ensures that portfolio allocations align with the investor's risk tolerance and preferences while accounting for real-world economic conditions. The investor approval process integrates risk profiling, actuarial analysis, credit scoring, and macroeconomic factors to generate a personalized portfolio recommendation, as illustrated below:

Investor Risk Profiling comprises:

### a) Data Collection:

The investor completes a questionnaire to assess:
   Financial goals (short-term or long-term investments).
   Risk tolerance (e.g. conservative, moderate, or aggressive).
   Investment knowledge and experience.
   Expected returns and loss thresholds.
Demographic data such as age, income, marital status, etc. is also collected.

### b) Risk Scoring Analysis:

Historical financial data and market performance are analyzed to calculate key metrics, including:
   Sharpe ratios for risk-adjusted returns.
   Volatility of asset classes.
   Portfolio diversification needs.
The investor is assigned an initial risk tolerance score (e.g., on a scale of 1-10).
   Integration of Actuarial data, Credit Scoring, and Rating Data

### a) Fetching Actuarial Data:

For Individual investors:
   The AI agent 311a retrieves actuarial data, including longevity projections, income stability, and savings rates, to analyze life expectancy and financial endurance.
For Institutional investors:
   The AI agent 311a fetches credit ratings and institutional creditworthiness scores from verified agencies like Moody's, Fitch, DNB, etc.

### b) Cross-Referencing Data:

The actuarial and credit scoring data are matched against the investor's questionnaire response to ensure alignment between self-reported risk preferences and actual financial health.
Discrepancies, such as overestimations of risk tolerance or underestimations of income volatility, are flagged by the AI agent 311a.

### Market and Macroeconomic Data Analysis

### a) Incorporating External Indicators:

The AI agent 311a analyzed macroeconomic indicators, including:
   Inflation rates.
   Interest rates and central bank policies.
   Economic growth forecasts and GDP trends.
   Sector-specific market conditions.
These factors influence the asset classes and portfolio allocations recommended.

### b) Dynamic Adjustment for Longevity and Inflation:

For individual investors with good credit scores, longevity data is integrated to calculate the risk-adjusted financial endurance needed for their lifetime.
Inflation-adjusted returns are calculated to align with real purchasing power preservation.

### Generating Risk Tolerance and Portfolio Recommendations

### a) Risk Tolerance Scoring:

Based on actuarial, credit scoring, and market data analysis, the AI agent 311a assigns a final risk tolerance score to the investor. For example:
   A risk tolerance score of 6 indicates a moderate risk portfolio.
   A risk tolerance score of 8 indicates an aggressive portfolio allocation.

### b) Custom Portfolio Allocation:

If the investor agrees with their assigned risk score, a portfolio suggestion is generated based on their score and current market conditions.
If the investor prefers a higher or lower risk portfolio (e.g. a risk score of 8 instead of 6), the AI agent 311a dynamically adjusts the portfolio to reflect the new risk appetite while ensuring alignment with market realities.

### Investor Approval and Final Portfolio Recommendations

### a) Investor Review:

The investor is presented with:
   The rationale for the assigned risk score.
   The portfolio allocation tailored to their risk profile.
   A comparison of alternative portfolios for different risk levels.
AI-Driven Suggestions:
   The AI agent 311a provides insights into how changing risk levels impact potential returns volatility, and exposure.
   For example, moving from a moderate portfolio (score 6) to an aggressive portfolio (score 8) may increase exposure to equities and reduce bond holdings.
Final Approval:
   Once the investor approves the suggested portfolio, the allocation is finalized, and periodic rebalancing recommendations are scheduled based on changes in market conditions, updates to actuarial and credit scoring data, adjustments in the investor's financial circumstances.

### Novelty and Advantages:

Integrated Risk Assessment: Combines self-reported preferences, actuarial data, and credit scoring to ensure a comprehensive risk profile.
Dynamic Adjustments: Allows investors to adjust their risk tolerance and dynamically modifies portfolio allocations to align with updated preferences.
Macroeconomic Sensitivity: Incorporates inflation, interest rates, and market trends into portfolio recommendations.
Scalability: Applicable to both individual and institutional investors, enabling diverse use cases such as retirement planning or endowment fund management.
Transparency: Provides clear rationales for portfolio suggestions, empowering investors to make informed decisions.

This investor approval process is a data-driven and adaptive system that personalizes portfolio recommendations by leveraging AI to synthesize multiple data sources. It enhances confidence and decision-making for both investors and financial institutions.

As shown in FIG. 2A, the framework also utilizes “Learning Preference”. The learning preference or the learning process in the AI model works in the following way:
1) Data Collection and Preparation: Gather and pre-process data (cleaning, normalization).
2) Model Selection: Choose and appropriate model type (e.g., neural networks, decision trees).
3) Forward Propagation: Feed data through the model to make initial predictions.
4) Loss Calculation: Calculate prediction error using loss function.
5) Backpropagation: Update model weights to minimize error.
6) Training (Epochs): Repeat training with multiple iterations to improve performance.
7) Evaluation and Testing: Use a validation/test dataset to measure effectiveness.
8) Hyperparameter Optimization: Tune model settings to enhance accuracy.
9) Generalization: Ensure the model performs well on unseen data (prevent overfitting).
10) Deployment and Inference: Use the trained model to make predictions on new data.
Types of Learning:
Supervised Learning: Uses labeled data.
Unsupervised Learning: Finds patterns in unlabeled data.
Reinforcement Learning: Learns through trial and error, using rewards.

The portfolio manager 311a employs reinforcement learning (RL) to find the optimal combination of stocks. In reinforcement learning, an AI agent 311a iteratively tries different portfolio combinations and learns from the market's response (reward in the form of returns or risk minimization.

The framework uses a unique risk assessment process using dynamic data collection and Application Programming Interface (API) integration. The dynamic data is collected through APIs. Apart from the investors' questionnaires, the system integrates external APIs such as Actuaries, Dun & Bradstreet (D&B), and other reliable financial information sources. Investor information, such as financial status, liabilities, and investment history, is dynamically collected from these APIs. Furthermore, the framework performs verification and authentication using a data validation and authentication module 304, shown in FIG. 3. The multiple modules further comprise a data acquisition module 303 configured to receive and/or collect data, pre-process the received data, normalize and integrate the pre-processed data to create a comprehensive dataset for analysis. The received data is pre-processed using one or more of actuarial data models and credit worthiness to estimate an investor's risk. The data received by the data acquisition module 304 comprises traditional data, for example, financial data comprising stock exchange data, company financials, economic indicators, regulatory filings. The data received by the data acquisition module 304 further comprises alternative data comprising social media sentiment, news articles, sensor data, and other non-traditional data sources. The real-time data received or collected by the data acquisition module 303 is used by the data validation and authentication module 304 to verify and authenticate the information provided by investors during the onboarding questionnaire. By cross-referencing investor-submitted data with accurate third-party API data, the system ensures high data integrity and eliminates potential discrepancies. The framework performs aligned risk scoring. The combination of questionnaire data and verified external information allows for more precise risk profiling. The system aligns the investor's provided information with verified data from APIs, improving the accuracy of the risk score calculation.

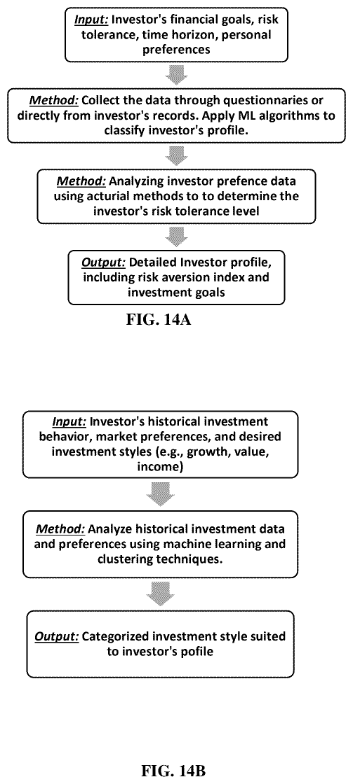

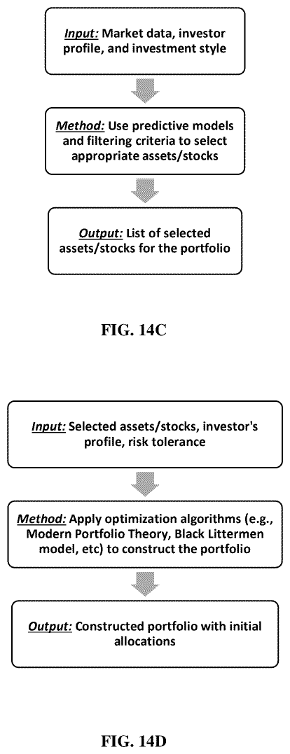

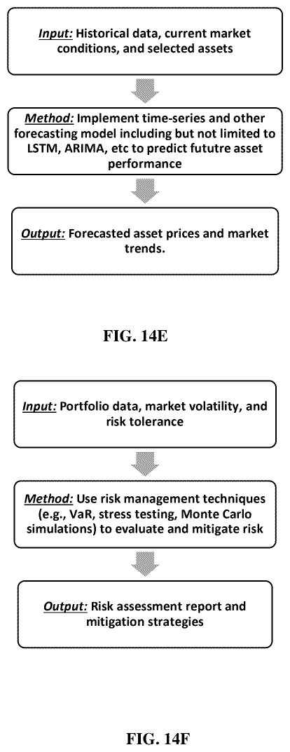

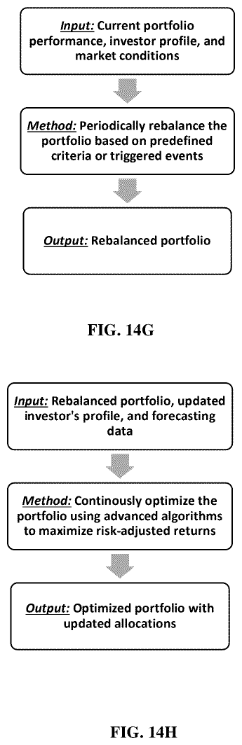

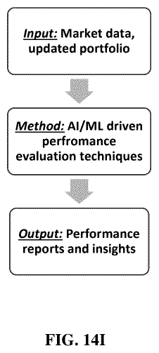

The modules further comprise a profile evaluation module 305 configured to receive data on an investor's goals, risk tolerance, investment horizon, and personal preferences. The profile evaluation module 305 is further configured to apply one or more machine learning algorithms to analyze and classify profiles of a plurality of investors dynamically and generate a detailed investor profile report, including a risk aversion index and specific investment objectives. The modules further comprise an investment style evaluation module 306 configured to analyze investor's historical investment behavior, trading patterns, and market preferences, as shown in FIG. 14B. The investment style evaluation module 306 then utilizes clustering techniques, utility function, risk budgeting and sentiment analysis to determine investor's preferred investment style. The investment style evaluation module 306 then outputs a categorized investment style tailored to investor's profile and preferences.

### Risk Budgeting:

As used herein, risk budgeting or risk budget is simply a particular allocation of portfolio risk. An optimal risk budget is simply the allocation of risk such that the first order of conditions for portfolio optimization is satisfied. Risk budgeting is an advanced portfolio management technique in which the investors allocate risk precisely among portfolio components to achieve targeted investment outcomes. Unlike traditional methods, which allocate capital purely based on expected returns, risk budgeting explicitly manages how much risk each investment contributes toward the overall portfolio volatility, ensuring no single asset or strategy disproportionately influences the total portfolio risk. It is the process of finding an optimal risk budget. (Kurt Winkelmann, 2003, 173). There are three aspects of risk budgeting:
The risk budget identifies the total amount of risk and allocates the risk to a portfolio's constituent parts.
An optimal risk budget allocates risk efficiently.
The process of finding the optimal risk budget is risk budgeting.

Given below is an example that assumes a simplified investment portfolio consisting of four asset classes. Portfolio standard deviation (total risk) is assumed to be 10%.

| | | | | % | | |
|---|---|---|---|---|---|---|
| | | | | Contribution | | |
| | Weights | | | to Total | Excess | Ratio Excess |
| Asset Class | (%) | MCTR | ACTR | Std Dev | Return | Return/MCTR |
| U.S. Equities | 40% | 15% | 6% | 60% | 6.5% | 0.433 |
| International | 20% | 12% | 2.4% | 24% | 5% | 0.417 |
| Equities | | | | | | |
| Bonds | 30% | 30% | 1.5% | 15% | 2% | 0.4 |
| Commodities | 10% | 10% | 1% | 10% | 4% | 0.4 |

Asset Class: Category of investments (stocks, bonds, real estate, commodities, etc.).
Weights: The percentage allocation of capital to each asset class.
MCTR (Marginal Contribution to Total Risk): The change in total portfolio risk (standard deviation) resulting from a small incremental increase in the allocation to an asset. MCTR indicates how sensitive the portfolio's total risk is to changes in each asset's allocation.

MCTR=Asset beta relative to portfolio×Portfolio Standard Deviation
ACTR (Absolute Contribution to Total Risk): Each asset's actual contribution to total portfolio risk; calculated as: ACTR=Asset weight in portfolio×MCTR ACTR quantifies the exact contribution of each asset to the total portfolio risk.
% Contribution to Total Std Dev: The percentage contribution each asset has to the portfolio's total risk. It clearly shows which asset classes are major or minor risk drivers.

$$\% Contributed to Total Std Dev = \frac{ACTR}{Portfolio Sfd Dev} \times 100$$

Ratio of Excess Return to MCTR: Measures the risk-adjusted performance potential. It indicates how much incremental return each asset provides relative to its marginal risk contribution. It measures how effectively each asset generates return per unit of marginal risk it introduces, helping prioritize risk allocation for better portfolio efficiency. Excess Return=Expected Return−Risk Free Rate

$$Ratio = \frac{Excess Return}{MCTR}$$

Sum of ACTRs=Portfolio Std Dev (6%+2.4%+1.5%+1%=10%)

U.S. Equities: Largest ACTR and % contribution (60%), meaning it's the primary driver of total portfolio volatility. It has a relatively high Excess Return/MCTR ratio (0.433), indicating strong risk-adjusted return potential. Though risky, the portfolio is compensated relatively well.

International Equities: Contribute significantly (24%) to portfolio volatility. Its risk-adjusted return (0.417) is slightly lower than U.S. equities, but still favorable, suggesting moderate efficiency and reasonable inclusion.

Bonds: Lowest MCTR (5%), low ACTR (1.5%), meaning bonds are effectively reducing the portfolio's total risk. Lower Excess Return/MCTR ratio (0.400) compared to equities. Bonds reduce volatility but offer lower incremental returns per unit of risk.

Commodities: Relatively low risk contribution (10%), moderate MCTR. Good diversification benefits, as its correlation with equities might be lower. Decent Excess Return/MCTR (0.400), suggesting a balanced addition from a risk-return perspective.

In the context of the automated system, the risk budgeting process uniquely leverages real-time, predictive risk analytics powered by advance machine learning models. The system will utilize:
Real-time ML driven volatility forecasting: The system continuously forecasts the volatility and correlations of each asset class using predictive ML models (e.g., LSTM or Transformer-based neural networks trained on market data), updating every minute or hourly. This enables dynamic adjustment of risk allocation rather than relying on static historical volatility, which is a conventional method.
Automated Risk Allocation and Rebalancing: Suppose the ML model identifies that asset's volatility is forecasted to sharply increase, predictive ML models (e.g. LSTM or Transformer-based neural networks trained on market data), updating every minute or hourly. This enables dynamic adjustments of risk allocation rather than relying on static historical volatility, which is a conventional method.
ML-driven Real-Time MCTR Calculation: ML-based volatility and correlation prediction engines (e.g., neural network-based volatility prediction) recalibrate the MCTR continually, allowing real-time adjustments and optimizations.
Dynamic ACTR and Risk Attribution Analytics: Software would instantly show exact risk contributions with predictive analytics, significantly surpassing static or historical approaches.
AI-based Excess Return Forecasting: Integrating ML-driven predictive analytics (economic regime forecasts, sentiment analysis, deep-learning-based factor modeling), your software dynamically recalculates expected returns, ensuring the “Excess Return to MCTR” ratios remain forward-looking and accurate, rather than historical.

The distinct technical innovation here is the automated, real-time recalibration of portfolio risks via predictive, machine learning-driven analytics rather than generic portfolio allocation approaches. By linking ML-based risk forecasting directly to real-time execution mechanisms, the system transforms the principle of risk budgeting into specific, tangible, and technologically driven solutions that improve efficiency and precision.

### Utility Function

A utility function mathematically represents an investor's preferences by quantifying satisfaction or value derived from various investment outcomes. In the automated portfolio system, the utility function is critical for translating abstract investor goals (risk tolerance, expected return) into a clear mathematical optimization problem, guiding investment decisions systematically.

The system implements a unique adaptive utility function optimized via machine learning algorithms that dynamically integrates multiple investor-specific preferences and external market indicators.

For example, the system's utility function could be defined as:

$$U = E ( R ) - \frac{λ}{2} {σ}^{2} - α . {ML}_{Risk Indicator}$$

### Where:

E(R) is the expected return, continuously forecasted using ML-based regression methods.
σ² represents dynamically estimated portfolio variance from predictive ML volatility models.
λ lambda is the investor-specific risk aversion coefficient, adaptively calibrated based on real-time feedback or user input.
α·ML_{Risk Indicator} is a unique, patented term introduced by your software, representing an ML-derived external risk indicator (e.g., sentiment analysis or macroeconomic ML predictions) directly influencing investment utility.

In an embodiment, if the ML models forecast a market downturn based on predictive analysis of macroeconomic indicators or sentiment derived from news feeds. The system incorporates this ML-predicted external risk directly into the utility function. As this ML-derived risk indicator increases, the software autonomously recalibrates the investor's utility-based portfolio optimization toward defensive assets, effectively managing risk and preserving investor value.

| Parameter | Value | Explanation |
|---|---|---|
| Expected Return, | 8% | ML-predicted portfolio |
| E(R) | (0.08) | expected annualized return. |
| Portfolio | 4%² | ML-estimated variance from |
| Variance, σ² | (0.0016) | volatility models (σ = 4%). |
| Risk Aversion, λ | 3 | Investor-specific preference |
| | | (higher = more conservative). |
| ML Risk Indicator | 0.5 | ML predictive indicator score |
| | | (0 = low risk, 1 = high risk). |
| Sensitivity | 0.05 | Weight assigned to ML risk |
| Coefficient, α | | factor by investor preference. |

$$U = 0.08 - \frac{3}{2} ( 0.0016 ) - 0.5 ( 0.03 )$$

$$U = 0. 08 - 0.0024 - 0.0 \; 15$$

$$Final utility value : U = 0.0626 or 6.26 \%$$

Expected Return (8%) Reflects the portfolio's performance expectation derived from ML predictive analytics (highly dynamic and adaptive).
Portfolio Variance Penalty (0.24%): This penalty explicitly captures the portfolio's risk. Since variance is low (4%), the risk penalty is modest.
ML Risk Indicator (1.5% penalty): This unique ML-driven term adjusts investor utility according to predicted external market risks (e.g., upcoming downturn identified through predictive macroeconomic or sentiment ML analytics).

Technological logic: Unlike traditional abstract financial utility measures, your software dynamically recalculates investor utility by integrating predictive, real-time ML analytics. This makes investor utility sensitive not only to return and volatility but also to external market conditions forecasted by machine learning-creating a dynamic, adaptive optimization approach.

### Practical Implications:

If your ML risk indicator increases significantly (e.g., an economic downturn predicted), the software instantly recalibrates the utility downward for riskier portfolios, prompting automated portfolio shifts toward safer allocations.
Conversely, during stable or positive sentiment scenarios (low ML indicator value), utility increases, incentivizing risk-taking and pursuing higher returns, aligning dynamically with the investor's true preferences and current market conditions.

If the ML model forecasts higher external risk, this term increases, dynamically and automatically lowering portfolio utility, thus shifting portfolio decisions toward safer assets.

The innovation lies in the explicit integration of adaptive, ML-driven indicators into the utility function, coupled with automated real-time recalibration mechanisms. Unlike a generic, abstract utility function that merely reflects subjective investor preference, this implementation explicitly involves technological means (ML algorithms) to quantify and dynamically adapt investor utility, creating a tangible and unique technical contribution.
Employs real-time machine learning models that continuously predict and update risk estimates and external market indicators, thus technically enabling real-time adjustments in portfolio construction.
Directly integrates ML-derived forecasts into traditionally abstract financial concepts (risk budgeting and utility functions), making them actionable, technology-specific, and demonstrably tied to improved technical performance in portfolio management.
Explicitly integrating predictive ML analytics directly into the utility function.
Making investor decisions dynamically adaptive via technological means rather than relying on abstract theoretical models or subjective investor input alone.
Using real-time computational methods (predictive analytics, ML-driven risk estimation), moving away from generic utility concepts to technologically specific, actionable, and demonstrably impactful solutions.

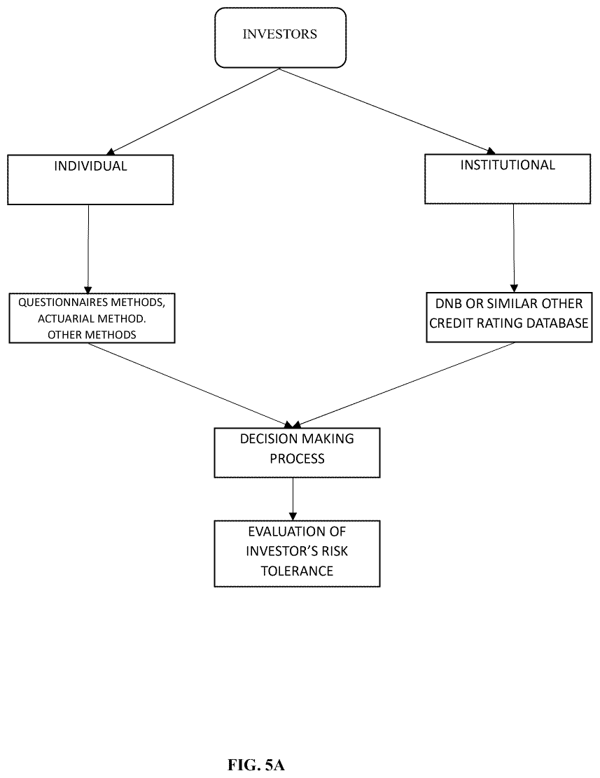

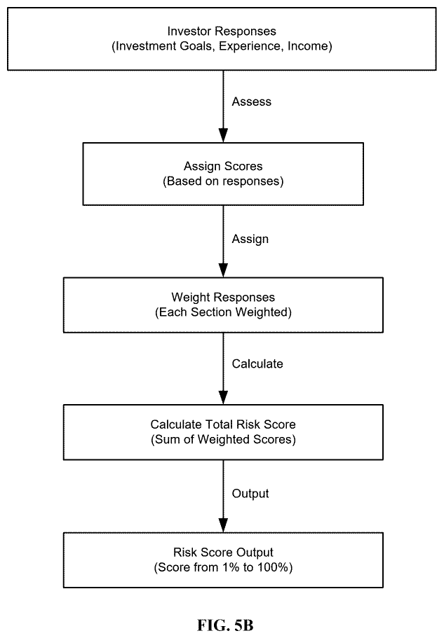

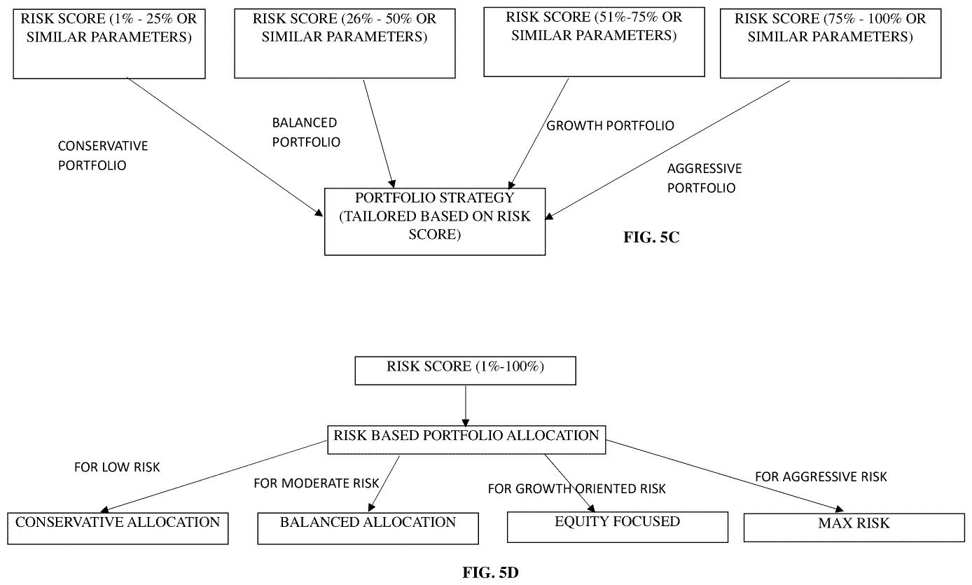

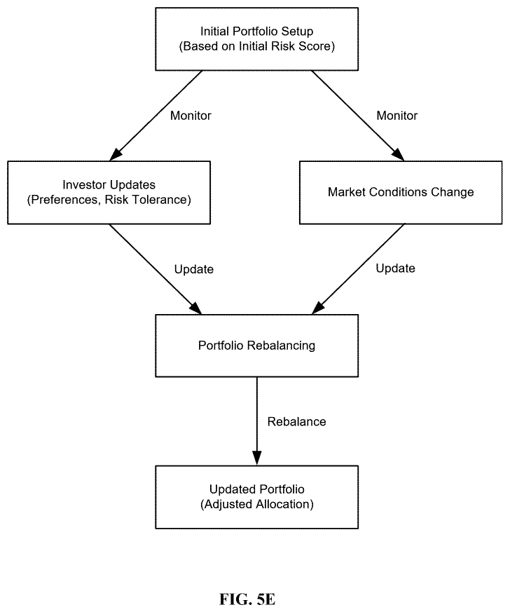

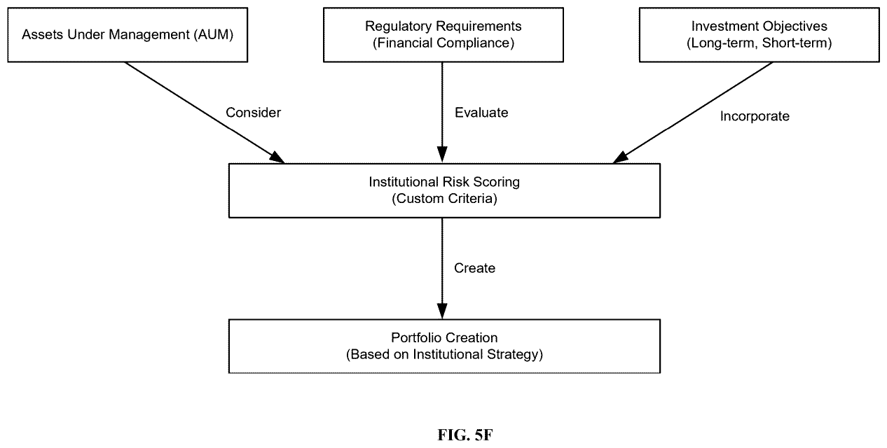

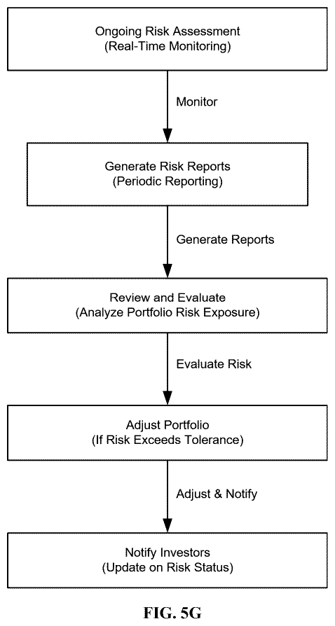

The framework performs a weighted scoring approach for risk scoring. FIG. 5A illustrates a flowchart illustrating the decision-making process for evaluating the investor's risk tolerance. To assess an investor's risk tolerance through a detailed onboarding questionnaire and create a portfolio that matches their risk profile. This risk profile is calculated using a weighted scoring system that takes into account investment goals, experience, income, liabilities, and preferences. FIG. 5B illustrates the risk scoring process performed by the system 300, shown in FIG. 3. Each question is assigned a score, typically from 1 to 5, based on how risk-tolerant or risk-averse the investor is. For example, a conservative investor would score lower (1-2), while an aggressive investor would score higher (4-5). The questions are grouped into sections, each weighted according to its importance in determining risk tolerance. The weighted scores are summed to calculate the total risk score, which ranges from 1% to 100%. This risk score is used to determine the investors overall risk tolerance and guides portfolio creation.

Example Weightings for Individual Investors are illustrated as follows:
Investment Goals & Time Horizon. 25%
Income, Assets, & Liabilities: 20%
Investment Experience: 15%
Investment Preferences: 20%

The scoring process comprises scoring the investor's response, for each section. These scores are then multiplied by the section's weight to generate a weighted score for each category.

Total risk score is calculated using the following equation:

Risk Score=Σ(Section score*Weight)

This final score, ranging from 1% to 100%, determines the investor's risk profile, from very conservative to highly aggressive.

The investor's risk tolerance level is outputted after processing the investor's data using actuarial methods. The investor's risk tolerance level may be interpreted as follows:

FIG. 5C illustrates risk tolerance interpretation based on a risk score range. As shown in FIG. 5C, the Risk Score Range are classified as follows:
Low Risk Score (1%-25%): Indicates a very conservative investor, preferring minimal risk and stable investments. The portfolio focuses on capital preservation with very low-risk investments.
Moderate Risk Score (26%-50%): Indicates moderate risk tolerance, balancing safety with some growth. The portfolio includes a mix of conservative and growth-oriented assets.
Growth-Oriented Risk Score (51%-75%): Growth-oriented, willing to take on higher risks for better returns. The portfolio is more aggressive, and includes a higher proportion of equities or other volatile assets.
Aggressive Risk Score (76%-100%): Highly aggressive investors, comfortable with high volatility and aiming for maximum capital appreciation. The portfolio includes riskier assets such as emerging markets, speculative stocks, or commodities.

The final portfolio strategy is tailored based on the calculated risk score, aligning the asset mix with the investor's risk tolerance.

The modules further comprise an instrument selection module, herein referred to as a financial instrument selection module 307 configured to use predictive models, including the machine learning algorithms, to filter and select appropriate assets and stocks, as shown in FIG. 14C. In an embodiment, the financial instrument selection module 307 dynamically selects suitable instruments, for example, financial instruments as per the investors risk tolerance level, as follows:

At the beginning of the lifecycle of the project, the AI model will be presented with a set of data sources, such as but limited to Paid Article on current stock market sentiment, historical of company quarterly results, historical financial data, general news outlets, and other data deemed necessary. The AI model will initially process all that data and find a pattern that best link stock movement and sentiment or hard financial data. We will not direct the model to build the data from either form input, instead we will instruct it to dynamically switch or adapt its model based on the type of market.

Dynamically build strategies: AI/ML is leveraged to analyze massive datasets to dynamically adapt the model based on the type of market (whether driven by sentiment, fundamental data, or technical indicators). The AI model switches or adapts dynamically between these data sources depending on the market conditions. Below is a comparison of this with a manual approach versus an AI-driven approach, both numerically and conceptually.

Without AI/ML (Manual Approach)
1. Data Sources to Analyze:
   Stock price data (historical price movements).
   Sentiment data (news, social media, analyst reports).
   Fundamental data (earnings, revenue, financial ratios).
   Market-specific factors (interest rates, inflation, etc.).
2. Steps in Manual Analysis:
   A financial analyst would have to manually:
      Collect data from multiple sources.
      Apply rules based on pre-defined criteria.
      Decide when to rely on sentiment analysis or fundamentals.
      Reassess market conditions periodically (e.g., quarterly).
      Adapt strategies based on interpretation of the data.
3. Computation Complexity (Example for S&P 500):
   Assume an analyst manually collects 5 years of daily price data, sentiment data, and fundamental data for each stock in the S&P 500.
   Data points to analyze: 500 stocks×252 trading days/year×5 years=630,000 price.
   Sentiment data points (daily): Assume 10 sentiment signals per day per stock: 500 stocks×252 trading days/year×10=1,260,000 sentiment data points/year.
   Financial data: Assume each company has quarterly data for 10 fundamental metrics over 5 years: 500 stocks×4 quarters/year×10 metrics×5 years=100,000 fundamental data.

Total data points to analyze manually: 630,000+1,260,000+100,000=1.99 million data points over 5 years. This approach becomes practically impossible to handle with such large datasets, especially when considering portfolio optimization or switching strategies dynamically.

With AI/ML (Dynamic Model Switching)
1. AI Model Overview:
   The AI model processes all available data:
      Sentiment data (e.g., NLP from news/social media).
      Technical indicators (e.g., SMA, MACD, RSI).
      Fundamental data (e.g., earnings, revenue, ROE).
   The AI dynamically adapts the strategy based on real-time analysis of the market. For example:
      In a bull market, the model might give higher weight to sentiment data (positive news driving stocks).
      In a bear market, it might prioritize fundamentals (looking for value stocks with strong balance sheets).
2. Steps in AI-Driven Analysis:
   Automatically fetches data from APIs (stock prices, news, earnings).
   Uses NLP to process real-time sentiment data.
   Automatically adjusts model weights to switch between fundamentals and sentiment-based approaches based on market volatility or other factors.
3. Computation Example (AI-Driven):
   The model can process data for all 15,000 financial instruments in the US market, using historical data (e.g., 10 years), sentiment, and fundamentals.
   Assume the AI is analyzing:
      Price data: 15,000×252×10=37,800,000 price data points.
      Sentiment data (10 signals/day): 15,000×252×10=37,800,000 sentiment data points/year.
      Fundamental data: Assume each company has 10 key financial metrics reported quarterly over 10 years: 15,000×4×10×10=6,000,000 fundamental data points.

Total data points processed by AI over 10 years:

37,800,000(price data)+37,800,000(sentiment data)+6,000,000(fundamental data)=81.6 million data points.

The AI can handle this data in real-time, dynamically adjusting strategies, compared to manual approaches that would take analysts days or even weeks to process and act upon.

The financial instrument selection module 307 then ensures diversification across sectors, industries, and asset classes to minimize risk. Next, based on an optimization criterion, the financial instrument selection module 307 generates a list of selected financial instruments for inclusion in the portfolio. The modules further comprise a portfolio construction module 309 configured to apply multi-objective optimization algorithms to construct the portfolio that balances risk, return, and investor preferences; utilize Modern Portfolio Theory (MPT), Black-Letterman model, reverse optimization, resampled mean-variance optimization, mean-variance optimization, and other non-normal optimization approaches to optimize the constructed portfolio, and output a constructed portfolio with initial asset allocations, optimized for the investor's profile; and optimize the constructed portfolio to optimize the expected return of the constructed portfolio. The constructed portfolio is, for example, an investment portfolio. The construction of a suitable and optimal portfolio is based on the calculation and designation of the Risk Factor the ML had returned. Based on that risk, a portfolio is proposed that lines up a list of stocks that match the risk factor. The stocks themselves are being evaluated every quarter to determine their stability or volatility and therefore, those stocks are assigned to portfolio that match their Risk Factor. It should be noted that the terms risk tolerance and risk factor are used interchangeably throughout this application.

### Reverse Optimization

Reverse optimization is a tool that helps explain the implied returns associated with any portfolio. It can be used to estimate returns for use in a forward-looking optimization. Mean-Variance optimization solves optimal weights based on expected returns, covariances, and a risk aversion coefficient. Based on predetermined inputs, an optimizer solves the optimal asset allocation weights. As the name implies, reverse optimization works in the opposite direction. Reverse optimization takes as its inputs a set of asset allocation weights that are assumed to be optimal and, with the additional inputs of covariances and the risk aversion coefficient, solves for the expected returns. These reverse optimized returns are sometimes referred to as implied or imputed returns.

Reverse optimization begins with observed or implied market portfolio allocations (for example, benchmark indices) and computationally derives the implied returns that would justify such allocations. Instead of starting with subjective expected returns, reverse optimization uses market equilibrium as a foundational assumption to calculate implicit expected returns, ensuring portfolio alignment with market consensus.

| | Observed |
|---|---|
| Asset Class | Market Weights |
| U.S. Equities | 50% |
| International | 25% |
| Equities | |
| Bonds | 25% |

Using ML-driven predictive analytics, the system calculates current implied returns as follows:
It first estimates the covariance matrix (Σ) dynamically using ML-driven volatility forecasting and market correlations.
Then, it computes implied returns (Π) using the reverse optimization equation: Π=λ·Σ·Wₘₐᵣₖₑₜ
Let's assume the ML-driven models predict the covariance matrix (Σ) as follows:

$$( \sum ) = [ \begin{matrix}0.025 & 0.015 & 0.01 \\ 0.015 & 0.022 & 0.0009 \\ 0.01 & 0.0009 & 0.0025\end{matrix} ]$$

Let risk averse (λ)=2.5.
Calculating implied returns explicitly using market weights:

$${W}_{market} = [ \begin{matrix}0.5 \\ 0.25 \\ 0.25\end{matrix} ]$$

$$Then , \prod = 2.5 \cdot [ \begin{matrix}0.0016 & 0.0009 & 0.0006 \\ 0.0009 & 0.0025 & 0.0009 \\ 0.0006 & 0.0009 & 0.0016\end{matrix} ] \cdot [ \begin{matrix}0.5 \\ 0.25 \\ 0.25\end{matrix} ]$$

| | Implied Returns |
|---|---|
| | (After the above |
| Asset Class | calculations) |
| U.S. Equities | 9% |
| International | 5.8% |
| Equities | |
| Bonds | 3.2% |

Instead of assuming returns arbitrarily, implied returns reflect real-time equilibrium, informed by dynamic ML analytics, enhancing portfolio credibility.
Ensures portfolios stay aligned with real-time market consensus, adapting automatically as markets shift.

### Example Scenario:

Consider the system identifies that technology sector allocations in major benchmark ETFs increase significantly. The system's AI-powered reverse optimization module uses real-time neural network models to interpret these changes, instantly recalculating implied market returns. It then combines these inferred returns with ML-derived macroeconomic sentiment signals, dynamically adjusting asset weightings to exploit opportunities not visible through conventional backward-looking methods.

Reverse optimization is enhanced through machine-learning-driven market analytics to uniquely determine implied market returns:
The system analyzes real-time market data, such as ETF allocations or benchmark indices (e.g., S&P 500 sector allocations), employing a neural network to dynamically infer implied expected returns from current asset allocations.
This inferred dataset acts as a baseline, which is further adjusted by machine-learning-enhanced factor models, such as macroeconomic predictors or sentiment analysis, providing additional layers of quantitative refinement.

The technical uniqueness arises from real-time computational methodologies involving neural networks and ML-derived macroeconomic signals to dynamically calculate implied returns. Unlike abstract reverse optimization that purely theorizes implied returns, your invention utilizes technologically specific, predictive analytics, thus transforming abstract financial principles into practical, measurable, and actionable solutions.

### Resampled Mean-Variance Optimization

Resampled mean-variance optimization combines Markowitz's mean-variance optimization framework with Monte Carlo simulation and, all else equal, leads to more-diversified asset allocations. In contrast to reverse optimization, the Black-Litterman model, and constraints, resampled mean-variance optimization is an attempt to build a better optimizer that recognizes that forward-looking inputs are inherently subject to error. Resampling uses Monte Carlo simulation to estimate a large number of potential capital market assumptions for mean-variance optimization and, eventually, for the resampled frontier. Conceptually, resampling is a large-scale sensitivity analysis in which hundreds or perhaps thousands of variations on baseline capital market assumptions lead to an equal number of the mean-variance optimization frontiers based on the Monte Carlo-generated capital market assumptions. Resampled mean-variance optimization is an extension of traditional mean-variance optimization, designed to address estimation errors and improve the robustness of portfolio allocations. It generates multiple simulated asset-return scenarios (resamples), averages these scenarios, and computes portfolio weights that mitigate the sensitivity to input uncertainty.

### Example Scenario:

For example, the generative AI models might detect emerging volatility patterns, economic regime shifts, or even sentiment-driven market anomalies. Based on these conditions, the models generate customized, condition-specific return scenarios. The system then rapidly synthesizes these AI-generated scenarios, enabling optimal portfolio allocation adjustments, particularly useful during periods of increased uncertainty, market regime shifts, or crises.

Assume the system creates 1,000 realistic asset-return scenarios based on the generative AI and ML models. Sample simulated returns from ML-generated scenarios:

| Asset Class | Scenario 1 | Scenario 2 | Scenario 3 | . . . Scenario N |
|---|---|---|---|---|
| US Equities | 8% | 10% | −3% | . . . |
| International | 5% | 12% | −4% | . . . |
| Equites | | | | |
| Bonds | 2% | 5% | 4% | . . . |

The system runs mean-variance optimization on each AI-generated scenario and averages resulting asset weights to arrive at robust, resampled optimal portfolio weights:

| | Average Weight |
|---|---|
| Asset Class | after Resampling |
| US Equities | 42% |
| International | 18% |
| Equites | |
| Bonds | 35% |
| Commodities | 5% |

The system uniquely enhances resampled optimization through AI-generated adaptive simulation scenarios:
The software utilizes generative AI models (e.g., GANs or Variational Autoencoders) trained on historical data and predictive indicators to create realistic asset-return scenarios reflective of current market conditions.
Thousands of AI-generated scenarios are processed rapidly by computational optimization engines, deriving stable, robust portfolio weights less sensitive to traditional data-estimation errors.
Resampling avoids instability from traditional optimization by integrating ML-generated scenarios that closely mimic real market patterns.
It offers stable optimization results in dynamic, uncertain markets.

Technological innovation lies in integrating AI-generated adaptive return scenarios rather than traditional random resampling. The explicit use of sophisticated generative AI models combined with computationally intensive, real-time optimization engines transforms the abstract concept of “resampled optimization” into a tangible, technology-dependent, and demonstrably improved computational process.

### Non-Normal Optimization Approaches

Non-normal optimization approaches explicitly incorporate skewness, kurtosis, tail risk, and other non-normal statistical characteristics into portfolio allocation decisions. Unlike classical approaches assuming returns follow a normal distribution, non-normal optimization recognizes market returns' inherent complexities and asymmetries, providing more robust portfolios in practice.

### Example Scenario:

For instance, if ML models predict increased negative skewness and heightened tail risk in certain asset classes, the system will automatically recalibrate optimization criteria. The software systematically reduces exposure to assets with unfavorable skewness and tail risk profiles, reallocating capital toward assets predicted to exhibit more favorable non-normal risk attributes.

The System uses ML predictive analytics explicitly to forecast non-normal characteristics such as skewness and kurtosis. Assume your ML models predict the following statistical attributes for three asset classes:

| | Mean | | Skewness (ML | Kurtosis (ML |
|---|---|---|---|---|
| Asset Class | Return | Volatility | Predicted) | Predicted) |
| Equities | 9% | 12% | −0.7 | 4.5 |
| Bonds | 4% | 3% | 0.2 | 3.1 |
| Commodity | 15% | 40% | 2.5 | 8.7 |

Using a non-normal optimization model (e.g., Cornish-Fisher Expansion or advanced convex optimization methods integrated with ML predictions), the software explicitly optimizes portfolios considering skewness/kurtosis. For example, the software might reduce allocations to assets with negative skewness (higher downside risk) or excessive kurtosis (fat tails).

Optimized Asset Weights after considering non-normal ML-driven statistics:

| | Optimal |
|---|---|
| Asset Class | Weight |
| Equities | 45% |
| Bonds | 40% |
| Commodity | 5% |

The software integrates a unique ML-driven non-linear predictive modeling approach for explicitly handling non-normal statistical characteristics of asset returns:
The software employs advanced ML algorithms, such as ensemble methods (XGBoost, Random Forests) and deep learning (CNN or Transformer models), to explicitly forecast distributions of returns, including skewness and fat tails.
This ML-derived predictive distribution is incorporated into computationally sophisticated optimization algorithms (such as stochastic optimization or advanced convex/non-convex optimization techniques), dynamically adjusting asset weights in response to predicted tail risks or asymmetric market events.
Assets with high positive skewness but excessive kurtosis (e.g. commodity) are considered due to high tail risk despite potential returns.
Balanced assets (bonds) gain more weight due to favorable non-normal characteristics.

The uniqueness is explicitly technical: advanced ML predictive analytics are coupled directly with computationally intensive non-linear optimization algorithms. By employing ML algorithms to quantify complex non-normal characteristics systematically and by dynamically adapting computational optimization, the invention transforms an abstract financial concept into a clearly defined technical solution significantly improving investment decision-making.

The automated portfolio optimization software uniquely incorporates:
ML-powered real-time inference of implied returns (Reverse Optimization).
AI-generated predictive scenarios improving computational robustness (Resampled Mean-Variance Optimization).
Explicit ML-driven prediction of complex statistical features such as skewness and kurtosis, dynamically integrated with optimization processes (Non-Normal Optimization).

These implementations explicitly depend on computational processes involving predictive analytics, machine learning, AI-generated scenarios, and computational optimization, ensuring they represent tangible, technologically significant, and patent-eligible contributions.

Next, the portfolio is constructed by the portfolio construction module 309 using the processor shown in FIG. 3. FIGS. 5D and 14D illustrate the portfolio creation process. To construct the portfolio, the existing or proposed portfolio is matched to risk score, as shown below:
High-risk investors (76%-100%): These portfolios are designed with fewer constraints and a higher allocation to volatile assets such as equities, commodities, or others. They focus on maximum growth and accept significant short-term volatility.
Moderate-risk investors (26%-75%): These portfolios balance growth and risk, with a blend of equities, bonds, and other less volatile assets. They aim to provide steady returns while managing risk through diversification.
Low-risk investors (1%-25%): Portfolios for these investors focus on capital preservation, with allocations to bonds, cash equivalents, or low-volatility sectors. These portfolios are designed to generate stable returns with minimum risk and volatility.

As illustrated in FIG. 5D, in the first step, the portfolio is determined based on the investor's calculated risk score. In the next step, the asset allocation is tailored to match the risk score. For a low risk score, a conservative allocation, focused on bonds and low-volatility assets is performed. For a moderate risk score, balanced allocation, including a mix of bonds and equities is performed. For a growth-oriented risk score, higher equity allocation, focused on growth assets is performed. For an aggressive risk score, a maximized risk exposure, focusing on volatile and high-return investments is performed.

The modules further comprise a portfolio optimization module configured to continuously refine and optimize the portfolio using advanced algorithms to maximize risk-adjusted returns; integrate AI-driven optimization techniques that adapt dynamically to the changing market condition and changing investor profiles; and output an optimized portfolio with updated allocations to achieve a superior performance. In an embodiment, the term “dynamically adapt” refers to the fact that the ML (or AI) model will have a feedback loop to review the results predicted vs the reality of the market. The AI Model is fed current data on a daily basis and be able to read its previous prediction and better adapt its next answer based on current condition. The AI/ML model is designed to dynamically adapt through a feedback loop, where it compares its previous predictions to the actual market outcome and continuously improves its predictions by learning from daily incoming data. This process ensures that the AI model becomes more accurate and relevant over time. The feedback loop allows the AI to adjust its strategy based on the difference between its previous predictions and the real market behavior. This enables the model to refine its predictions for the next day, week, month, or year.

### Scenario:

The AI model is tasked with predicting the direction of the S&P 500 (up or down) for the next day. The model's prediction is based on a combinations comprising of fundamental analysis, sentiment analysis, technical indicators, macroeconomic factors, and historical patterns.

### Day 1: Initial Prediction

The AI model processes the data available at the end of Day 0 (yesterday's data).
Based on the current sentiment analysis, technical indicators (e.g., RSI, MACD), macroeconomic factors, and historical market patterns, the model predicts that the S&P 500 will increase the next day.

### AI Prediction for Day 1:

Prediction: S&P 500 will increase.
Actual Market Outcome: The S&P 500 decreases by 0.5%.

### Feedback Loop: Day 1 to Day 2

At the end of Day 1, the AI compares its prediction to the actual market outcome. Since its prediction (increase) did not match the real result (decrease), the model initiates the feedback loop.

### Feedback Process:

1. Error Calculation:
   The AI quantifies the error by comparing the predicted movement (positive) with the actual movement (negative).
   For this example, let's say the model assigns an error score of 0.5 due to the 0.5% difference in the market.
2. Adjustment in Model Weights:
   Based on the error, the AI model adjusts the weights assigned to the input features that contributed to the incorrect prediction.
   For instance, the model might reduce the weight of sentiment analysis slightly if it gave too much weight to positive sentiment while ignoring technical signals that were indicating bearish movement.
3. Daily Data Feed:
   The AI is fed new market data from Day 1 (e.g., updated sentiment data, price movements, volatility).
   This new data allows the AI to adapt its model and retrain itself using real-time inputs to generate a more accurate prediction for the next day.

### Day 2: Adapted Prediction.

After processing the feedback loop from Day 1, the AI makes a new prediction for Day 2 based on the adjusted model.
The AI now considers the market's negative behavior from Day 1, reduces the weight of over-optimistic sentiment data, and increases the weight of more accurate technical indicators (e.g., MACD, RSI).

### AI Prediction for Day 2:

Prediction: S&P 500 will decrease.
Actual Market Outcome: The S&P 500 decreases by 1%.

### Feedback Loop: Day 2 to Day 3

At the end of Day 2, the AI compares its prediction (decrease) to the actual market outcome (decrease). Since the prediction was correct, the model reinforces the weights it used to make this prediction, increasing the influence of the inputs that contributed to the correct forecast.

### Feedback Process for Day 2:

1. Error Calculation:
   Since the prediction was correct, the AI assigns a low error score (e.g., 0.1 due to a slight difference in the magnitude of the market drop).
2. Adjustment in Model Weights:
   The AI reinforces the features that led to the correct prediction (e.g., it increases the weight of technical indicators like MACD and decreases the reliance on less significant inputs).
3. Daily Data Feed:
   The AI is fed new market data from Day 2 (e.g., updated sentiment, market prices, trading volumes).
   The model continues to learn from this data and recalibrates its prediction process to stay aligned with evolving market conditions.

### Summary of Dynamic Adaptation: Days 1-3

| | | Actual Market | Error | Feedback |
|---|---|---|---|---|
| Day | AI Prediction | Outcome | Score | Loop Action |
| Day 1 | S&P 500 | S&P 500 | 0.5 | Reduce weight of |
| | will increase | decreases 0.5% | | sentiment data, |
| | | | | increase weight |
| | | | | of technical |
| | | | | indicators |
| Day 2 | S&P 500 | S&P 500 | 0.1 | Reinforce |
| | will decrease | decreases 1% | | technical |
| | | | | indicators, |
| | | | | fine-tune |
| | | | | other inputs |
| Day 3 | Predicts based on | | | |
| | an updated model | | | |
| | with better | | | |
| | adaptation. | | | |

### Numerical Example of Model Weight Adjustment

### Initial Model Weights (Day 1):

Sentiment Analysis: 0.4
Technical Indicators (RSI, MACD): 0.3
Historical Market Patterns: 0.3
After Day 1's incorrect prediction, the feedback loop adjusts the weights:
Adjusted Weights (Day 2):
   Sentiment Analysis: 0.35 (reduced)
   Technical Indicators (RSI, MACD): 0.4 (increased)
   Historical Market Patterns: 0.25 (slightly reduced)
After Day 2's correct prediction, the model reinforces these adjustments:
Reinforced Weights (Day 3):
   Sentiment Analysis: 0.35 (maintained)
   Technical Indicators (RSI, MACD): 0.45 (further increased)
   Historical Market Patterns: 0.2 (decreased slightly)
      Summary of Dynamic Adaptation with AI/ML
1. Daily Learning: The AI is fed new data daily, enabling it to learn from both correct and incorrect predictions. Each day, it compares its predictions to the actual market outcome and adjusts its internal model through the feedback loop.
2. Error Correction: If the AI makes an incorrect prediction, it identifies the sources of error (e.g., too much reliance on sentiment, not enough focus on technical indicators) and corrects them by adjusting the weights of each factor.
3. Continuous Improvement: Over time, the AI adapts better to market conditions, increasing the accuracy of its predictions. This dynamic adaptation helps the AI stay relevant and accurate in an ever-changing market environment, where no single strategy works permanently.
4. Real-Time Data Processing: The model continuously processes real-time data and learns from historical patterns, making it robust against market volatility and unforeseen events.

The AI/ML dynamic adaptation process allows the model to continuously improve by comparing its predictions to actual outcomes and recalibrating itself daily. The feedback loop ensures that the model becomes more accurate over time, helping it to anticipate market movements more effectively and provide better investment recommendations based on real-time data and market conditions. This is significantly more efficient than a static model or manual prediction process, where updates happen much more slowly or not at all.

### Adjustment of Portfolio Constraints:

For higher risk scores, the portfolios include fewer constraints on asset selection, allowing for a wider range of investment options. On the contrary, for lower risk scores, there are more constraints to protect the investor's capital, limiting exposure to volatile assets and focusing on stable, low-risk investments.

### Flexibility and Dynamic Adjustments

Investors can update their risk preferences at any time by retaking the questionnaire. The system 300 dynamically recalculates the risk score and adjusts the portfolio accordingly to reflect new preferences or circumstances. Furthermore, the system 200 provides flexibility to the investors by allowing real-time portfolio rebalancing. As market conditions change or the investor's risk tolerance shifts, portfolios are rebalanced to maintain alignment with the risk profile. Next, a portfolio optimization module 311, using the processor, shown in FIG. 3, optimizes the portfolio to produce an optimized expected return. FIG. 5E illustrates the dynamic adjustment process. The portfolio is created based on the initial risk score calculated during onboarding. Any changes in investor preferences or risk tolerance can trigger an update to the portfolio. Shifts in market conditions are continuously monitored. Based on either investor updates or market conditions, the portfolio is rebalanced to align with the new scenario. The adjusted portfolio reflects the latest conditions and investor preferences.

Furthermore, for institutional investor additional factors/criteria are available for consideration. Such criteria/factors comprise Assets Under Management (AUM), long-term liabilities (e.g., pension obligations), and specific regulatory frameworks. Furthermore, institutional investors may be allowed to follow specific frameworks like Modem Portfolio Theory, ESG Investing, or Factor Investing to guide asset allocation and risk management. Furthermore, institutional investors may have custom risk scoring adjustments available to them which provide custom risk scoring systems tailored to their strategic objectives, including more complex scenario analysis or actuarial models.

FIG. 5F illustrates the process of applying considerations for institutional investors.
Assets Under Management (AUM): Institutional investors manage significant capital, influencing their investment strategy.
Regulatory Requirements: Institutions must comply with financial regulations, which impact their investment options.
Investment Objectives: Institutional investors may focus on long-term goals (e.g., pension funds) or short-term gains.
Institutional Risk Scoring: Institutions often use custom risk scoring systems that differ from individual investors.
Portfolio Creation. Based on AUM, compliance, and objectives, institutional portfolios are tailored to meet strategic goals.

As shown in FIG. 5F, the process of applying considerations for institutional investors comprises simultaneously considering Assets Under Management (AUM), evaluating Regulatory Requirements and incorporating Investment Objectives while risk scoring of institutional investors. In the next step, a tailor-made portfolio is created to meet the strategic goals of the institutional investor.

Furthermore, risk monitoring and reporting is available for investors. The system 300 performs ongoing risk assessment. The portfolios are continuously monitored for risk exposure by the risk management and evaluation module 312, with reports generated to ensure investors are always aware of potential risks and portfolio performance. The system 300 provides risk mitigation strategies. The system 300 incorporates various mechanisms comprising of VaR, stress testing, scenario analysis, stop-loss, diversification strategies, and hedging tools to mitigate risks associated with aggressive portfolios.

FIG. 5G illustrates the risk monitoring and reporting process. In the first step, portfolio performance and market conditions are monitored in real-time to conduct an ongoing risk assessment. Next, periodic risk reports are generated to assess the portfolio's exposure to risk. The portfolio's risk is evaluated to determine if it exceeds the investor's risk tolerance. If the risk exceeds tolerance levels, adjustments are made to reduce exposure. Next, investors are updated on the risk status and any portfolio adjustments.

FIG. 5J illustrates a table showing a calculation of Expected Return (end result).

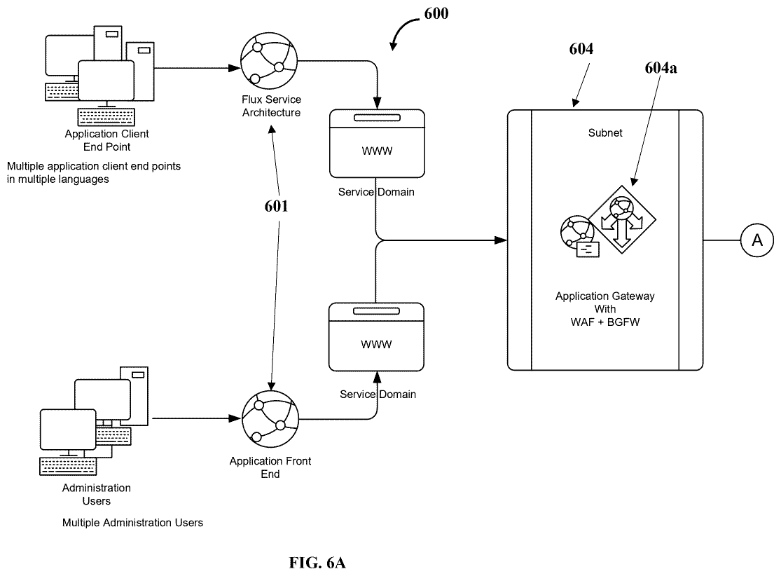

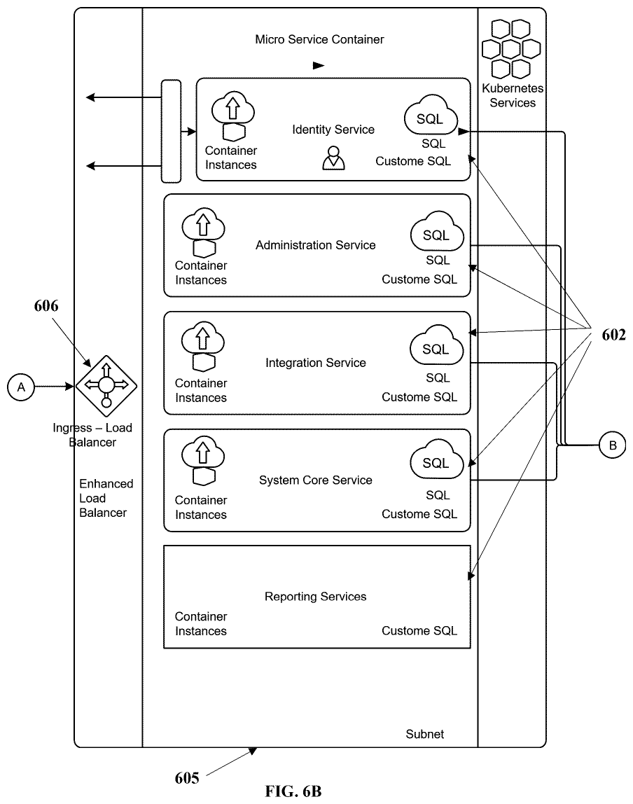

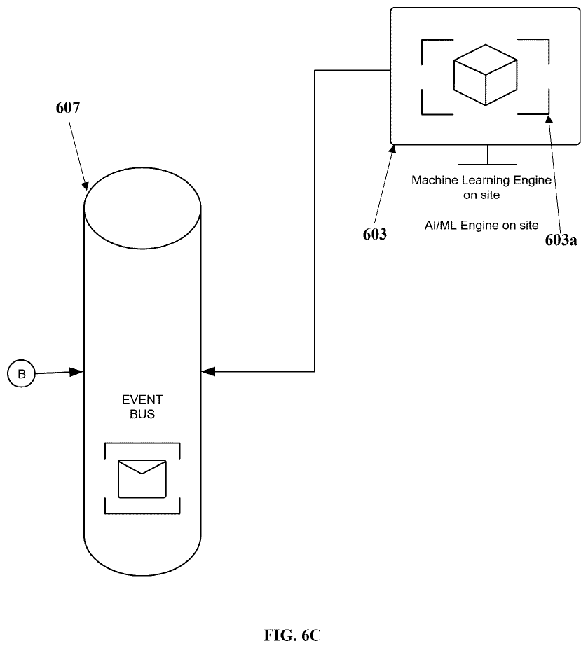

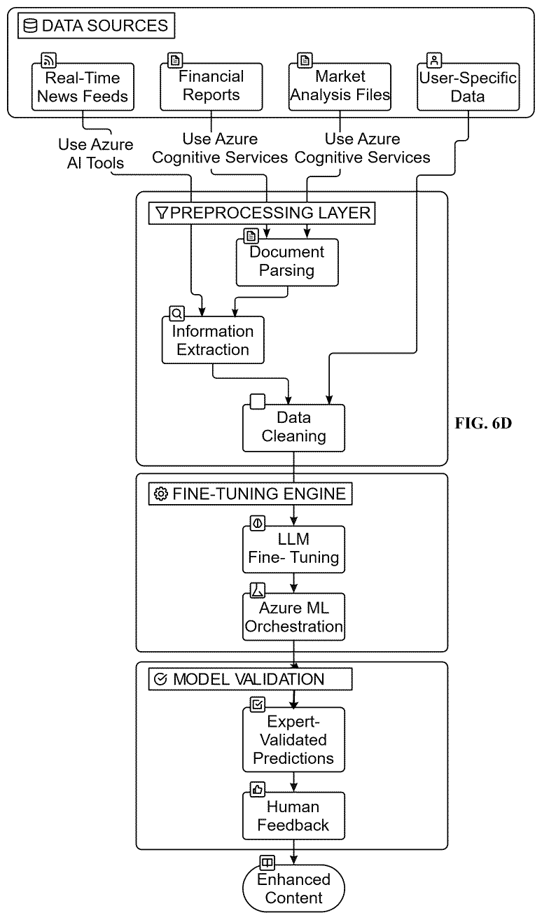

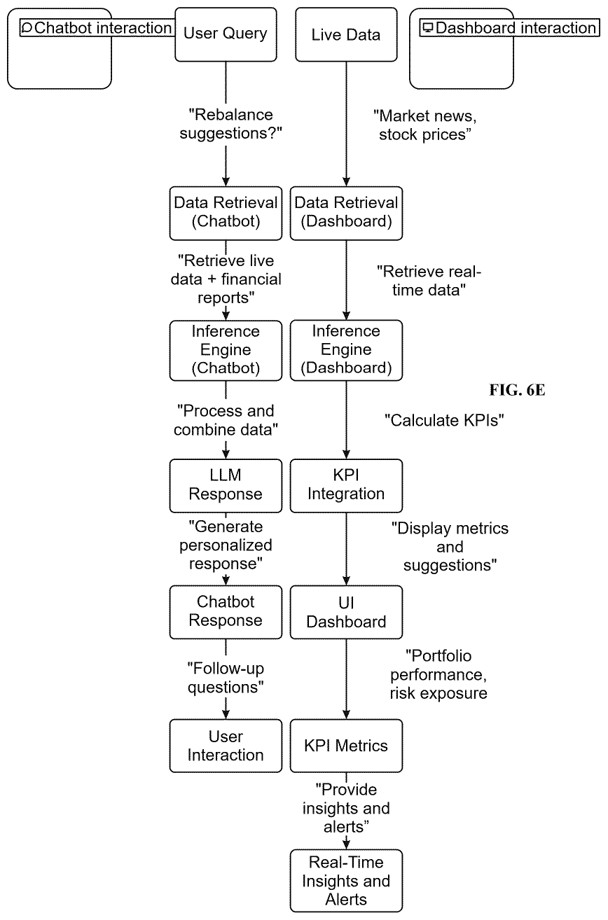

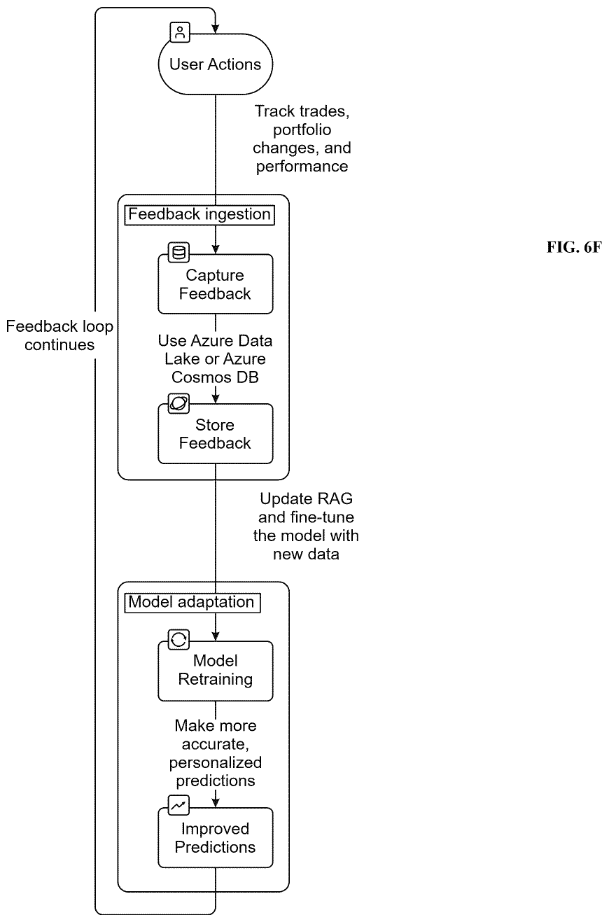

FIGS. 6A-6C illustrates an architecture overview for the portfolio construction module 309, shown in FIG. 3. The portfolio construction module 309 is, for example, an Artificial Intelligence (AI)-based portfolio construction module 309. In an embodiment, the portfolio construction module 309 is implemented on an artificial-intelligence (AI) powered portfolio construction system 600. The artificial-intelligence (AI) powered portfolio construction system 600 is, for example, a cloud-based AI-powered portfolio construction system, consisting of multiple web applications 601, microservices 602, and machine learning components 603 designed for managing and optimizing portfolios in a scalable and secure environment, as shown in FIGS. 6A-6C.

The AI powered portfolio construction system 600 utilizes two web applications 601 that interface with a central application gateway 604a deployed on a cloud infrastructure 604. The AI powered portfolio construction system 600 comprises a first cloud server (not shown) comprising at least one processor (not shown) coupled to a memory (not shown). The first cloud server comprises the central application gateway 604a. The application gateway 604a is equipped with a Web Application Firewall (WAF), as shown in FIG. 6A. to provide protection against security threats, ensuring secure communication between external users and internal services 602.

The AI powered portfolio construction system 600 further comprises a second cloud server (not shown) comprising at least one processor (not shown) coupled to a memory (not shown). The second cloud server (not shown) comprises a container orchestration system 605 for orchestrating a plurality of microservices 602. The core of the AI powered portfolio construction system resides 600 within a cloud-based Kubernetes subnet 605 where the microservices 602 are orchestrated. Each microservice 602 is designed to handle specific functionalities, including:
Identity Microservice: Handles authentication and authorization for users.
Administration Microservice: Enables system administrators to manage rules, portfolio size, and configurations related to portfolio management.
Integration Microservice: Facilitates integration with external systems, such as payment services or trading partners.
System Core Service: Centralizes and processes business logic, including the execution of portfolio construction rules and portfolio management algorithms.
Reporting Service: provides detailed performance reports by comparing portfolio returns to benchmarks and industry standards, and provide insights and analysis on portfolio performance.

The second cloud server (not shown) further comprises an ingress load balancer 606. The ingress load balancer 606 follows the central application gateway 604a to distribute traffic efficiently across the microservices 602.

The AI powered portfolio construction system 600 further comprises an event bus 607 for facilitating communication to and from the microservices 602. The microservices 602 communicate via the Event Bus 607, which serves as a central message broker, ensuring smooth and asynchronous interaction between different services 602. This architecture facilitates decoupling and allows microservices 602 to operate independently while maintaining consistency in data flow.

The AI powered portfolio construction system 600 further comprises multiple databases (not shown). Each microservice 602 maintains its own independent database (not shown) out of the multiple databases (not shown), adhering to a decentralized data management approach. This ensures scalability and fault tolerance by isolating data operations within the microservices 602.

The AI powered portfolio construction system 600 further comprises an on-site Virtual Machine (VM) hosted on a computer system 603 comprising at least one processor (not shown) and memory (not shown). Outside the cloud-based infrastructure, the on-site Virtual Machine (VM) is utilized to run a Machine Learning (ML) Virtual Machine 603a, where the AI model for portfolio optimization is trained. Furthermore, the AI model requires a dedicated database (not shown) for storing training data, model parameters, and other relevant data points essential for improving the AI portfolio engine's 603a performance over time.

The AI model leverages advanced machine learning techniques to analyze market data, portfolio performance, and other financial metrics to generate optimized portfolio recommendations. The integration of the AI engine 603a with the System Core Service enables real-time updates and dynamic portfolio adjustments based on the continuously trained AI model.

The AI-powered portfolio construction system 600/platform shown in FIGS. 6A-6C is designed to assist investors in making data-driven decisions by analyzing stock market trends, portfolio performance, and other key financial metrics. The solution focuses on leveraging artificial intelligence to provide real-time insights and optimized portfolio recommendations. The platform will integrate three major data sources: users' portfolio data, external market data, and live news/articles feeds. In an embodiment, the AI-powered architecture/platform may utilize Azure-based infrastructure integrated with OpenAI and custom AI models to provide personalized recommendations, predictions, and feedback loops for continuous improvement. As used herein, Azure is Microsoft Corporation's public cloud computing platform. Microsoft Corporation is an American multinational corporation and technology conglomerate headquartered in Redmond, Washington. OpenAI, Inc. is an American artificial intelligence (AI) research organization founded in December 2015 and headquartered in San Francisco, California.

Key Components of the AI-powered portfolio construction system 600/platform:
Portfolio Data Integration:
   Description: Portfolio data integration will be the core foundation of the platform, aggregating users' financial assets and personal preferences to provide personalized investment recommendations. The platform will collect data from various sources, including stocks, ETFs, bonds, and other investment vehicles, along with the user's preferences and risk tolerance. This will allow the AI system to tailor portfolio strategies that align with the user's investment objectives, risk appetite, and personal preferences.
   Use Case: By analyzing
   1. Portfolio Assets:
      Stocks, ETFs, Bonds: Information about the user's current investments and holdings will be aggregated in real-time.
      Historical Performance: The system will track the performance history of these assets, analyzing past trends and returns.
   2. User Preferences:
      Investment Strategy:
         Growth-Oriented: Focuses on aggressive capital appreciation with higher volatility.
         Income-Oriented: Prioritizes steady income streams (e.g., dividends, bonds) with lower risk.
         Balanced: A mix of both growth and income strategies.
      Asset Allocation Preferences:
         Preferred asset categories (e.g., equity-heavy, fixed-income focus).
         Geographic preferences (domestic vs. international markets).
         Sectoral focus (technology, healthcare, etc.).
      3. Risk Tolerance:
         Low Risk: Focus on conservative investments with steady but low returns.
         Medium Risk: A balanced approach with moderate exposure to volatility.
         High Risk: Higher volatility and return potential, with exposure to more speculative assets.
      4. Time Horizon:
         Short-Term: Looking to liquidate assets within 1-3 years.
         Medium-Term: A 3-7-year horizon, suitable for mid-term goals.
         Long-Term: Investments intended to grow over 10+ years for retirement or other long-term goals.
      5. Liquidity Needs:
         High Liquidity: Investments that can be quickly converted to cash.
         Moderate Liquidity: Investments with some lock-in periods or restrictions.
         Low Liquidity: Long-term assets that are harder to sell without significant price impact.
      6. Ethical and ESG Considerations:
         Does the user have preferences for Environmental, Social, and Governance (ESG) investments?
         Sustainability Preferences: Focus on green energy or socially responsible investment.
   Market Data & News Analysis:
      Description: A critical data source is external market data, including live prices, economic indicators, expert analyses, and news articles. These data sources will be continuously ingested into the platform.
      Use Case: The system will analyze news in formats such as PDFs, web scraping, and APIs from financial news outlets to determine sentiment and trends. For example, sudden negative news around a stock can trigger a warning to the investor to reconsider their holdings.
   Real-Time Mode (Live Mode):
      Description: The platform will offer a real-time analysis dashboard that visualizes key performance indicators (KPIs) such as price movements, portfolio performance, and market trends. It will also suggest possible actions based on current data.
      Use Case: Users can monitor live market changes and access key graphs, heatmaps, and other visual aids to better understand how news or data may affect their investments.

### Problem Statement:

Diverse Asset Classes and User Preferences:
   Each user's portfolio can involve different asset classes (stocks, bonds, ETFs, cryptocurrencies, etc.), which require specific insights and strategies.
   Users have distinct risk profiles, investment strategies, and preferences, meaning one model cannot serve all without extensive feature engineering.
   The financial data ecosystem involves multiple data formats (e.g., PDFs, CSVs, real-time data feeds, news articles) that need to be parsed, understood, and integrated into decision-making.
Challenges with Traditional Machine Learning Approaches:
   Generalization Issues: Training a one-size-fits-all machine learning model is inefficient. The model would need to generalize across varying asset types, historical market conditions, and user preferences, making it prone to inaccuracies.
   Per-User Model Training Complexity: Building custom models per user would require substantial manual feature engineering, as each user's portfolio requires unique data inputs and analysis parameters. This approach would also suffer from scalability issues, as each new user would demand retraining, leading to increased resource usage and delays.
   Handling Varied Data Sources: The need to manage and process multiple data formats (e.g., financial reports, stock prices, and live market news) in real time is beyond traditional ML's capabilities, especially without advanced preprocessing.
Scalability and Real-Time Adaptation Challenges:
   Complexity in Scaling: It becomes difficult to scale traditional ML methods for multiple users without compromising performance. Each portfolio's uniqueness increases the complexity of feature extraction and model retraining.
   Real-Time Decision Making: Traditional models often require a predefined set of features that limit their ability to adapt quickly to new data, especially in fast-moving financial markets where real-time insights are crucial for effective decision-making.

Solution: Leveraging LLM Fine-Tuning and Retrieval-Augmented Generation (RAG)
Why LLMs (Large Language Models) are Optimal:
   Broad Understanding of Diverse Data Types: LLMs, such as those fine-tuned for financial knowledge, can understand and process varied inputs without requiring extensive feature engineering. They can handle structured data (like stock prices) and unstructured data (news articles, PDFs, financial reports) effortlessly, making them more flexible than traditional ML models.
   Real-Time Data Ingestion and Analysis: LLMs can be fine-tuned to analyze real-time data from multiple sources—market trends, stock prices, and even live news articles—based on each user's preferences. This allows for instant portfolio recommendations and insights.
   Scalability Across Users and Assets: By fine-tuning an LLM with financial-specific data and using RAG, the model can adapt to each user's portfolio without the need for individual models. It processes each user's data dynamically and provides tailored recommendations, enabling scalability without complex retraining for every new user.
Retrieval-Augmented Generation (RAG) as a Core Strategy:
   Dynamic Information Retrieval: Instead of relying on static model predictions, RAG allows the system to retrieve the most relevant data in real time based on the user's current needs. This could be stock price movements, recent news, or even specific market reports.
   Combining Real-Time Knowledge with LLM Power: With RAG, the model can pull in live market data and knowledge base insights (such as newly uploaded financial reports or external news sources). It enriches the recommendations by combining pre-trained knowledge with real-time retrieval of relevant financial information.
   Real-Time Portfolio Analysis: The LLM can analyze these retrieved pieces of information and generate personalized portfolio adjustments or suggestions. This means the system is not bound to a static dataset but can update recommendations dynamically based on fresh market inputs.
Flexibility in Handling Varied Data Sources:
   User Portfolio Data (Database): LLMs can interpret structured data such as portfolio holdings, transaction history, and risk profiles. These can be fed into the LLM in a way that aligns with the user's financial goals (e.g., long-term growth vs. short-term trading).
   Market Analysis (Uploaded Files to Knowledge Base): Documents uploaded to the system can be ingested using Azure Cognitive Search or other OCR techniques. LLMs can then retrieve and analyze these files dynamically as they evolve over time, giving users more contextually relevant recommendations.
   Live Data (Web Scraper): The LLM can handle real-time news scraping and financial API data based on the user's interests. For instance, a user tracking energy stocks will get the latest news and sentiment analysis on this sector, which will be included in portfolio suggestions.
Real-Time Inference and Feedback Loop:
   Continuous Learning: By leveraging user feedback and real-time portfolio changes, LLMs can improve over time through active fine-tuning. The system records user actions (e.g., buy/sell decisions) and market conditions, using this data to refine recommendations.
   Automated Adaptation to User Preferences: The LLM does not need manual adjustments to user portfolios; it automatically adapts based on investment strategy, risk tolerance, and preferences. The model's ability to understand natural language and structured data in real time ensures that user-specific insights are continually updated.

Proposed Architecture with LLM Fine-Tuning and RAG. FIG. 6D illustrates training/fine-tuning with financial data.

Training (Fine-Tuning with Financial Data):
Data Sources:
   Financial reports, market analysis files, and real-time news feeds.
   User-specific portfolio data, transaction history, and preferences.
Fine-Tuning Process:
   Use Azure ML and OpenAI fine-tuning capabilities to customize a pre-trained LLM model with financial knowledge.
   Integrate knowledge from financial documents and live data to enhance the LLM's understanding of market events and portfolio dynamics
      Inference (Real-Time Processing with RAG):

FIG. 6E illustrates Real-Time Processing with RAG (Chatbot and Dashboard interaction).
The RAG Framework dynamically retrieves relevant data from external live sources and a user-specific knowledge base (financial reports, portfolio data). This data is fed into the LLM, which generates insights and personalized suggestions for the user's portfolio.
Two interaction pathways are provided: one via a Chatbot that offers conversational, personalized insights and another via a Dashboard that displays key portfolio metrics and investment recommendations.

Feedback Loop (Adaptive Learning). FIG. 6F illustrates an adaptive learning feedback loop.
User Feedback: Track decisions and market performance post-suggestion.
Model Retraining: The system uses feedback to refine LLM, continually improving the accuracy of predictions and insights.

### Key Benefits:

1. Scalability Without Retraining for Every User: Fine-tuning an LLM ensures the system scales effectively, as it leverages broad financial knowledge while offering personalized, dynamic insights for each user.
2. Dynamic Adaptation via RAG: By retrieving fresh data (news, market trends), the system stays up to date with the financial landscape, allowing for real-time recommendations tailored to each user.
3. Ease of Handling Diverse Data Formats: The LLM's ability to process structured (user portfolio data) and unstructured (financial reports, market news) inputs eliminates the need for manual feature engineering, enhancing efficiency.

### Technology Stack:

### Cloud Platform:

Azure: Ensures scalability, security, and seamless integration for various components (compute, data, AI services).

### AI Models:

OpenAI API (Azure OpenAI Service):
   LLM Fine-Tuning: Utilize pre-trained LLMs (like GPT-4) for real-time analysis and personalized portfolio recommendations.
   RAG Framework: Implement a Retrieval-Augmented Generation pipeline to fetch real-time market data, news, and portfolio-specific knowledge from knowledge bases (KB) and external sources.
   Text Summarization & NLP: Summarize live news articles and financial reports for portfolio impact analysis using OpenAI's language models.
Azure Cognitive Search:
   Integrated into the RAG pipeline for real-time data retrieval from structured databases and unstructured sources (news articles, reports).
   Acts as a knowledge base (KB) for user-specific financial data and preferences.
Azure ML (Optional for Custom AI Models):
   For advanced financial forecasting and historical data analysis (e.g., portfolio performance modeling).

### Database & Storage:

Azure SQL Database: For structured data storage such as user portfolio information, transaction history, and financial performance metrics.
Azure Blob Storage:
   For unstructured data storage, including uploaded financial documents (PDFs, reports) and retrieved news articles.
   Integration with RAG to store and query large volumes of text data.

### Front-End & Visualization:

Web App:
   Provides an intuitive user interface for interaction with both the chatbot and dashboard.
   Delivers real-time portfolio analysis and insights through RAG-generated content and LLM responses.
   Displays LLM-driven insights and personalized investment strategies.
   Includes the Chatbot for interactive experiences

### Live Data Ingestion:

Web Scrapers & APIs:
   Integrated into the RAG framework to fetch real-time stock prices, market news, and financial updates based on user preferences.
   APIs from sources like Yahoo Finance or Bloomberg for real-time data.

### Security:

Azure Security Center:
   Provides encryption, user authentication, and role-based access control (RBAC) to secure user data.
   Ensures secure handling of financial data, sensitive portfolio details, and user-specific preferences.
Azure Key Vault:
   Manages sensitive credentials and API keys securely.
Authentication & Access Control:
   Azure Active Directory (AAD) for managing user authentication and ensuring data access is role-based.

The proposed AI-based platform offers a comprehensive solution for stock market analysis and portfolio management, enabling investors to make well-informed decisions based on real-time data, market sentiment analysis, and personalized recommendations. The continuous feedback loop ensures that the system becomes more accurate and efficient over time, leading to more optimized portfolio management strategies. This solution will leverage the power of Azure and OpenAI technologies to create a scalable, secure, and highly functional platform, providing users with real-time insights and tailored investment advice.

The portfolio construction module 309, for example the AI based portfolio construction module further comprises expandable Customized AI-based LLM Cloud Infrastructure. A personal AI-LLM cloud model is a system that hosts AI in private cloud settings that are customized to each user's demands and data while maintaining privacy. This model, unlike conventional AI systems, focuses on personalized interactions. By using the user's data and preferences to train the model, more relevant responses are produced. Scalability, distributed processing, and remote access are made possible by the cloud architecture, guaranteeing that users can communicate with their personal AI on several devices. It promises improvements in automation, decision-making, and personal assistants. A Personal AI LLM (Large Language Model) cloud model leverages the power of personalized, large-scale AI models hosted on private or hybrid cloud infrastructures. The Personal AI LLM model may be implemented by a personalized AI LLM module 320, shown in FIG. 3. The Personal AI LLM cloud model allows personalization since the AI is trained on user-specific data-emails, notes, documents-allowing for highly tailored interactions and responses. The Personal AI LLM cloud model allows cloud integration since Personal AI models are hosted in cloud environments, enabling secure, scalable access across devices and locations. The Personal AI LLM cloud model provides privacy by ensuring that data remains secure within the user-controlled cloud, personal AI avoids data-sharing concerns inherent in publicly available AI systems. The Personal AI LLM cloud model allows customization since users can fine-tune the model's behavior, setting preferences for how their AI operates and interacts with different applications or data sources. Furthermore, the Personal AI LLM cloud model can continuously learn since personal AI models can update and refine their understanding based on real-time interactions and new data input, leading to more context-aware outputs.

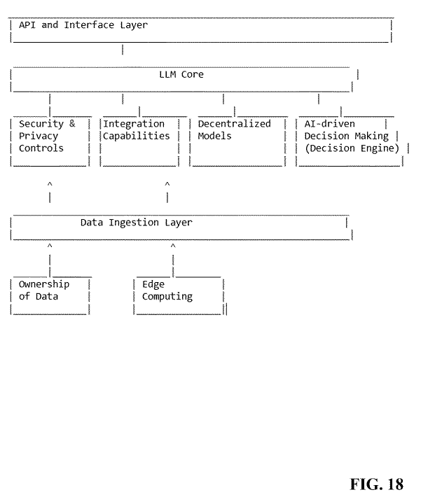

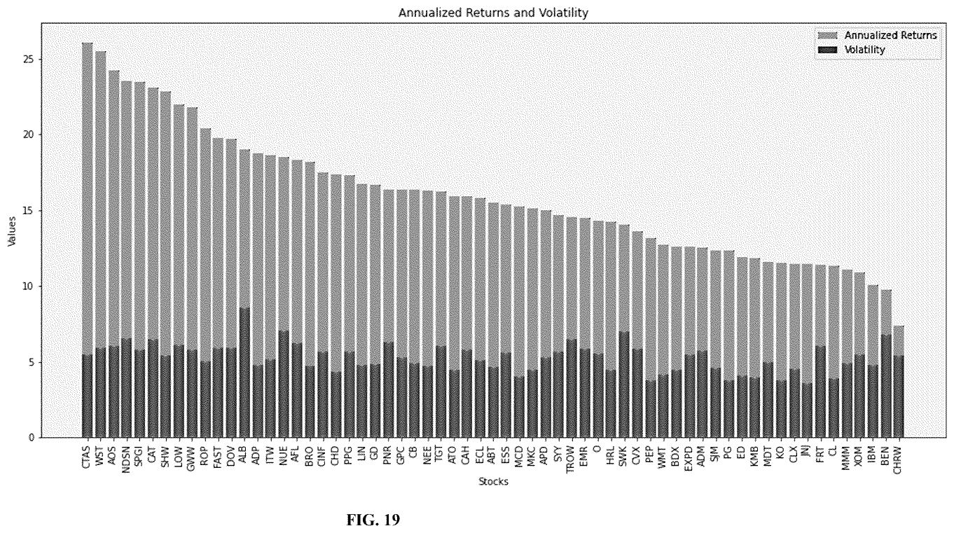

FIG. 18 illustrates key components of personal AI LLM cloud architecture. The key components of personal AI LLM cloud architecture comprise:
Data Ingestion Layer: Collects user-specific data (documents, preferences) that is continuously updated for personalization.
LLM Core: The central AI engine that processes language tasks like text generation, summarization, decision support, and more.
API and Interface Layer: Facilitates interactions with various apps, devices, and user interfaces.
Security and Privacy Controls: Encryption, secure cloud environments, and access control protocols ensure data remains protected.
Integration Capabilities: Personal AI can be integrated with productivity tools, personal assistants, and CRM systems, further enhancing its utility.
Ownership of Data: Users will increasingly demand more control over their data, with personal AI models allowing for strict control over what is shared or stored.
Decentralized Models: Future architectures could leverage blockchain for verifiable data transactions, ensuring transparency and control.
Edge Computing: Over time, AI will shift to edge computing models where personal AI can function offline or in hybrid modes for faster response times and improved privacy.
AI-driven Decision Making: Personal AI will evolve to assist with complex decision-making processes, analyzing personalized financial portfolios, managing health data, and optimizing schedules based on user priorities.

Personal AI LLM cloud models thus combine powerful, large-scale AI capabilities with secure, user-controlled environments that cater to the needs of individuals while offering scalable AI interactions.

This architecture forms the basis for the proposed AI-Based Portfolio Construction Engine and its patent application, ensuring innovation in the fields of secure, scalable portfolio management, AI-driven financial analysis, and microservices-based cloud computing systems.

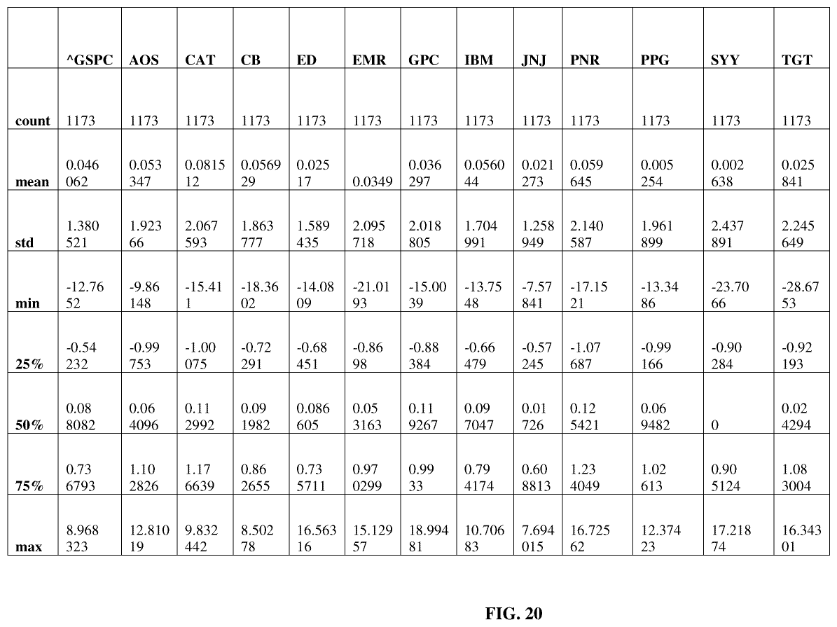

Explained below is how the input date is transformed (Data Transformation):
1) Define URL/APIs
2) Extract/Collect required data from the defined URL/APIs
3) Define the maximum period for the historical data
4) Download the raw data
5) Clean the data
6) Download the clean data
7) Calculate the historical returns and volatility, as shown in FIG. 19.
8) Stock selection using dynamic criteria
9) Data Description table, as shown in FIG. 20.
10) Generating Portfolio Weights, as shown below:
   =================================================================================

### Portfolio Weights:

| | random_weights | rebalance_weights |
|---|---|---|
| 0 | 45.767154 | 6.495963 |
| 1 | 99.292213 | 14.093044 |
| 2 | 83.828330 | 11.898177 |
| 3 | 1.146353 | 0.162708 |
| 4 | 30.083516 | 4.269905 |
| 5 | 7.818320 | 1.109694 |
| 6 | 93.412426 | 13.258496 |
| 7 | 79.287814 | 11.253719 |
| 8 | 59.354412 | 8.424471 |
| 9 | 83.045087 | 11.787008 |
| 10 | 22.707007 | 3.222920 |
| 11 | 84.033677 | 11.927323 |
| 12 | 14.771353 | 2.096573 |

=================================================================================

### Portfolio Metrics:

| | Expected | Expected |
|---|---|---|
| | Portfolio | Portfolio |
| | Returns | Volatility\ |
| 0 | 1076.821985 | 2281.068208 |

| | Portfolio |
|---|---|
| | Sharpe Ratio |
| 0 | 0.47205 |

1) Calculating total possible combinations
2) Running Monte Carlo Simulation (table)

### Simulations Result:

| | | | Sharpe |
|---|---|---|---|
| | Returns | Volatility | Ratio\ |
| 0 | 9.936436 | 23.276494 | 0.426887 |
| 1 | 11.602108 | 21.835421 | 0.531343 |
| 2 | 8.575143 | 21.344900 | 0.401742 |
| 3 | 9.769267 | 22.129440 | 0.441460 |
| 4 | 9.600704 | 21.216684 | 0.452507 |

| | Portfolio Weights |
|---|---|
| 0 | [0.00781498214923455, 0.0831558006320845, 0.17 . . . |
| 1 | [0.09044307097880044, 0.005336638181853167, 0 . . . |
| 2 | [0.042560915854637164, 0.07512582243513062, 0 . . . |
| 3 | [0.11013936480893195, 0.014043362352847562, 0 . . . |
| 4 | [0.06638626930344138, 0.06977791993110809, 0.0 . . . |

11) Calculating Sharpe Ratio (table)

MAX SHARPE RATIO:

| | |
|---|---|
| Returns | 12.518038 |
| Volatility | 20.680676 |
| Sharpe Ratio | 0.605301 |
| Portfolio Weights | [0.1287533768960903, |
| | 0.1551632781307516, 0.167 . . . |
| Name: | 105, dtype: object |

MIN VOLATILITY:

| | |
|---|---|
| Returns | 9.447602 |
| Volatility | 19.488216 |
| Sharpe Ratio | 0.484785 |
| Portfolio Weights | [0.034246831360586344, |
| | 0.04009899080323416, 0 . . . |
| Name: | 7849, dtype: object |

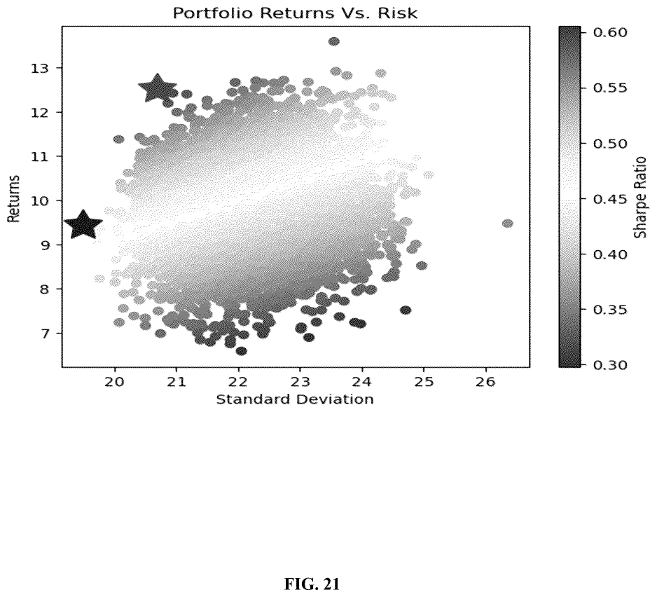

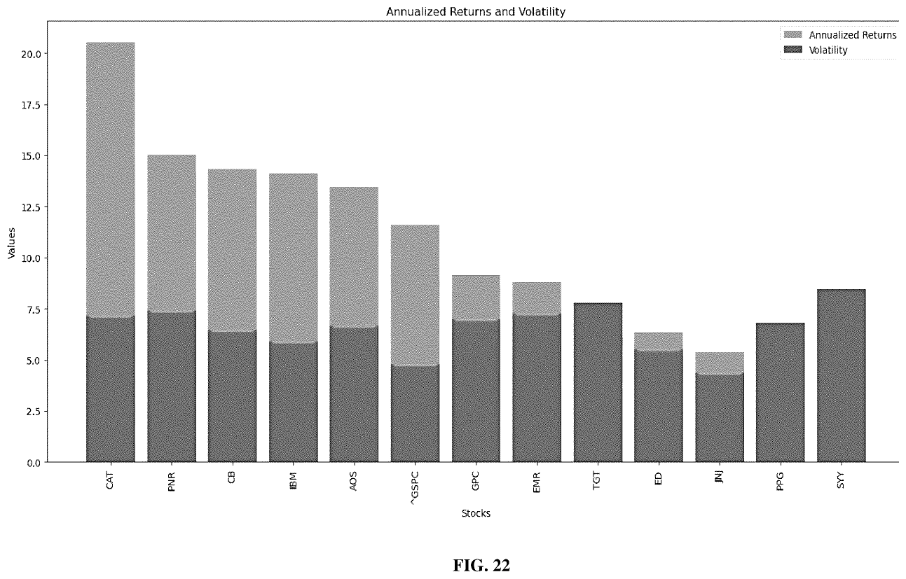

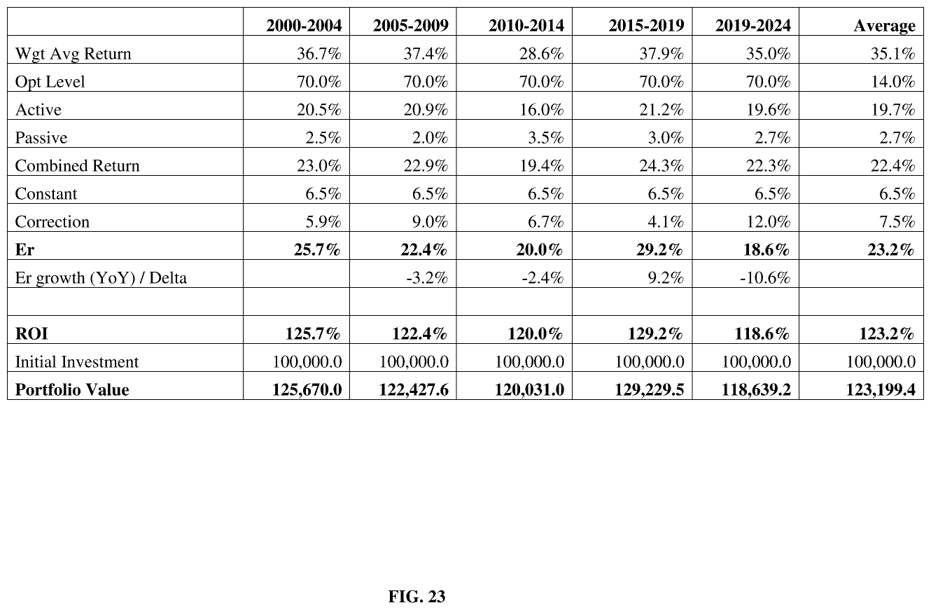

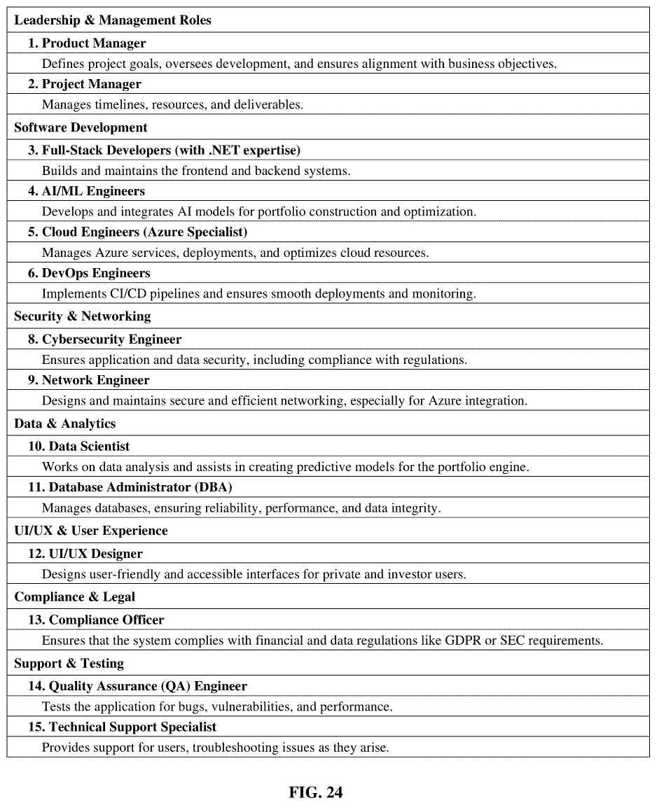

11) Portfolio Risk vs Return, as shown in FIG. 21. FIG. 22 illustrates a graph showing annualized returns of a select stocks vs volatility.
12) Calculation of Expected Return (table) (end result), as shown in FIG. 23.

Forecasting the price movements the selected financial instruments in the portfolio: The modules of the system 300 further comprise a forecasting module 310 configured to implement time-series forecasting models to predict future asset performance and market trends, as shown in FIG. 14E. The forecasting module 310 is also configured to incorporate fundamental analysis, technical analysis, macroeconomic indicators, historical data, and sentiment analysis into the forecasting process, and generate forecasted asset prices and market trends to guide investment decisions. The generative AI system has the capability to analyze news articles and identify broad market sentiments, allowing it to assess the prevailing emotional tone of the market. By monitoring sentiment shifts, it can detect changes in market mood and anticipate periods of instability when sentiment deviates significantly from its normal range. This enables the AI to provide insights into potential market disruptions before they fully materialize.

In addition to sentiment analysis, the system leverages historical data to identify recurring patterns that have historically preceded volatility. By recognizing these patterns, the AI can predict upcoming fluctuations in the market and issue timely recommendations on buying and selling opportunities. This proactive approach helps minimize risk by advising investors when to adjust their positions in anticipation of turbulent market conditions, ensuring they are better prepared for potential downturns or periods of heightened uncertainty.

### Key Features:

Sentiment Detection: The AI constantly scans and processes news articles to gauge the overall market mood, identifying shifts in sentiment that might signal upcoming instability.

Deviation Analysis: By tracking sentiment deviations from historical norms, the system can spot irregularities in market behavior, helping investors stay ahead of potential volatility.

Pattern Recognition: Using extensive historical data, the AI identifies established patterns that often coincide with market volatility. These patterns inform the AI's risk assessment, signaling times when the market is likely to become more unpredictable.

Actionable Insights: Based on its analysis of sentiment trends and historical patterns, the AI generates timely recommendations for buying or selling assets. This helps investors reduce risk by strategically adjusting their portfolios before significant market changes occur.

By combining fundamental, technical, and sentiment analysis with historical pattern recognition, our generative AI offers a comprehensive approach to market forecasting, empowering investors with the tools needed to navigate unpredictable markets while minimizing exposure to risk.

The AI system utilizes fundamental, technical, and sentiment analysis from financial data, market data, news articles, and historical data patterns to anticipate assets and market volatility, providing actionable insights to investors. We'll go through two numerical examples to demonstrate how the AI detects sentiment shifts and identifies volatility patterns, one with AI and one without, and compare the outcomes.

### Without AI/ML (Manual Approach)

In a manual process, an analyst would gather data from various sources and attempt to identify market sentiment and patterns. Let's consider the following scenario for S&P 500 stocks.

### 1. Manual Data Collection:

The analyst reads 100 news articles related to the S&P 500.
The analyst attempts to manually assign sentiment scores based on whether the tone of the news is positive, negative, or neutral.
For simplicity, we assign the sentiment score on a scale from −1 to 1 for each article:
   Positive sentiment=+1,
   Neutral sentiment=0,
   Negative sentiment=−1.

### Example: Sentiment Detection Manually

Let's say the analyst categories 100 articles as follows:
60 articles have a positive sentiment: 60×1=60,
20 articles have a neutral sentiment: 20×0=0,
20 articles have a negative sentiment: 20×−1=−20.

The overall sentiment score:

Sentiment Score=60+0−20=40

Since this score is positive, the analyst might interpret the market as bullish but may not have any precise metric on how it compares to historical sentiment or whether deviations exist that could signal upcoming volatility.

### 2. Historical Pattern Recognition:

The analyst manually compares historical price movements for S&P 500 stocks over the past year and looks for patterns that preceded volatility.
They identify key patterns such as sudden increases in volatility indicators like the VIX index but lack the computational power to process all variables simultaneously.
   Example Outcome (without AI):

The analyst determines a positive sentiment overall and decides that no immediate action is needed based on a cursory look at market patterns. However, because of the limitations in identifying sentiment deviations or complex patterns that signal volatility, the analyst may miss early warnings of market instability.

### With AI/ML (AI-Driven Approach)

In this example, we will use the AI system to dynamically analyze news sentiment and identify patterns in market data to generate timely insights. The AI will process a larger dataset and recognize sentiment deviations and volatility patterns much faster than a manual approach.

### 1. Sentiment Analysis Using AI:

The AI scans and processes 10,000 news articles related to the S&P 500, using NLP algorithms to assign sentiment scores to each article.
Based on this analysis, the AI assigns a sentiment score from −1 (negative) to 1 (positive) for each article and aggregates the results.
The system also calculates the average sentiment score from historical data (e.g., last 3 months) and compares it to the current sentiment score.
   Example: Sentiment Detection with AI

Let's assume the AI detects the following sentiment scores from 10,000 articles:
6,000 articles with positive sentiment: 6,000×1=6,000,
2,500 articles with neutral sentiment: 2,500×0=0,
1,500 articles with negative sentiment: 1,500×−1=−1,500.

The overall sentiment score:

Sentiment Score=6,000+0−1,500=4,500

### Deviation Analysis:

The AI compares this score to the historical average sentiment (e.g., an average sentiment score of 5,500 over the last 3 months). The current sentiment is 1,000 points lower than usual, suggesting a negative deviation.

AI Insight: The AI detects a negative deviation in sentiment and signals a potential market shift, possibly indicating the start of instability.

### 2. Pattern Recognition Using AI:

The AI identifies key patterns from historical market data that often precede volatility. For example, it recognizes:
   A sudden rise in the VIX index (volatility indicator),
   Historical patterns where significant sentiment drops coincide with high market volatility.

Using machine learning, the AI correlates these patterns with the current market conditions and issues a recommendation based on similar events in the past.

Example Outcome (with AI):
The AI detects that the current sentiment deviation aligns with historical patterns that have preceded market corrections.
The AI issues a recommendation to adjust portfolios by selling 15% of risky assets and shifting to safer investments (e.g., bonds).

Result: Investors receive early warning and timely insights to reduce exposure to potential market volatility, helping to minimize losses.

### Market Insights and Portfolio Adjustments

### Portfolio Value: $1,000,000

Assume the investor's portfolio is valued at $1,000,000, with 70% in stocks and 30% in bonds. Based on the AI's recommendations:
Before AI Insights: The investor holds:
   $700,000 in stocks (risky assets),
   $300,000 in bonds (safe assets).
      Actionable Insight from AI:
The AI recommends reducing stock exposure by 15% (due to sentiment deviation and volatility prediction) and reallocating this amount to safer assets (bonds).

### After AI Recommendations:

Stock holdings reduce by 15% of $700,000=$105,000.
Bond holdings increase by $105,000.
New portfolio composition:
   Stocks: $595,000,
   Bonds: $405,000.

### Anticipated Outcome:

If the market experiences a 10% drop in stock prices (as predicted by AI), the portfolio would suffer a smaller loss:
   Loss in stocks: 595,000×10%=59,500.
   Total portfolio value after drop: 1,000,000−59,500=940,500.
Without AI (assuming no reallocation and a full 70% exposure to stocks):
   Loss in stocks: 700,000×10%=70,000.
   Total portfolio value after drop: 1,000,000−70,000=930,000.

By following the AI-driven recommendations, the investor preserves an additional $10,500 in portfolio value, thus minimizing the impact of the market downturn.
Without AI/ML: Manual analysis of sentiment is time-consuming, prone to bias, and lacks the ability to detect sentiment deviations or complex volatility patterns. The investor is exposed to higher risks.
With AI/ML: The AI system provides timely insights by analyzing large datasets (news articles, historical data) and recognizing sentiment deviations and volatility patterns. This allows investors to anticipate market shifts and take proactive measures to minimize risk, as seen in the portfolio adjustment example.

By integrating AI-driven sentiment analysis and pattern recognition, the system empowers investors to navigate market volatility and protect their portfolios more effectively than through manual approaches.

The modules further comprise a risk management and evaluation module 312 which is configured to use advanced risk management techniques comprising Value at Risk (VaR), Monte Carlo simulations, scenario analysis, and stress testing to continuously monitor portfolio risk and provide real-time alerts for significant risk changes, as shown in FIG. 14F. Furthermore, the risk management and evaluation module 312 is configured to generate risk assessment reports and suggest mitigation strategies to manage and reduce the portfolio risk.

The modules further comprise a rebalancing module configured to periodically review and adjust the portfolio to maintain alignment with the investor's goals, for example, financial goals and market condition, as shown in FIG. 14G. The rebalancing module 313 is further configured to automate rebalancing strategies based on predefined criteria or triggered events and output a rebalanced portfolio that adheres to optimized asset allocation.

The modules further comprise an Environmental, Social, and Governance (ESG) evaluation module 314 configured to assess environmental, social, and governance criteria for potential investments. The (ESG) evaluation module 314 is further configured to incorporate ESG scores and factors into asset selection and portfolio construction processes, and generate an ESG-optimized portfolio that aligns with investor's sustainability preferences. The modules further comprise a performance evaluation and reporting module 315 configured to generate detailed performance reports by comparing portfolio returns to benchmarks and industry standards, and provide insights and analysis on portfolio performance comprising attribution analysis and risk-adjusted returns, as shown in FIG. 14I. The performance evaluation and reporting module 315 is further configured to deliver the performance reports and dashboards to the investor for transparency and decision support.

The modules further comprise a rebalancing module 313 configured to periodically review and adjust the portfolio to maintain alignment with the investor's financial goals and market condition, as shown in FIG. 14G. Furthermore, the rebalancing module 313 is configured to automate rebalancing strategies based on predefined criteria or triggered events and output a rebalanced portfolio that adheres to optimized asset allocation. The modules further comprise an Environmental, Social, and Governance (ESG) evaluation module 314 configured to assess environmental, social, and governance criteria for potential investments, as shown in FIG. 14H. The ESG evaluation module 314 is further configured to incorporate ESG scores and factors into asset selection and portfolio construction processes and generate an ESG-optimized portfolio that aligns with investor's sustainability preferences.

The modules further comprise a performance evaluation and reporting module 315 configured to generate detailed performance reports by comparing portfolio returns to benchmarks and industry standards. The performance evaluation and reporting module 315 is further configured to provide insights and analysis on portfolio performance comprising attribution analysis and risk-adjusted returns, and deliver the performance reports and dashboards to the investor for transparency and decision support. The modules further comprise a tax optimization module 316 configured to analyze tax implications of investment decisions and transactions, implement strategies to minimize tax liability and maximize after-tax returns, and output a tax-optimized portfolio that considers the investor's tax situation.

The modules further comprise a scenario analysis and stress testing module 317 configured to evaluate the portfolio performance under various economic scenarios and the changing market condition, including extreme events, conduct stress tests to identify potential vulnerabilities and estimate potential losses, and generate scenario analysis and stress test reports to arrive at risk management decisions. The modules further comprise a multiple decision-based feedback loop module 318 configured to learn from past performance, the market trends, and investor behavior, to refine future investment decisions. The multiple decision-based feedback loop module 318 is further configured to continuously update and learn the models and algorithms based on new data and insights, and output improved investment strategies and portfolio optimizations by leveraging machine learning for continuous improvement. The security module 319 continuously monitors the network and AI services for any suspicious activity, alerting administrators in case of potential security threats. The role distribution/organization structure module 321 provides Role-Based Access Control (RBAC). FIG. 24 illustrates the roles and responsibilities assigned to each of the roles. The system verifies not just who the user is, but also what they are allowed to access. Each user has defined roles (e.g., access to specific financial instruments or AI features), as shown in FIG. 24, to prevent unauthorized access to sensitive data.

FIG. 7 illustrates a flowchart showing the overall process followed by the model for the optimization of the expected return. Step 1 comprises evaluation of Investor's Profile. The evaluation includes dynamic profiling that adopts as investor's circumstances change. The goal is to quantify the risk factor of individual and institutional investors using machine learning (ML) algorithms that analyze multiple data sources. The risk factor is quantified on a scale of 1-100, where 1 represents the most risk-averse, and 100 represents the highest risk tolerance. After being fed thousands of questionnaires forms and being directed to some extend on how to categorize the risk factor, the ML algorithm will be able to quantify the risk factor of the investor. The ML quantify that Risk Factor from a scale of 1-100. The AI/ML system will process questionnaire forms and external data (like Actuary data for individual investors, and Dun & Bradstreet [D&B] data for institutional investors) to predict the investor's risk tolerance.

### Without AI/ML (Manual Approach)

1. Investor Questionnaires:
   Let's say an analyst manually analyzes 1,000 questionnaires from individual and institutional investors. Each questionnaire contains multiple questions that reflect the investor's:
      Risk appetite: willingness to take risks.
      Investment horizon: short-term vs. long-term investment plans.
      Income/Net worth: annual income or total net worth.
2. Categorizing Risk Factors:
   The analyst must manually categorize risk levels based on subjective interpretation. For example:
      High-income investors with a long-term horizon and positive responses to risk-taking questions might be given a risk score of 80.
      Conservative investors with a short-term horizon and low income might be assigned a risk score of 30.
3. Time and Complexity:
   Data points per questionnaire: Assume each questionnaire has 10 questions relevant to risk.
      Total data points: 1,000 investors×10 questions=10,000 data points
   The manual process requires analyzing these data points and categorizing them into risk scores. This process is slow, prone to subjective bias, and not scalable for larger datasets.

### Example Outcome (Without AI/ML):

Investor A (manual analysis):
   Annual Income: $100,000.
   Risk appetite: Moderate.
   0 Investment horizon: 10 years.

Manual Risk Score: 65 (based on analyst interpretation).

### With AI/ML (Automated Approach)

1. Questionnaire Data Processing:
   The AI model is fed thousands of questionnaire forms, where each questionnaire contains 10-20 questions. The model is trained to quantify the risk factor based on labeled data from past responses.
   ML Algorithm: The algorithm categorizes responses using features like income, age, risk appetite, and investment horizon. The algorithm then predicts a risk score for each investor.
2. External Data Sources (D&B and Actuarial Data):
   The AI system also fetches financial health data from D&B and actuarial sources. This includes:
      Credit scores for individual investors.
      Institutional financial health scores (debt-to-equity ratio, profit margin).
      Liquidity data (cash flow analysis).
   This data helps adjust the risk score to reflect the investor's actual financial capacity and stability.
3. Risk Factor Calculation (AI-Driven):
   For each investor, the system dynamically adjusts the risk factor based on the real-time data it fetches.
   For example, if an individual has a high-risk appetite but a poor credit score, the ML algorithm will lower their risk tolerance score to reflect their financial instability.

### Numerical Example (With AI/ML):

Let's assume that we have 5 key features from the questionnaires, such as income, age, risk appetite, investment horizon, and credit score. Additionally, we integrate external data sources like D&B scores to adjust the risk factor.

We create a simplified risk factor formula based on the ML output:

Risk Factor=0.3×Income Score+0.2×Risk Appetite+0.2×Investment Horizon+0.15×Credit Score+0.15×D&B Financial Health Score

Where each input is normalized to a scale of 1-100.

### Example Calculations

### Investor A (AI/ML Output)

Annual Income: $100,000→Income Score: 70.
Risk Appetite: Moderate→Risk Appetite Score: 60.
Investment Horizon: 10 years→Horizon Score: 80.
Credit Score: 750→Credit Score: 75.
D&B Financial Health Score: 85.

Using the formula:

Risk Factor=(0.3×70)+(0.2×60)+(0.2×80)+(0.15×75)+(0.15×85)

Risk Factor=21+12+16+11.25+12.75=73

AI-Driven Risk Score for Investor A: 73 (reflects the investor's risk tolerance and financial capacity more accurately).

### Investor B (AI/ML Output)

Annual Income: $50,000→Income Score: 50.
Risk Appetite: Conservative→Risk Appetite Score: 30.
Investment Horizon: 5 years→Horizon Score: 60.
Credit Score: 600→Credit Score: 50.
D&B Financial Health Score: 40.

Using the formula:

Risk Factor=(0.3×50)+(0.2×30)+(0.2×60)+(0.15×50)+(0.15×40)

Risk Factor=15+6+12+7.5+6=46.5

AI-Driven Risk Score for Investor B: 46.5 (lower risk tolerance due to a conservative profile and weaker financial health).

The AI/ML approach allows for a far more accurate and dynamic quantification of the investor's risk factor, leveraging a combination of questionnaire data, actuarial data, and institutional data from sources like D&B. The AI approach can scale easily and adjust risk factors based on real-time financial health and risk indicators. In contrast, the manual approach is subjective, time-consuming, and prone to human error, especially when dealing with large datasets and dynamic external factors.

In the second step, an evaluation of investment style is performed, by an investment style evaluation module 306 configured to analyze investor's historical investment behavior, trading patterns, and market preferences, as shown in FIG. 14B. In the third step, multiple financial instrument selections are performed. A financial instrument selection module 307 configured to use predictive models, including the machine learning algorithms, to filter and select appropriate assets and stocks, as shown in FIG. 14C. In step 4, a portfolio construction is performed. FIGS. 5D and 14D illustrate the portfolio creation process. In step 5, investor's approval process is performed. In step 6, forecasting is performed by a forecasting module 310 configured to implement time-series forecasting models to predict future asset performance and market trends, as shown in FIG. 14E. In step 7, Risk Management & Evaluation is performed by a risk management and evaluation module 312 which is configured to use advanced risk management techniques comprising Value at Risk (VaR), Monte Carlo simulations, and stress testing to continuously monitor portfolio risk and provide real-time alerts for significant risk changes, as shown in FIG. 14F. In step 8, rebalancing is performed by a rebalancing module configured to periodically review and adjust the portfolio to maintain alignment with the investor's financial goals and market condition, as shown in FIG. 14G. In step 9, Return Optimization of Optimizable Portfolio, for example, the optimizable financial portfolio, is performed. In step 10, Performance Evaluation & Reporting is performed by a performance evaluation and reporting module 315 configured to generate detailed performance reports by comparing portfolio returns to benchmarks and industry standards, and provide insights and analysis on portfolio performance comprising attribution analysis and risk-adjusted returns, as shown in FIG. 14I. In step 11, Tax Strategies are Optimized. In step 12, scenario analysis and stress testing is performed by a scenario analysis and stress testing module 317. In step 13, a feedback is given via feedback loop for continuous improvement.

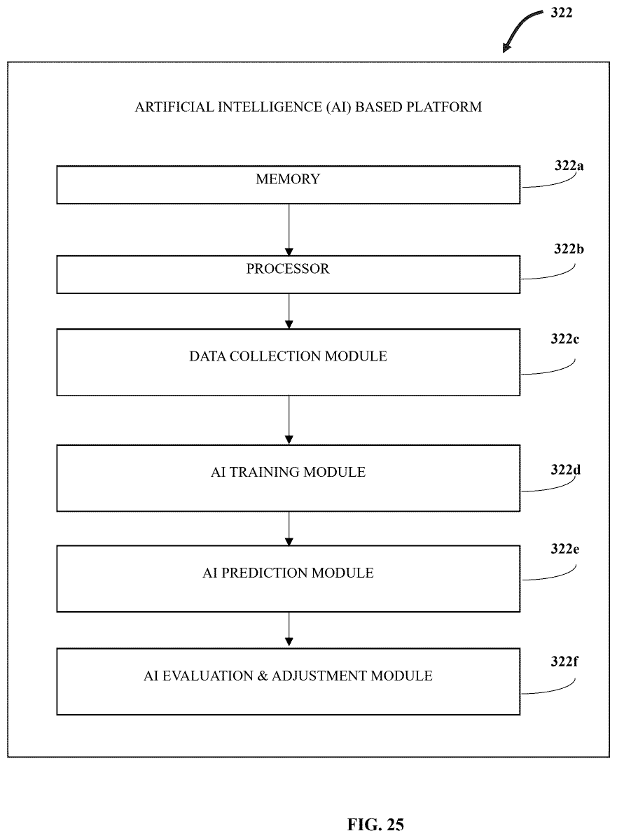

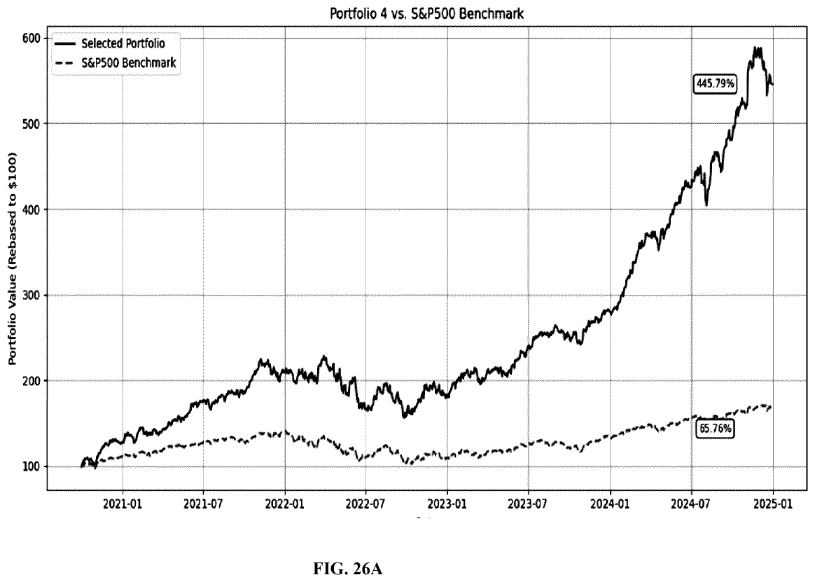

FIG. 8 illustrates a flowchart showing how some of the modules shown in FIG. 3 work together to implement an Artificial Intelligence (AI) based platform 322 used, for example, for trading. The AI based platform 322 is also illustrated in FIG. 25. The AI based platform 322 comprises a memory 322a, a processor 322b communicatively and operably connected to the memory 322a, a Data Collection Module 322c, an AI Training Module 322d, AI Prediction Module 322e and AI Evaluation & Adjustment Module 322f. The process starts with the Data Collection Module 322c, which gathers information from various sources such as reports, articles, news, and events. This data is then passed to the AI Training Module 322b, where the AI model is trained using historical stock data and data, for example, financial data. After training, predictions are made and validated by expert professionals through the Validation & Expert Feedback Loop. Once the predictions are validated, the AI Prediction Module 322e takes over, making real-time performance predictions of the asset predictions, for example, financial asset predictions, based on live market data. Finally, the AI Evaluation & Adjustment Module 322f reviews the system's performance at regular internals, ensuring the model remains accurate and up-to-date. This iterative process allows the system to continuously improve, with feedback loops ensuring constant refinement of the AI's prediction.

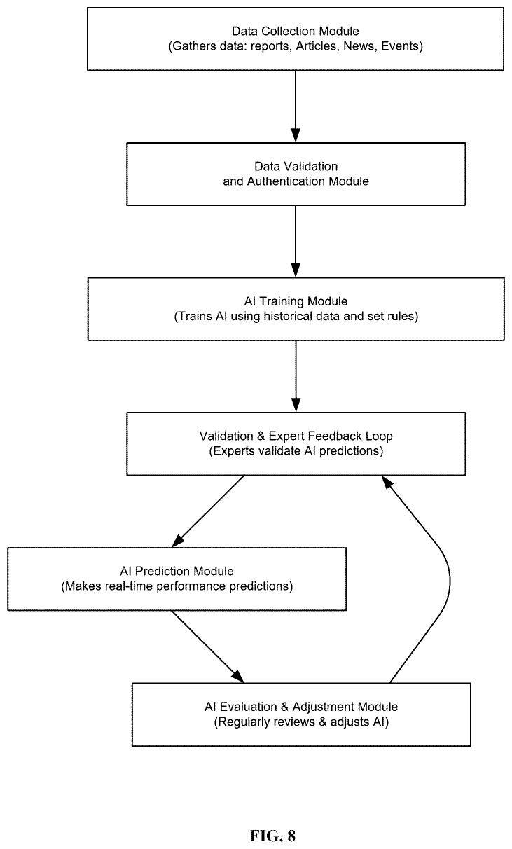

FIG. 9 illustrates a flowchart showing the process followed by the data collection module 322c. The Data Collection Module 322c begins by gathering inputs from various sources, such as analysis reports, articles, news, and expert commentary. These inputs are diverse in nature, covering both real-time and historical data. Once the data is collected, it moves to the Data Aggregation phase. In this step, the system organizes and pre-processes the data, ensuring it is structured and clean for the next stage. After pre-processing, the AI Module Input phase begins, where the aggregated data is fed into the AI model. This data becomes the foundation for AI training, enabling the system to learn from historical and real-time information, refining its predictions over time.

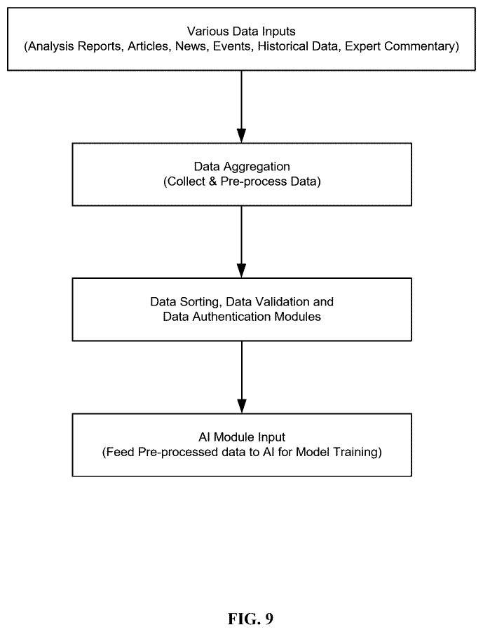

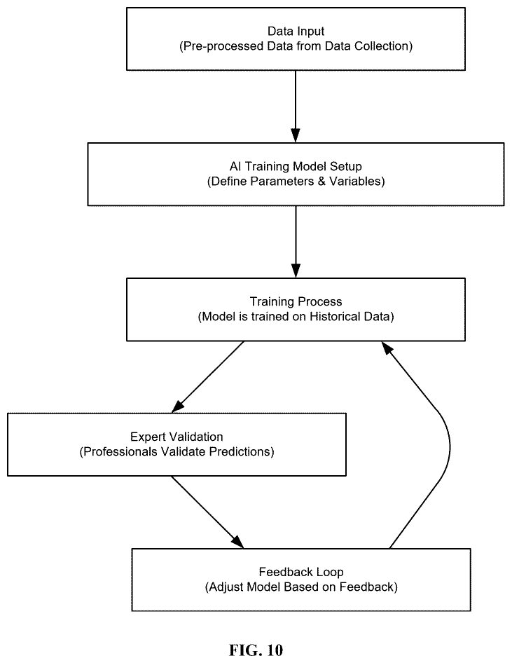

FIG. 10 illustrates a flowchart showing the process followed by an Artificial Intelligence (AI) training module 322d. The process begins with the input of pre-processed data collected from the previous module. The next step involves setting up the AI training model, where parameters and variables that define the model are configured. The core of this AI training module 322c is the training process, where the AI model is trained on historical data to learn patterns and make predictions. Once the model generates predictions, expert professionals validate these outputs. Any discrepancies or feedback from experts are then incorporated into the model, adjusting it in the Feedback Loop. This iterative process continues until the AI model achieves accurate and reliable predictions.

FIG. 11 illustrates a flowchart showing a validation and expert feedback loop. The validation and expert feedback loop begins with the AI model generating predictions based on the data provided. These predictions are then validated by expert professionals, who review the outputs for accuracy and performance. In the event of discrepancies or incorrect predictions, the experts analyze the root cause, providing feedback that is essential for improving the model. This feedback is then used to adjust the AI model, ensuring it becomes more accurate over time. The loop repeats, allowing continuous refinement of the model through ongoing expert feedback.

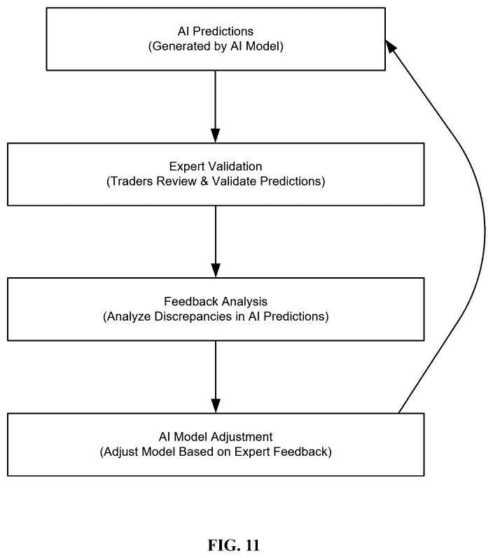

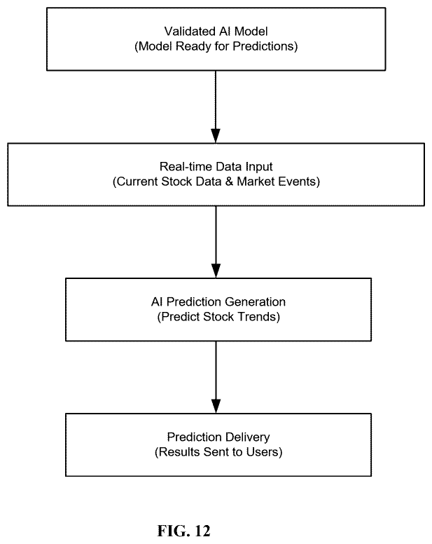

FIG. 12 illustrates a flowchart showing the process followed by AI prediction module 322e. The AI Prediction Module 322e starts with a validated AI model that has undergone training and validation. In real-time, the module 322e collects current stock data and market events as inputs. Using this real-time data, the AI generates predictions on stock trends, assessing the market based on its learned patterns. Once predictions are generated, they are delivered to users, informing them about upcoming system actions, as the system autonomously takes decisions based on these predictions.

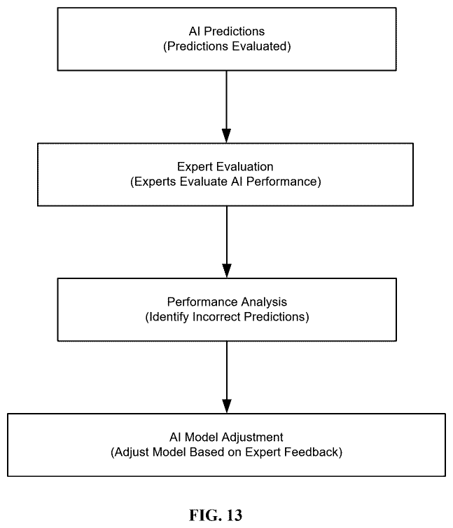

FIG. 13 illustrates a flowchart showing the process followed by AI evaluation and adjustment module 322f. The AI Evaluation and Adjustment Module 322f begins with the AI system generating predictions. These predictions are then evaluated by experts who assess the AI's performance based on accuracy and market relevance. During the performance analysis stage, experts identify any incorrect predictions or areas where the AI's predictions were off Based on this evaluation, the model is adjusted to improve its predictive capabilities, ensuring it becomes more accurate over time. This process of expert evaluation and adjustment ensures that the AI system adapts to changing market conditions and user requirements.

FIG. 15 illustrates the Buy-Sell Process Flow Chart. Given below is the Buy-Sell process.

### Step 1: Stock Selection Based on Fundamental Analysis

In this step, we select stocks based on fundamental parameters such as earnings, revenue growth, debt levels, valuation ratios, and profitability ratios. Each parameter is assigned a weight based on its importance or reliability in predicting long-term performance.

### Fundamental Parameters and Suggested Weights

Here's a list of common fundamental indicators and their suggested weights based on their importance:

| Fundamental Parameters | Weights (%) |
|---|---|
| Earnings Growth (YoY) | 20% |
| Revenue Growth (YoY) | 15% |
| Price-to-Earnings-to- | 15% |
| Growth (PEG) Ratio | |
| Return on Equity (RoE) | 10% |
| Price-to-Earnings (P/E) Ratio | 10% |
| Debt-to-Equity (D/E) Ratio | 10% |
| Free Cash Flow | 5% |
| Dividend Yield | 5% |
| Price-to-Book (P/B) Ratio | 5% |
| Profit Margin | 5% |

### Weighted Average for Fundamental Selection

Each stock is assigned a fundamental score based on the weighted average of the selected fundamental indicators. The formula for the fundamental score is:

$${F}_{weighted} = {\sum }_{i = 1}^{n} {w}_{i} \cdot {P}_{i}$$

### Where;

wᵢ is the weight of the i-th fundamental parameter.
Pᵢ is the value (or normalized score) of the i-th fundamental parameter
n is the total number of fundamental parameters

### Threshold for Fundamental Selection

Once the weighted fundamental score F_{weighted} is calculated, we compare it to a pre-defined fundamental threshold T_{fundamental}. Only stocks with scores above the threshold are selected for further analysis in Step 3.
Select Stock if F_{weighted}>T_{fundamental}

This helps filter fundamentally strong stocks.

### Step 2: Sentiment Analysis (Stock Selection)

Sentiment analysis involves using natural language processing (NLP) to assess how positive or negative news and social media mentions are about a stock. Sentiment can provide valuable insights into short-term market behavior.

### Sentiment Sources

News Articles: Financial news on the stock.
Social media: Twitter, Reddit, Stock Twits sentiment.
Analyst Reports: Buy, hold, or sell recommendations.

### Sentiment Scoring System

We assign sentiment scores based on text analysis:
Positive sentiment: +1
Neutral sentiment: 0
Negative sentiment: −1

### Sentiment Formula

Let:
S_{news}=Sentiment from news articles,
S_{social}=Sentiment from social media,
S_{analyst}=Sentiment from analyst report,
S_{traffic}=Sentiment from internet traffic.

The overall sentiment score for each stock is:

$${S}_{total} = {\sum }_{i = 1}^{n} {w}_{i} \cdot {S}_{i}$$

Where w_{news}, w_{social}, w_{analyst}, w_{traffic}, are the weights for each sentiment source (e.g., 0.5 for news, 0.15 for social media, 0.15 for analyst reports, 0.2 for overall internet traffic).

### Sentiment Threshold

Select stock if Sₜₒₜₐₗ>Tₛₑₙₜᵢₘₑₙₜ

### Step 3: Technical Analysis

In this example, we are using ten technical indicators and dynamically assign them weights based on their relative importance and/or reliability in predicting stock price movements. Then calculating a weighted average of the signals from all the indicators will help us to make a more comprehensive decision (buy or sell) when the weighted average crosses a certain threshold.

In this approach:
Each indicator provides a buy or sell signal, either as a binary output (1 for buy, −1 for sell) or some normalized score.
Assign weights to each indicator based on its reliability or predictive power. For example, indicators that perform better in certain market conditions (like trend-following or mean-reversion) will be given higher weights.
Weighted average calculation: After calculating the signals from each indicator, compute a weighted average of these signals.
Threshold for decision: Based on the weighted average, if the result is higher than a certain threshold, you issue a buy signal; if it's lower than another threshold, you issue a sell signal.

### Weight Summary:

| Technical Indicators | Weights (%) |
|---|---|
| SMA (50-days, 20-days) | 10% |
| EMA (20-days) | 10% |
| MACD | 15% |
| RSI | 15% |
| Bollinger Bands | 10% |
| Stochastic Oscillator | 10% |
| ATR | 10% |
| Fibonacci Retracement | 10% |
| VWAP | 5% |
| Parabolic SAR | 5% |

### Threshold for Decision:

Buy Signal: If the weighted average of all the indicators exceeds 0.5 (suggesting bullish momentum).
Sell Signal: If the weighted average is below −0.5 (suggesting bearish momentum).
We can dynamically adjust these thresholds based on the market and investors' risk tolerance.

Let:
I₁, I₂, I₃, . . . , Iₙ represent the n technical indicators.
w₁, w₂, w₃, . . . , wₙ represent the corresponding weights assigned to each indicator, where wᵢ≥0 and the sum of the weights

$${\sum }_{i = 1}^{n} {w}_{i} = 1 .$$

S₁, S₂, S₃, . . . , Sₙ represent the signal values generated by each indicator. These signal values can take values like:
   1 for a buy signal
   −1 for a sell signal
   0 if the indicator gives a neutral/no signal.

### Weighted Average Signal Calculation

The weighted average signal S_{weighted} is a linear combination of the individual indicator signals, weighted by their respective weights:

$${S}_{weighted} = {\sum }_{i = 1}^{n} {w}_{i} \cdot {S}_{i}$$

### Where;

wᵢ is the weight of the i-th indicator,
Sᵢ is the signal of the i-th indicator (which can be 1 for buy, −1 for sell, or 0 for neutral),
n is the total number of indicators.

### Decision Criteria:

Now, based on the value of the weighted signal S_{weighted}, we make the following decisions:
Buy Signal:
   If S_{weighted}>T_{buy}, then we issue a buy signal.
   T_{buy} is the buy threshold (e.g., 0.5)
Sell Signal:
   If S_{weighted}<Tₛₑₗₗ, then we issue a sell signal.
   Tₛₑₗₗ is the sell threshold (e.g., −0.5)
Hold/Neutral:
   If Tₛₑₗₗ≤S_{weighted}≤T_{buy}, the system gives no signal.

### Complete Formula:

Thus, the complete formula for the weighted signal S_{weighted} is:

$${S}_{weighted} = {w}_{1} \cdot {S}_{1} + {w}_{2} \cdot {S}_{2} + … + {w}_{n} \cdot {S}_{n} = {\sum }_{i = 1}^{n} {w}_{i} \cdot {S}_{i}$$

The buy or sell decision is determined as follows:

$$Decision = \{ \begin{matrix}Buy , & if {S}_{weighted} > {T}_{buy} \\ Sell , & if {S}_{weighted} < {T}_{sell} \\ Hold , & if {T}_{sell} \leq {S}_{weighted} \leq {T}_{buy}\end{matrix}$$

### Fine Tuning:

Thresholds: The buy/sell thresholds (T_{buy} and Tₛₑₗₗ) can be adjusted based on back-testing results. Typically, for a balanced condition, we might set T_{buy}=0.5 and Tₛₑₗₗ=−0.5.
Dynamic Weights: The system could also modify the weights dynamically based on the market context or indicator performance over time.
Signal Normalization: The system also ensures all signals are normalized (e.g., 111, 000, and −1−1−1) so that they can be meaningfully combined into the weighted average.

### Step 4: Lunar Cycle Analysis

Lunar cycles have been studied in finance, with some research suggesting that the new moon tends to correlate with increased stock prices (bullish sentiment), and the full moon with lower prices (bearish sentiment). We'll integrate the lunar phase into our decision-making process.

Lunar Phases and Trading Signals:
New Moon: Typically bullish, so assign a buy bias.
Full Moon: Typically bearish, so assign a sell bias.

### The Formula for Lunar Cycle Influence

We introduce a binary signal for the lunar cycle:

$${S}_{lunar} = \{ \begin{matrix}1 & if new moon \\ - 1 & if full moon\end{matrix}$$

### Combined Technical and Lunar Signal

To incorporate the lunar cycle into our technical analysis, we compute the combined signal S_{combined} as:

S_{combined}=wₜ·S_{technical}+wₗ·Sₗᵤₙₐᵣ

Where;
wₜ and wₗ are weights for the technical indicators and lunar cycle, respectively (e.g., wₜ=0.8, wₗ=0.2).

### Buy/Sell Threshold for Combined Signal:

Buy: S_{combined}>T_{buy} (e.g., 0.5)
Sell: S_{combined}<Tₛₑₗₗ (e.g., −0.5)

### Step 5: Portfolio Optimization:

In this step, we focus on diversifying the portfolio and optimizing position sizes to manage risk. We will use methods like Modern Portfolio Theory (MPT) and others to allocate capital based on the risk-return trade-off. The main idea is to optimize returns while minimizing risk.

### Process for Portfolio Optimization:

1. Risk Assessment: Measure the risk of each stock (e.g., using volatility, beta, or Value at Risk (VaR)).
2. Correlation Analysis: Assess the correlation between different selected stocks to minimize portfolio risk.
3. Capital Allocation: Allocate capital to selected stocks based on:
   Risk profile (lower risk gets higher allocation).
   Expected return (higher expected return gets higher allocation).
4. Position Sizing: Use techniques like Kelly Criterion or Equal Weighting to size positions.

### Mathematical Formula for Position Sizing:

Using Risk Parity (or equal risk contribution), we can allocate weights to each stock in the portfolio:

$${w}_{i} = \frac{1 / {σ}_{i}}{{\sum }_{j = 1}^{m} 1 / {σ}_{j}}$$

Where;
wᵢ is the portfolio weight of the stock i.
σᵢ is the volatility of the stock i.
m is the number of selected stocks in the portfolio.

This ensures that each stock contributes equally to the overall portfolio risk.

### Step 6: Risk Management and Exit Strategy:

Risk management is crucial in ensuring that potential losses are minimized. Here, we define an exit strategy and incorporate stop-loss, take-profit, and trailing stops.

### Key Concepts for Risk Management

1. Stop-loss orders: Automatically sell a stock if its price falls below a certain percentage (e.g., 5% from the purchase price).

Stop Loss Price=Entry Price×(1−Stop Loss %)
2. Take-Profit Orders: Automatically sell a stock if its price reaches a certain percentage gain (e.g., 10% from the entry price).

Take−Profit Price=Entry Price×(1+Take Profit %)
3. Trailing Stops: A dynamic stop-loss that moves with the price as the stock price increases. It locks in profits while allowing the stock to rise further.
4. Risk-Reward Ratio: Set a risk-reward ratio (e.g., 1:2) to ensure that the potential reward outweighs the risk. If you're risking 5%, set a target to gain at least 10%.
5. Max Drawdown: Define a maximum portfolio drawdown limit. If the portfolio value drops by more than, say, 15%, you may want to exit certain positions or reduce exposure to risky assets.

### Mathematical Formula for Risk Management:

### Expected Return:

$$E ( R ) = {\sum }_{i = 1}^{m} {w}_{i} \cdot E ( {R}_{i} )$$

Where;
wᵢ is the portfolio weight of the stock i.
E(Rᵢ) is the expected return of stock i.
m is the number of stocks in the portfolio.

### Portfolio Risk and Standard Deviation:

$${σ}_{p} = \sqrt{{\sum }_{i = 1}^{m} {\sum }_{j = 1}^{m} {w}_{i} {w}_{j} {σ}_{i} {σ}_{j} {ρ}_{i j}}$$

Where;
σᵢ is the standard deviation (volatility) of stock i.

ρᵢⱼ is the correlation coefficient between stocks i and j.

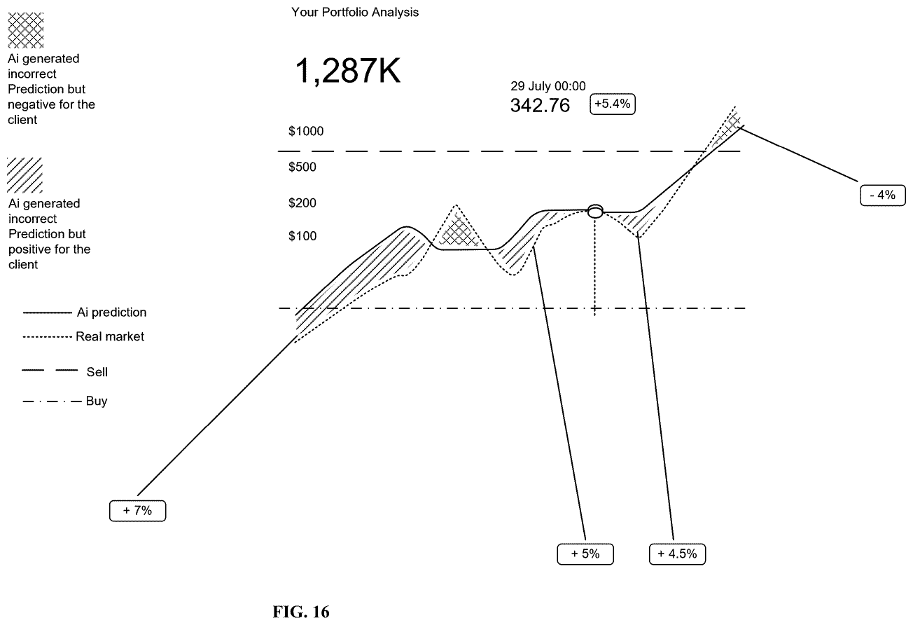

FIG. 16 illustrates a graph showing real market vs AI prediction. The blue line represents the AI's forecasted performance of the market, showing its estimates of when the asset value will rise or fall. The green line shows the actual market performance, revealing how the value of the asset has changed over time. Buy and sell signals are indicated by the blue and orange dotted lines, respectively. These lines show when the AI estimated the right moments to buy or sell based on the market forecast. The graph helps users visualize where the AI was accurate (aligned with the real market) and where it misjudged the market (shown by shaded areas). This transparency allows the user to understand how the AI's predictions affect the portfolio over time. Positive Ai Errors, shown in green shaded area are the moments that represent instances where the Al predicted incorrectly, but the outcome was in favor of the client (the market performed better than the AI expected). Negative AI errors are shown in red shaded area. These are moments where the Al predicted market growth, but the market actually fell, resulting in negative outcomes for the client.

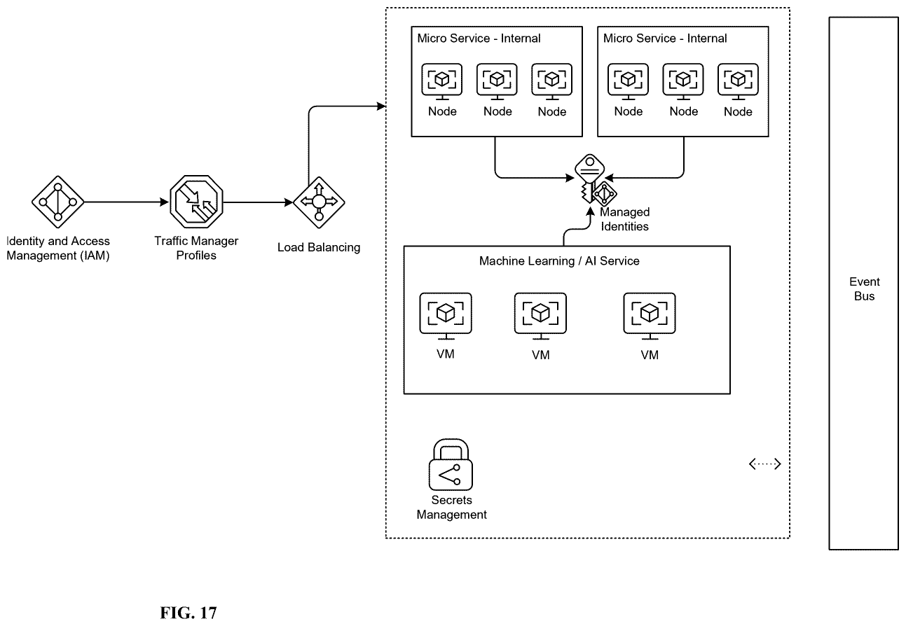

FIG. 17 illustrates a security diagram for user authentication, secure data flow and privacy. As shown in FIG. 17, for user authentication and access control, and to ensure privacy and security, the system uses Identity and Access Management (IAM) services. This includes:
Multi-Factor Authentication (MFA): Users are required to provide multiple forms of verification (e.g., a password and a one-time code sent to their phone) before accessing the AI system.
Role-Based Access Control (RBAC): The system verifies not just who the user is, but also what they are allowed to access. Each user has defined roles (e.g., access to specific financial instruments or AI features) to prevent unauthorized access to sensitive data.

Once authenticated, users can interact with their private AI LLMs (Large Language Models) to analyze financial instruments. The diagram in FIG. 17 emphasizes how data flows securely:
Data Encryption in Transit: All communication between the user and the AI system is encrypted using SSL/TLS, ensuring that no unauthorized party can intercept sensitive data, such as financial information or AI model outputs.
Data Encryption at Rest: Financial data and AI models are stored in encrypted databases, meaning that even if the storage system is compromised, the data remains unreadable without the proper decryption keys.

The core of the system—user interaction with the private AI LLM—needs to protect both user preferences and financial data. The diagram depicts:
Isolated AI Models: Each user has access only to their own customized AI LLM, ensuring that no data from one user can be accessed by another. The AI models process the financial data securely, adhering to user-specific preferences and requirements.
Access Control for AI Models: Additional security policies ensure that only authorized users can train or modify their models. This access control prevents any unauthorized alterations to the models or the underlying financial data.

The system processes user data within a Virtual Private Network (VPN) or a secure cloud network. This ensures that sensitive data is only processed in a protected, isolated environment, reducing the risk of unauthorized access or data breaches.
Firewall Protection: The network is protected by firewalls that monitor and block unauthorized access attempts.
Monitoring and Intrusion Detection: Security systems continuously monitor. the network and AI services for any suspicious activity, alerting administrators in case of potential security threats.

In the diagram, these layers are represented by secure, isolated network environments, demonstrating that all data processing and communication are kept private.

To ensure that the system complies with data privacy regulations (such as GDPR), the diagram includes:
Auditing and Logging: The system logs all access and interactions with AI models and financial data. This logging is crucial for both security monitoring and regulatory compliance, ensuring that all user actions are traceable and verifiable.

The method and the system 300 disclosed herein are not limited to a particular computer system platform, processor, operating system, or network. In an embodiment, one or more aspects of the method and the system 300 disclosed herein are distributed among one or more computer systems, for example, servers configured to provide one or more services to one or more client computers, or to perform a complete task in a distributed system. For example, one or more aspects of the method and the system 300 disclosed herein are performed on a client-server system that comprises components distributed among one or more server systems that perform multiple functions according to various embodiments. These components comprise, for example, executable, intermediate, or interpreted code, which communicate over a network using a communication protocol. The method and the system 300 disclosed herein are not limited to be executable on any particular system or group of systems, and are not limited to any particular distributed architecture, network, or communication protocol.

The foregoing examples have been provided merely for explanation and are in no way to be construed as limiting of the method and the system 300 disclosed herein. While the method and the system 300 have been described with reference to various embodiments, it is understood that the words, which have been used herein, are words of description and illustration, rather than words of limitation. Furthermore, although the method and the system 300 have been described herein with reference to particular means, materials, and embodiments, the method and the system 300 are not intended to be limited to the particulars disclosed herein; rather, the method and the system 300 extend to all functionally equivalent structures, methods and uses, such as are within the scope of the appended claims. While multiple embodiments are disclosed, it will be understood by those skilled in the art, having the benefit of the teachings of this specification, that the method and the system 300 disclosed herein are capable of modifications and other embodiments may be effected and changes may be made thereto, without departing from the scope and spirit of the method and the system 300 disclosed herein.

We claim:

1. A system for an automated investment portfolio model for optimizing an optimizable portfolio of assets, comprising:
a memory; and
a processor communicatively coupled to the memory and configured to execute a plurality of instructions stored in the memory to implement a plurality of modules, comprising:
a data acquisition module configured to receive data, pre-process the received data, normalize and integrate the pre-processed data to create a comprehensive dataset for analysis, wherein the received data is pre-processed using one or more of actuarial data models and credit worthiness to estimate an investor's risk;
a profile evaluation module configured to receive data on factors comprising the investor's goals, risk tolerance, return determination, investment horizon, and personal preferences, wherein the profile evaluation module is further configured to apply one or more machine learning algorithms to evaluate, analyze, assist, and classify profiles of a plurality of investors dynamically and generate a detailed investor profile report, comprising a risk aversion index and specific investment objectives;
an investment style evaluation module configured to:
analyze one or more parameters comprising investor's historical investment behavior, trading patterns, and market preferences;
utilize clustering techniques, utility function, risk budgeting, and sentiment analysis to determine investor's preferred investment style; and
output a categorized investment style tailored to investor's profile and preferences;
an instrument selection module configured to:
use predictive models, comprising the machine learning algorithms, to filter and select one or more instruments appropriate for the investor's profile and preferences;
ensure diversification across sectors, industries, and asset classes to minimize risk; and
based on an optimization criteria, generate a list of selected instruments for inclusion in the portfolio;
a portfolio construction module configured to apply multi-objective algorithms to construct a portfolio from the selected instruments, wherein the constructed portfolio balances parameters comprising one or more of risk, return, and investor preferences;
a portfolio optimization module configured to utilize various optimization models comprising Modern Portfolio Theory (MPT), Black-Letterman model, reverse optimization, resampled mean-variance optimization, mean-variance optimization, and non-normal optimization approaches to optimize the constructed portfolio; and
said portfolio optimization module further configured to:
continuously refine and optimize the constructed portfolio using advanced algorithms to maximize risk-adjusted returns;
integrate (Artificial Intelligence) AI-driven optimization techniques that adapt dynamically to the changing market condition and changing investor profiles; and
output an optimized portfolio with updated asset allocations to achieve a superior performance.

2. The system of claim 1, wherein the plurality of instructions stored in the memory further implements modules, comprising:
a forecasting module configured to:
implement various forecasting models to predict factors comprising future asset performance and market trends;
incorporate factors comprising macroeconomic indicators, historical data, and sentiment analysis into the forecasting process; and
generate forecasted asset prices and market trends to guide investment decisions;
a risk management and evaluation module configured to:
use advanced risk management techniques comprising Value at Risk (VaR), Monte Carlo simulations, scenario analysis and stress testing from the scenario analysis and stress testing module to continuously monitor portfolio risk and provide real-time alerts for significant risk changes; and
generate risk assessment reports and suggest mitigation strategies to manage and reduce the portfolio risk;
a rebalancing module configured to:
periodically review and adjust the portfolio to maintain alignment with factors comprising the investor's goals and market condition;
automate rebalancing strategies based on predefined criteria or triggered events; and
output a rebalanced portfolio that adheres to optimized asset allocation;
an Environmental, Social, and Governance (ESG) evaluation module configured to:
assess environmental, social, and governance criteria for potential investments;
incorporate ESG scores along with various other factors into asset selection and portfolio construction processes; and
generate an ESG-optimized portfolio that aligns with investor's sustainability preferences;
a performance evaluation and reporting module configured to:
generate detailed performance reports by comparing portfolio returns to benchmarks and industry standards;
provide insights and analysis on portfolio performance comprising attribution analysis and risk-adjusted returns; and
deliver the performance reports and dashboards to the investor for transparency and decision support;
a tax optimization module configured to:
analyze tax implications of investment decisions and transactions;
implement strategies to minimize tax liability and maximize after-tax returns; and
output a tax-optimized portfolio that considers the investor's tax situation;
a scenario analysis and stress testing module configured to:
evaluate the portfolio performance under various economic scenarios and the changing market condition, including extreme events;
conduct stress tests to identify potential vulnerabilities and estimate potential losses; and
generate scenario analysis and stress test reports to arrive at risk management decisions;
a multiple decision-based feedback loop module configured to:
learn from past performance, the market trends, and investor behavior, to refine future investment decisions;
continuously update and learn the models and algorithms based on new data and insights; and
output improved investment strategies and portfolio optimizations by leveraging machine learning for continuous improvement.

3. The system of claim 1, wherein the data received by the data acquisition module comprises:
traditional data comprising stock exchange data, company financials, economic indicators, regulatory filings; and
alternative data comprising social media sentiment, news articles, sensor data, and other non-traditional data sources.

4. The system of claim 1, wherein the actuarial models estimate an individual investor's financial risks based on factors comprising one or more of age, income, asset base, liabilities, and investment history, and wherein the actuarial models determine factors comprising Required annual contributions to achieve retirement goals, optimal portfolio allocation between equities, bonds, and real estate to balance growth and stability.

5. The system of claim 1, wherein the data acquisition module is further configured to pre-process the received data using credit rating Application Programming Interface (APIs) and Social Score Ranking.

6. The system of claim 5, wherein the credit rating APIs provide insights into an institutional investor's creditworthiness by fetching and analyzing credit scores from established bureaus, wherein the credit scores allow the system to take portfolio decisions and perform risk assessments.

7. The system of claim 1, wherein the machine learning algorithms in the predictive models used by the instrument selection module comprise a plurality of rule-based algorithms and pattern recognition powered by generative AI to identify the one or more instruments appropriate for the investor's profile and preferences, wherein the instruments comprise equities, bonds, commodities, real estate, and alternative assets, and wherein the instrument selection module employs unsupervised machine learning techniques comprising one of clustering and principal component analysis (PCA) to categorize the instruments into different groups comprising optimized, unoptimized, and optimized hedge-able assets to enhance and optimize expected returns of the updated portfolio.

8. The system of claim 7, wherein the instrument selection module categorizes the instruments into groups comprising optimized assets, unoptimized assets, and optimized hedge-able assets, wherein the unoptimized assets are the instruments that are bought and held until the end of a defined time horizon, wherein the optimized assets are the instruments that are actively managed during the defined time horizon, wherein the optimized hedge-able assets are derivatives, future and options to hedge the risk of the optimized assets, wherein the instrument selection module employs unsupervised machine learning techniques comprising one of clustering and principal component analysis (PCA) to categorize instruments based on correlations, volatility, performance metrics, and risk profiles, wherein the clustering comprises using one of K-means and Hierarchical Clustering algorithm to group the instruments based on their features comprising price movement, correlation with other assets, and volatility, wherein the PCA reduces the dimensionality of the dataset, identifying key factors that explain most variance among the instruments which are then used to categorize the assets, wherein the instrument selection module categorizes the instruments into the unoptimized assets group by identifying instruments with low volatility, passive management strategies, and low correlation with actively managed assets, wherein the instrument selection module categorizes the instruments into the optimized assets group based on factors comprising high Sharpe ratios, active management, and correlation with the rest of the portfolio, and wherein the instrument selection module categorizes the instruments into the optimized hedge-able assets group based on analyzing which derivatives are most effective in hedging the risks of the optimized assets.

9. The system of claim 8, wherein the instrument selection module categorizes the instruments into groups based on an optimization function that is defined using AI, wherein the optimization function categorizes assets based on correlation and volatility:
$$Category = \{ \begin{matrix}Optimized & \begin{matrix}if Sharpe {Ratio}_{i} > Threshold , {ρ}_{i} > \\ Correlation Threshold\end{matrix} \\ Unoptimized & if {σ}_{i} < Threshold , {ρ}_{i} < Correlation Threshold \\ Hedge - able & if {Derivatives}_{i} hedges risk of optimized asset\end{matrix}$$
Where;
σᵢ is the volatility of the asset
ρᵢ is the correlation of asset i with the rest of the portfolio
wherein the thresholds are dynamically determined by the AI based on the historical and other various data.

10. The system of claim 1 further comprises utilizing a dynamic constant and a dynamic auto-correction factor, wherein the dynamic constant is a fixed value derived from the analysis of historical data spanning past several decades, wherein the dynamic constant is based on long-term market patterns and reflects established market behaviour, trends, and average growth rates observed over several decades, wherein the system sets benchmarks, growth expectations, and risk assessments for the portfolio based on past market behaviour, wherein the dynamic auto-correction factor is executed by the processor along with the multiple decision-based feedback loop module, wherein the system, based on the dynamic auto-correction factor, adjusts the portfolio to respond flexibly to short-term market fluctuations by automatically adjusting the portfolio's asset allocation when the portfolio deviates from its optimal risk-return profile, wherein the multiple decision-based feedback loop module, based on the dynamic auto-correction factor provides feedback to the system to adjust the portfolio to react to real-time market movements, mitigating risks, or taking advantage of opportunities as they arise, wherein the dynamic auto-correction factor executed by the processor continuously monitors the portfolio's performance relative to the portfolio's risk and return objectives.

11. The system of claim 1, wherein the portfolio optimization module dynamically adjusts the asset allocations as market conditions change, based on real-time data.

12. The system of claim 1, wherein the investor is one of an individual investor and an institutional investor, wherein the institutional investor is one of a family office, a corporation, an entity, and an institution.

13. The system of claim 1, wherein the profile evaluation module is further configured to receive data on tax implications of the investor.

14. The system of claim 1, wherein the (Artificial Intelligence)/Machine Learning (ML) uses a Machine Learning Model, wherein the system comprises an AI Agent that employ reinforcement learning (RL) model to determine the optimal combination of instruments, wherein the AI agent iteratively tries different portfolio combinations and learns from the market's response using the RL model, wherein the RL model uses a reward function to maximize returns while minimizing risk, wherein the AI agent learns the combinations of instruments and weightings in the portfolio to produce the optimal risk-adjusted returns, wherein the AI agent uses the RL model to calculate the reward function for each combination of instruments, and wherein the AI agent ranks each of the combinations of financial instruments based on the calculated reward function, and wherein the ranked combinations of financial instruments are used to select the combinations of financial instruments for inclusion in an optimized portfolio of assets.

15. The system of claim 14, wherein the AI agent employing the RL model is configured to:
a) use constraints comprising investor's risk tolerance, expected returns, and diversification requirements to determine the investor's preference and the investor's risk appetite;
b) based on said determination of the investor's preference and the investor's risk appetite, the AI agent evaluates a plurality of combinations of instruments, wherein the AI agent utilizes a plurality of techniques to reduce search space, uses parallel processing to evaluate multiple combinations of instruments simultaneously, and uses smart sampling to prioritize combinations with higher likelihood of meeting a reward criteria; and
c) using a reward function by the AI Agent to select an optimal combination of instruments after evaluation the plurality of combinations of instruments, wherein the reward function optimizes the combination of instruments for risk-adjusted returns, and wherein the AI agent selects the optimal combination of instruments.

16. A cloud based artificial-intelligence (AI) powered portfolio construction system architecture, comprising:
a first cloud server comprising at least one processor coupled to a memory, wherein said server comprises:
a central application gateway deployed on the cloud server, said central application gateway comprising a Web Application Firewall (WAF) to provide protection against security threats, ensuring secure communication between external users and internal services;
a second cloud server comprising at least one processor coupled to a memory, wherein said server comprises:
a container orchestration system for orchestrating a plurality of microservices, wherein each of said microservices are configured to handle specific functionalities;
an ingress load balancer configured to follow the central application gateway to distribute traffic across the microservices;
an event bus for facilitating communication to and from the microservices;
a plurality of databases, each corresponding to one of said microservices; and
an on-site Virtual Machine (VM) hosted on a computer system comprising at least one processor and memory, wherein said on-site Virtual Machine (VM) runs a Machine Learning (ML) Virtual Machine for training the AI model for portfolio optimization.

17. The cloud-based AI powered portfolio construction system architecture of claim 16, wherein a plurality of application client endpoints in multiple languages connect to the central application gateway via a first service domain, and wherein a plurality administration users connect to the central application gateway via a second service domain.

18. The cloud-based AI powered portfolio construction system architecture of claim 16, further comprises:
a personal Artificial Intelligence Large Language Model (AI LLM) cloud model that hosts AI in private cloud, comprising:
a data ingestion layer configured to collect user-specific data that is continuously updated for personalization;
a large language model core that processes language tasks; and
an API and interface layer that facilitates interactions with various apps, devices, and user interfaces.

19. The cloud-based AI powered portfolio construction system architecture of claim 16, wherein the event bus serves as a central message broker, ensuring smooth and asynchronous interaction between different services, and wherein the cloud-based architecture facilitates decoupling and allows the microservices to operate independently while maintaining consistency in data flow.

20. The cloud-based AI powered portfolio construction system architecture of claim 16, wherein the Machine Learning (ML) Virtual Machine utilizes a dedicated database for storing training data, model parameters, and other relevant data points essential for improving the AI portfolio engine's performance over time.

21. The cloud-based AI powered portfolio construction system architecture of claim 16, wherein the microservices comprise:
a) an Identity Microservice that handles authentication and authorization for users;
b) an administration microservice that enables system administrators to manage rules, portfolio size, and configurations related to portfolio management;
c) an integration microservice that facilitates integration with external systems, such as payment services or trading partners;
d) a system core service that centralizes and processes business logic, including the execution of portfolio construction rules and portfolio management algorithms; and
e) a reporting service that provides detailed performance reports by comparing portfolio returns to benchmarks and industry standards, and provide insights and analysis on portfolio performance.

22. An Artificial Intelligence (AI) based platform, comprising:
a memory; and
a processor communicatively coupled to the memory and configured to execute a plurality of instructions stored in the memory to implement a plurality of modules, comprising:
a Data Collection Module configured to gather information from various sources;
an AI Training Module that comprises an AI model, wherein the AI model is trained using historical stock and data, wherein after training the AI model, asset predictions are made by the AI model and the predictions are validated by expert professionals through a Validation & Expert Feedback Loop;
an AI Prediction Module configured to make real-time performance predictions of the asset predictions based on live market data; and
an AI Evaluation & Adjustment Module configured to review the AI model performance at regular internals, ensuring the model remains accurate and up-to-date.

23. The Artificial Intelligence (AI) based platform of claim 22, wherein the Data Collection Module gathers inputs from various sources comprising analysis reports, articles, news, and expert commentary, wherein the collected data is aggregated to organize and pre-processes the collected data to make the data structured and clean, and wherein the pre-processed data is fed to the AI model.

24. The Artificial Intelligence (AI) based platform of claim 22, wherein the Artificial Intelligence (AI) training module receives the pre-processed data collected from the Data Collection Module, wherein parameters and variables that define the AI model are configured, wherein the AI model is trained on historical data to learn patterns and make predictions, wherein the predictions generated by the AI model are validated by expert professionals and discrepancies or feedback from experts are then incorporated into the AI model, adjusting the AI model in the Feedback Loop, and wherein the feedback process continues until the AI model achieves accurate and reliable predictions.

25. The Artificial Intelligence (AI) based platform of claim 22, wherein the AI Prediction Module starts with a validated AI model that has undergone training and validation, wherein the AI Prediction Module, in real-time, collects current stock data and market events as inputs and generates predictions on stock trends, assessing the market based on its learned patterns, and wherein the generated predictions are delivered to users, informing them about upcoming system actions, as the system autonomously takes decisions based on these predictions.

26. The Artificial Intelligence (AI) based platform of claim 22, wherein the AI Evaluation and Adjustment Module begins with the AI system generating predictions which are evaluated by experts to assess the AI's performance based on accuracy and market relevance, wherein experts identify any incorrect predictions or areas where the AI's predictions were off, during the performance analysis stage, wherein based on the evaluation, the AI model is adjusted to improve the AI model's predictive capabilities, ensuring the AI model becomes more accurate over time.
